(19) United States
(12) Patent Application Publication
(10) Pub. No.: US 2023/0368935 A1
(43) Pub. Date: Nov. 16, 2023

(54) DEEP GEOLOGICAL DISPOSAL OF HIGH LEVEL WASTE ONSITE AT NUCLEAR POWER PLANTS

(71) Applicant: Henry Crichlow, Norman, OK (US)

(72) Inventor: Henry Crichlow, Norman, OK (US)

(21) Appl. No.: 18/108,001

(22) Filed: Feb. 9, 2023

Related U.S. Application Data
(63) Continuation-in-part of application No. 17/743,411, filed on May 12, 2022, now abandoned.

(51) Int. Cl. G21F 9/34; B09B 1/00; E21B 41/00

(52) U.S. Cl. CPC G21F 9/34; B09B 1/006; E21B 41/0057

(57) ABSTRACT

A method for evaluating, selecting, and implementing at existing nuclear surface (or near surface) sites a deeply located high-level nuclear waste (HLW) disposal repository that is located directly vertically below the areal confines of that existing site, within a particular deeply located geologic rock formation. Many of these existing sites are ideal because: they are already legally permitted and/or licensed for using nuclear/radioactive materials, they already have nuclear/radioactive materials onsite that need a long-term safe disposal solution, and many of these existing sites already have onsite useful infrastructure (e.g., roads, buildings, cooling pools, equipment, machinery, personnel, and/or the like). Such existing sites include nuclear power plants (operating or decommissioned), interim spent nuclear fuel rod assemblies (SNF) surface storage sites, and/or near surface SNF storage sites. The deep HLW disposal repository includes a vertical wellbore and may include a lateral wellbore and/or a human-made cavern.

### PRIORITY NOTICE

The present patent application is a continuation-in-part (CIP) of U.S. non-provisional patent application Ser. No. 17/743,411 filed on May 12, 2022, and claims priority to said U.S. non-provisional patent application under 35 U.S.C. § 120. The above-identified patent application is incorporated herein by reference in its entirety as if fully set forth below.

### CROSS REFERENCE TO RELATED PATENTS AND PATENT APPLICATIONS

U.S. utility Pat. No. 5,850,614; U.S. utility Pat. No. 6,238,138; U.S. utility Pat. No. 8,933,289; U.S. utility Pat. No. 10,427,191; U.S. utility Pat. No. 10,518,302; U.S. utility Pat. No. 10,807,132; U.S. utility Pat. No. 11,167,330; U.S. utility Pat. No. 11,183,313; and U.S. utility Pat. No. 11,339,611 are all prior art by the same inventor as the present patent application. This body of prior at is incorporated by reference in their entireties as if fully set forth herein.

### TECHNICAL FIELD OF THE INVENTION

The present invention relates in general to development of deep geological repositories for interim or permanent containment, storage, and/or disposal of radioactive materials (e.g., nuclear waste); and more specifically to the containment, storage, and/or disposal of radioactive materials within lateral wellbores and/or human-made caverns located in deep geological formations, of predetermined characteristics, that may be co-located with existing permitted sites that already contain onsite radioactive materials.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Today (circa 2022), innovation is needed in high level nuclear waste (HLW) disposal systems. The HLW may include spent nuclear fuel (SNF) from nuclear power plants. The HLW may also include radioactive waste from weapons programs (e.g., depleted uranium). A shallow one-shot, multi-billion Near Surface Mine/Tunnel Repository (NSMTR) for the disposal of HLW, requiring up to twenty (20) years or more to be implemented, is simply not a viable solution today. Some experts believe that a successful NSMTR for HLW disposal may never be implemented, anywhere on Earth, regardless of the billions of dollars expended in the fruitless effort. This opinion is based on several published discussions on the obstacles to the proposed NSMTR solution. One major obstacle to successful NSMTR implementation is the ³⁶Chlorine problem.

³⁶Chlorine is a radioisotope typically present in rainwater. ³⁶Chlorine is an unsurmountable and non-removable obstacle to the NSMTR approach to HLW disposal. Exhaustive analysis of ³⁶Chlorine in the interstitial waters of the near surface NMSTR layers of the earth, shows conclusively that surface (and near surface) waters shall reach the NMSTR stored HLW material there below, in as short a period as fifty (50) years, which is much too brief since HLW materials may require 10,000 years or so of environmental isolation for safe disposal. The inevitable chemical, physical, and electrolytic degradation of HLW materials stored in a NMSTR fashion shall occur, regardless of any subsequent protective systems implemented, like titanium umbrella sheets, added retroactively, after initial HLW disposal to protect the HLW containers.

Various embodiments of the present invention teach a technical and viable solution to the present need for long-term safe HLW disposal, that may augment or entirely replace the proposed NMSTR approach. Various embodiments of the present invention may use one or more deeply located wellbore systems, implemented vertically below a terrestrial surface, at depths of at least 10,000 feet below that terrestrial surface; and with: (a) long connected lateral (horizontal) wellbore extensions completed and lined with multiple protective steel casings, protective media, and cement-filled annuli; and/or (b) massive human-made caverns implemented below a deep and long (main) vertical wellbore section to form a significant volume(s) capable of storing/disposing of significant volumes of HLW. Additionally, these deeply located underground HLW repositories may be implemented at existing surface sites that already/current have HLW stored, such as, but not limited to, existing nuclear power plants (whether operational or not). Further, various embodiments of the present invention may provide: the actual needed volumetric capacity for HLW storage; technical feasibility; unsurpassed environmental protection to humankind and life in general over the necessary timeframes; economic benefits; worker safety; comparatively rapid and timely development for the HLW disposal systems required to sequester all the HLW currently stored on the surface and that HLW to be produced into the foreseeable future.

Prior art by the same inventor of this present invention may be as follows: U.S. utility Pat. No. 5,850,614; U.S. utility Pat. No. 6,238,138; U.S. utility Pat. No. 8,933,289; U.S. utility Pat. No. 10,427,191; U.S. utility Pat. No. 10,518,302; U.S. utility Pat. No. 10,807,132; U.S. utility Pat. No. 11,167,330; U.S. utility Pat. No. 11,183,313; published U.S. utility patent application 2020/0273592; and published U.S. utility patent application 2021/0025241. This body of prior at is incorporated by reference in their entireties as if fully set forth herein. This body of prior art discloses at least some embodiments that may be utilized and incorporated into embodiments of the present invention.

At least some current proposed HLW disposal frameworks and the on-going, but nonoperating, HLW/SNF disposal systems like Yucca Mountain (Mt.) in Nevada, have been doggedly and single mindedly following the approach offered by NSMTR supporters; i.e., a HLW disposal system, usually too near the terrestrial surface and which is defacto, close to or actually in the existing water table. It should be noted that the first technological breakthrough teaching the deep lateral wellbore strategy for safe HLW disposal was first published in U.S. utility Pat. No. 5,850,614 filed in 1997 by the same inventor of this present invention. This technology was further publicized at an International Conference in Regina, Canada. No mention of this technology or the like has ever made it into any United States Depart of Energy (USDoE) sponsored research for almost a decade or more. Several thousand wellbores with lateral (horizontal) extensions longer than 10,000 feet have been successfully drilled worldwide and still no reference or indication of this existing patented horizontal technology has been made by the USDoE or its contractors until after 2009.

The inventive technology if applied by the USDoE or its associated agencies, may allow these interested parties to expand their influence and reach, to look into and to include the analysis of the benefits of those existing allied technologies previously taught by this inventor and others. This additional technological application may provide USDoE et al, the ability to directly impact HLW disposal and those techniques that might be utilized for effective and timely disposal and which technologies have hither-to-fore been completely overlooked in the last three decades by USDoE and its contractors because of their total focus on the NSMTR approach.

These combined approaches in the current application may address all the major aspects of, and the problems associated with the HLW disposal in this country (the U.S.) today and the means, methods, and processes to economically solve these problems within a few years, rather than several decades as currently contemplated. The problems addressed range from those presented by spent nuclear fuel (SNF) rods to uranium hexafluoride, to weapons research waste and the military's depleted uranium projectile stockpiles, as well as the serious problem of public acceptance. Together the methods presented herein, may provide a coherent systematic and integrated blueprint and a definitive roadmap that may illustrate the methods that may solve the HLW disposal problem.

Expansion of the nuclear power generation industry in the United States (U.S.) and around the world has produced a pernicious and deadly byproduct of high-level nuclear waste (HLW). To organic life, HLW may be the most dangerous material on Earth, and HLW may remain hazardous for hundreds of thousands of years. Prior to work by the present inventor taught in U.S. utility Pat. No. 5,850,614, there has not been a well-thought-out, realistic, safe, and relatively affordable means for HLW disposal. Massive technological changes and improvements have been directed at efficient power generation systems by equipment building, and power generation companies; however, little or no effort has been expended by these companies to solve the “backend” problem of the efforts, the hazardous and dangerous radioactive nuclear waste (HLW) byproduct. Furthermore, major problems exist today (circa 2022) because of the inability of the existing U.S. federal laws or regulatory processes to allow disposal of HLW because of at least the following: (1) a current or prior federal governmental reliance upon near surface tunnels and mines (e.g., NSMTR and the like); (2) the prevailing “not in my back yard” (NIMBY) sentiment from voters; (3) continued accumulation of 2,000 metric tons (mt) or more of HLW, annually, and even more projected because of future expansion of nuclear power plants; and/or (4) dramatic increases in costs and liabilities to governments and the public stemming from not addressing the HLW disposal problems. There is growing current sentiment that current proposed disposal systems (e.g., NSMTR and the like) are dangerous, risky, take too long to implement, too expensive, volumetrically inadequate, politically and legally unrealistic; and thus, just not acceptable. Because of these issues there has been a complete lack of political will on behalf of lawmakers to properly address the current and growing HLW disposal problem.

This absence of properly dealing with the dangers of HLW have been reported by some as a major dereliction of duty by the nuclear power companies and the suppliers of the nuclear power generation technology. To date, and aside from work of the present inventor, there has been no firm methodology to provide for HLW disposal safely in deep geological formation systems below 10,000 feet (or more) with workable horizontal lateral systems or deeply located (human-made) cavern systems.

There are multifaceted issues that make the HLW disposal a complex and almost intractable problem. One major issue is the difference of attitudes of the various stakeholders in the overall process. Stakeholders in the nuclear power generation processes may include the following: power companies (utilities); suppliers of power companies; governments (e.g., U.S. federal, state, regional, local, municipal, county, city, foreign, etc.); municipal groups; environmental groups; people (voters, workers, residents, citizens, the public, Indigenous peoples, etc.); international agreements; the press; combinations thereof; and/or the like. International law, agreements, and/or treaties may play a role in the handling and/or disposal of HLW. Each particular stakeholder may have its own needs and/or agenda; however, an over-riding issue is that the HLW is not going away, and the HLW shall remain deadly for up to about 500,000 years. Any Earth organic lifeform may be irrevocably harmed by exposure to HLW. A solution to the problems associated with handling and disposal of HLW, which have developed over the last 50 years and growing, is needed. This is a long felt but unmet need.

Under existing U.S. federal law, the nuclear power generation companies have by statute, depended on governmental agencies to facilitate the disposal of HLW. In the U.S., this disposal authority has been the purview of the Atomic Energy Commission (AEC), the Nuclear Regulatory Commission (NRC), and the U.S. Department of Energy (USDoE). In 1982, the U.S. federal government agreed to take HLW starting by 1998. This transfer did not and has not occurred to date as of 2022. Litigation began and has continued to date. Unfortunately, this has been the norm with respect to HLW disposal. An objective of this patent application is to “go beyond this norm” to formulate a new and effective approach to managing the HLW disposal problems.

There are currently more than 80,000 metric tons (mt) of HLW located at various sites around the U.S. and accumulating at a rate of approximately 2,500 mt per year in the U.S. alone. In the U.S, HLW disposal at Yucca Mountain (Mt.) is the current “Law of the land.” HLW is contemplated to be disposed of or stored at Yucca Mt. However, no consensus on the suitability of Yucca Mt. for HLW disposal exists. On the contrary, as stated earlier, based on current knowledge, experts believe that Yucca Mt. is fatally flawed for HLW disposal, at least with respect to using NSMTR. For example, currently, more than 300 technical and legal contentions exist which the NRC must address to license Yucca Mt. The NRC has estimated it will cost at least $330 million, and up to five (5) years just to complete the licensing process. Furthermore, no estimate has even been made on the actual on-going operations or costs to maintain the Yucca Mt. facility if it were to be implemented.

The nuclear power utility companies have collected on a per kWHr (kilowatt hour) basis, billions of U.S. dollars in fees from electricity end-users, which has been escrowed to pay for the ultimate HLW disposal. In the U.S., the set-aside fund may be above $40 billion (U.S. dollars) (e.g., as of 2018). Note, while just currently and existing set-aside funds is significant this amount is very likely insufficient for implementation of NSMTR practices at Yucca Mt.; whereas, in contrast such funds are very likely more than sufficient for implementation of various HLW disposal methods taught herein.

There is a concerted effort against any nuclear waste disposal system being implemented in most states in the U.S. The currently selected site is at Yucca Mt. in Nevada, this site though initiated in 1978, has been unable to be developed for HLW disposal because of its problems, including social and legal roadblocks at every level. Yucca Mt. has geologic deficiencies, cost overruns, legal complications at the local, state, and federal levels and by all present forecasts, it is possible that this location will never be used as a HLW disposal site. This feeling is currently held by many of the state congressional and senate representatives. With this impasse, it is concluded that after many decades, that the Yucca Mt. near surface tunnel solution will not become a reality for HLW disposal.

Furthermore, there is the environmental issue of protection from radioactivity over the exceptionally long term of thousands of years with respect to dealing with HLW disposal issues. Any solution or disposal approach has to provide a very high level of safety and do so for thousands of year. The technological method illustrated herein may do just that. A new, more viable approach to the management of HLW disposal is needed which can be implemented under the existing legal, and regulatory systems. Without a safe and effective HLW disposal system, nuclear power generation may cease to exist or be severely curtailed, across the U.S. and/or the world. There is a critical need for a novel, viable, and effective management solution to the HLW disposal problem. This new solution is a primary objective of the current application. There is a need in the art for methods for managing the disposal of HLW in such a manner that the HLW may be disposed while remaining within the boundaries of the existing regulatory structure and laws, until these laws may be modified or repealed. This invention proposes method(s) to mitigate the problems associated with (HLW) waste disposal at or near to the actual source of HLW generation itself (such as, but not limited to, nuclear power plants and/or current surface HLW storage sites). There is currently a wide array of means for disposal of this HLW as taught by the present inventor and as further taught herein. A most promising methodology is the use of deep geological repository systems. To date, no deep repository has been implemented anywhere around the world for HLW disposal. This invention may create a desperately needed deep repository system onsite, at existing, certified nuclear power generation sites; and/or onsite, at existing, surface storage locations of HLW. It is to these ends that the present invention has been developed.

### BRIEF SUMMARY OF THE INVENTION

To minimize the limitations in the prior art, and to minimize other limitations that will be apparent upon reading and understanding the present specification, embodiments of the present invention may teach apparatus, devices, machines, systems, methods, processes, techniques, and/or steps for the long-term disposal of high level nuclear and radioactive waste products/materials (HLW), along with other radioactive waste forms, or alternatively other waste forms, within deep geological rock formation(s) of predetermined characteristics. In some embodiments, to emplace the (HLW) waste, wellbore(s) may be drilled from the Earth's terrestrial surface into the given deep geologic (rock) formation; and then either an at least mostly horizontal (lateral) wellbore(s) may be formed within that given deep geologic (rock) formation and/or a human-made cavern(s) may be formed within that given deep geologic (rock) formation; wherein the (HLW) waste may be then be sequestered (placed) within the horizontal wellbore(s) and/or in the human-made cavern(s), all within that given deep geologic (rock) formation.

In some embodiments, a method for evaluating, selecting, and implementing at existing (or future) nuclear surface (or near surface) sites a deeply located high-level nuclear waste (HLW) disposal repository that is located directly vertically below the areal confines of that existing site, within a particular deeply located geologic rock formation. Many of these existing sites are ideal for implementation of a deep HLW disposal repository because: they are already legally permitted and/or licensed for using nuclear/radioactive materials thereon, they already have nuclear/radioactive materials onsite that need a long-term safe disposal solution, and many of these existing sites already have onsite useful infrastructure (e.g., roads, buildings, cooling pools, equipment, machinery, personnel, and/or the like). Such existing sites include nuclear power plants (operating or decommissioned), interim spent nuclear fuel rod assemblies (SNF) and/or other nuclear/radioactive waste surface storage sites (e.g., cooling pools and the Hanford, Washington site), and/or near surface SNF storage sites. The deep HLW disposal repository, to be implemented at a given site, may include a vertical wellbore, a lateral wellbore, and/or a human-made cavern; wherein the lateral wellbore and/or the human-made cavern are entirely located within the deep disposal formation/zone. The HLW, SNF, and/or radioactive materials are emplaced in the lateral wellbore(s) and/or in the human-made cavern(s).

Nuclear power generation plants, SNF (temporary) surface storage sites, HLW (temporary) surface storage sites, and/or the like may occur and currently exist in a variety of locations in the U.S. and around the world. And future nuclear power generation plants, SNF (temporary) surface storage sites, HLW (temporary) surface storage sites, and/or the like are likely to come into existence for the foreseeable future in a variety of locations in the U.S. and around the world. It would be desirable if beneath such surface sites deep geologic repositories could be implemented. Various embodiments of the present invention contemplate disposing of the HLW onsite at these surface sites, in deep geological formations, a situation that has not been utilized before. There is no standardized template for nuclear power plant site selection. Some such nuclear power plant surface sites are near the ocean, near lakes, in towns and/or in suburbs. Not all such surface sites, for a variety of reasons, may work for implementation of onsite deeply located geologic repositories for HLW disposal. The methodology provided herein, may implement a series of steps that utilize the local geological characteristics, technical descriptors, the locational topographies, and local and regional attributes which may fully and uniquely define the location of power generation site or nuclear waste storage site. Further, the method provided herein may utilize systematic analyses which may deliver information and data which may be used to determine a technical ranking process in which the specific HLW surface sites may be analyzed and then selections made for implementing onsite deeply located repositories for HLW disposal.

Oilfield drilling devices, equipment, apparatus, machines, systems, methods, and operations form an integral subset of the operations utilized in the inventive method. With respect to horizontal (or lateral) drilling operations at great depth, the technologies of horizontal drilling or the drilling of lateral wellbores and cavern systems, have been improved considerably over the last decades. Downhole tools and downhole motors operating with specialized bottom hole assemblies (BHAs) have been able to overcome some of the obstacles to efficient horizontal drilling in deep formations. These improvements have been particularly noticeable in the ability to drill through and below deep formations to target productive oil and gas producing zones where significant petroleum production exists. This technology may also be used to drill horizontally within deep formations.

With respect to drilling and under-reaming of human-made caverns in deep formations, in recent years, in the drilling industry over 2,500,000 feet of under-reaming drilling has been successfully achieved. The reaming technology in oil well drilling is not new. Reaming patents exist as early as 1939. However, the recent technological developments in the drilling industry have made it possible to help resolve the problems involved in making human-made caverns in deeply located geologic (rock) formations a reality allowing for (HLW) waste disposal in deep geologic zones.

Recently (2018), an oil well service company has published that it successfully drilled a fifty-four inch (54″) diameter wellbore during an offshore well drilling from a drilling platform. Modifying such oilfield drilling technology allows implementation of embodiments of the present invention. Because of drilling design improvements, it is now possible to resolve the problems involved in disposing of nuclear waste in deeply located human-made caverns implementing larger diameter cavern sizes.

Some of the technical drivers that have allowed the embodiments of present invention herein to be implemented are as follows: drilling rig design features have improved; increased hydraulic pressure availability at the drill bit; available drilling rig horsepower up to as much as 6,000 hydraulic horsepower; available pump horsepower; available rig capacity up to 2,000,000 pounds of dead weight lift is available; high downhole drilling fluid pressures can be maintained; drilling rig ability to pump slurries of high density, drilling fluids weight in pounds per gallon (ppg) have increased considerably; and remote and automatic control software for rig operations.

In light of the problems associated with the known methods of disposing of nuclear waste (including in liquid/slurry format), it may be an object of some embodiments, to provide a method for the disposal of nuclear waste in horizontal (lateral) wellbores and/or in human-made caverns which is safe, with high volumetric capacity, that is cost-effective, and that may be performed with modified oil field equipment (such as but not limited to, wellbore and/or underreaming equipment). It may also be possible to dispose of the HLW directly below the waste generating surface site, whether operating or non-operating, while still adhering to existing federal, state, or local regulations.

Some embodiments may specifically address technical considerations, such as, but not limited to, disposal of HLW materials in human-made repositories, lateral wellbores, or caverns, implemented in deep formations. The initial disposal repositories may be horizontal (lateral) wellbore systems and/or human-made cavern systems in deep formations—that may be directly located below surface sites that have HLW thereon.

It is a primary objective of the present invention to provide a method of managing the interim or permanent disposal of HLW (including SNF) at existing, permitted, nuclear operations sites such that the nuclear power industry may mitigate the accumulation of surface SNF and HLW across the country (U.S).

It is a major objective of the present invention to provide disposal/sequestration of the HLW in deep lateral wellbores and/or in human-made deep caverns implemented at/within the physical confines of the existing (or future), permitted, actual nuclear operations sites.

It is another objective of the present invention to provide a method that disposes of or sequesters the HLW at existing (or future), permitted, actual operating nuclear power plants, non-operating power plants, at surface storage sites, and/or even at near surface storage sites.

It is another objective of the present invention to provide a HLW disposal method that functions under prevailing and/or preexisting laws, regulations, and/or guideline for HLW storage at approved sites.

It is another objective of the present invention to provide a method to dispose of the HLW in special lateral wellbore systems (also known as SuperLAT™ systems), forming a waste repository at/under the existing (or future), permitted, sites of the nuclear power plant or nuclear storage operations, while staying within the prevailing and/or preexisting regulatory parameters.

It is another objective of the present invention to provide a method to dispose of the HLW in special deep human-made caverns (also known as SuperSILO™ systems), implemented in the appropriate deep geologic rock formations forming a waste repository at/under the existing (or future), permitted, sites of the nuclear power plant or nuclear storage operations, while staying within the prevailing and/or preexisting regulatory parameters.

It is another objective of the present invention to provide a method that allows the comprehensive analysis and assessment of the optimal HLW disposal locations based on a series of factors, such as, but not limited to: existing quantitative levels of HLW stored at a given nuclear plant location or nuclear operations site; the current activity level of the radioactive material based on the decay age of HLW in storage at that location; geological analysis of the subterranean and surface formations adjacent to and below that location; the demographics surrounding the locations; the existing and predicted infrastructure development locally and regionally to a given site/location; existing political concerns; existing and forecasted economics; and relevant social issues.

It is another objective of the present invention to provide a method that allows the systematic technical ranking and further selection of the appropriate HLW disposal locations that make up the nuclear facilities in order to implement the waste repository onsite.

It is another objective of the present invention to provide a method that allows the ranking and selection of the appropriate SNF assembly material currently stored in, and the safety and age of the surface cooling ponds to allow sequential, or simultaneous operations, at or near those cooling ponds that is both safe and economic, and that achieves rapid disposal of the HLW material.

It is another objective of the present invention to provide a method that allows the quantitative selection of the HLW spent nuclear fuel based on the SNF activity/decay age in cooling pools, such that the longest-cooled, and hence least active SNF are removed and sequestered first in a FIFO (First In First Out) system within the deep geologic formations. This FIFO provides less heat generation problems and may also minimize the possible detrimental radioactive effects during handling and encapsulation and disposal processes as that HLW gets disposed of within the deep geologic formations.

It is another objective of the present invention to provide a method that allows the selection of the appropriate physical location at the existing nuclear sites based on the analysis of at least some of the following set of parameters: structural and stratigraphic geological closure of the subterranean repository zone; limited rock permeability values; existence of minimal rock fractures; adequate radiation protection properties of repository rock; remote distance of the deep disposal zone from the near surface existing water table; hydrodynamic isolation and geological containment of the geologic disposal zone; portions thereof; combinations thereof; and/or the like—all with respect to the given target deep geologic disposal formation(s)/zone(s) below the existing (or future) nuclear surface (or near surface) site(s).

It is another objective of the present invention to provide a method that allows the selection of the appropriate locations across or within the confines of a group of the nuclear facilities for implementing the disposal repository in the event that the HLW needs to be moved from one existing permitted, but non-optimal facility to another existing more optimal permitted regulated nuclear operations site.

It is yet another objective of the present invention to provide a method that allows the mitigation of those intrinsic problems which may be present in and complicate the utilization of surface or near surface HLW storage systems. The following published complications are usually present in or related to surface (and/or near surface) storage and have to be addressed and mitigated before any local or state permitting is allowed: groundwater motion; effect of biologicals on radionuclide transport; sediment accumulation; infiltration rates; bioturbation effects and consequences; nature of contamination; bathtub effect; gully processes; calibration of infiltration rates; sedimentation problems; plant growth and cover performance; pedogenic processes on the radon barrier; disposal cell stability; representative hydraulic conductivity rates; modeling impacts of effect of gully; implications of freezing; aquifer behavior; surface embankment properties; slope materials; erosion properties; rainfall intensity; surface erosion analysis; portions thereof; combinations thereof; and/or the like. Technical analysis of all these parameters and complications may often be made using available computer systems, software, simulation systems, and laboratory or empirical analyses and observations. However, it is usually very difficult to “fix” or mitigate all these problems associated with surface (or near surface) storage of HLW. Often one or more of these problems will prevent a proposed surface (or near surface) site from permitting and operations. Whereas, in contrast, most if not all of these problems are rarely a problem for HLW disposal within appropriate deeply located geologic rock formation(s)/zone(s)—even when the appropriate deeply located geologic rock formation(s)/zone(s) are located deeply below surface (or near surface) site(s) with such problems.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 shows a map of the continental United States of America (U.S.) showing nuclear power plant sites (both operational and decommissioned), surface nuclear waste storage sites, near surface nuclear waste storage sites, the Yucca Mounting (Mt) site, the Waste Isolation Pilot Plant (WIPP) site in New Mexico (NM), an interim nuclear waste storage site in Texas, a surface tanks nuclear waste storage site in Hanford, Washington (WA), and/or the like.

FIG. 2A may illustrate a generic surface schematic overview at an operating or closed nuclear power plant site and may also show a generalized vertical cross-section “cut-out” of a location wherein a HLW repository may be implemented onsite, but below, that operating or closed nuclear power plant site.

FIG. 2B may illustrate a generic surface schematic overview of the Yucca Mt site in Nevada (NV) and may also show a generalized vertical cross-section “cut-out” of a location wherein a HLW repository may be implemented onsite, but below, the Yucca Mt site.

FIG. 3 may illustrate a generic surface schematic overview of the Waste Isolation Pilot Plant (WIPP) site in NM and may also show a generalized vertical cross-section “cut-out” of a location wherein a HLW repository may be implemented onsite, but below, the WIPP site.

FIG. 4A may illustrate a generic surface schematic overview of the Hanford, WA site and may also show a generalized vertical cross-section “cut-out” of a location wherein a HLW repository, using at least one deeply located lateral wellbore, may be implemented onsite, but below, the Hanford, WA site.

FIG. 4B may illustrate a generic surface schematic overview of the Hanford, WA site and may also show a generalized vertical cross-section “cut-out” of a location wherein a HLW repository, using at least one deeply located human-made cavern, may be implemented onsite, but below, the Hanford, WA site.

FIG. 5 may illustrate the implementation of a prior art proposed consolidated interim storage facility for HLW material on the surface using surface casks for the HLW.

FIG. 6 shows Table 1 of 2017 published costs for just a single surface cask for HLW interim storage.

FIG. 7 illustrates a typical (prior art) cooling pond system that is commonly used for interim storage and cooling of spent nuclear fuel (SNF) rod assemblies.

FIG. 8A is a reproduction of a FIG. 1 from a prior art patented system from U.S. utility Pat. No. 6,238,138.

FIG. 8B illustrates a deep HLW disposal system based on a prior art invention taught in the patented inventions of U.S. utility Pat. No. 10,807,132.

FIG. 8C illustrates the only actual surface (prior art) marker today, indicating the location in New Mexico (NM) where a nuclear device was detonated deep below ground level on Dec. 10, 1967.

FIG. 9 may illustrate and summarize at least some of the exhaustive analyses (such as, but not limited to, geophysical method analyses and/or geological method analyses) that may used to provide sufficient data and/or information for determining whether to implement an onsite but deep HLW disposal repository at an existing (or future) nuclear surface (or near surface) site.

FIG. 10 may illustrate in pictorial and graphic formats, the results of at least some of the studies/analyses listed in FIG. 9.

FIG. 11 may show a graphic display output from high-quality (high-resolution) video borehole images and/or images/rendering of fractures in borehole adjacent formation(s).

FIG. 12 may show a three-dimensional (3D) visual (digital) model showing a location of at least one modeled drill rig on a modeled terrestrial surface, position of at least one modeled vertical wellbore passing through at least one modeled non-disposal rock formation(s) and extending into a modeled disposal repository zone, and at least one modeled lateral wellbore that is also located entirely within the modeled disposal repository zone and that extends from a distal/terminal end portion (that is disposed away from modeled terrestrial surface) of modeled vertical wellbore.

FIG. 13 may be graph/chart depicting activity level of the spent nuclear fuel (SNF) rod assembly radioactive material versus time as the SNF material resides in cooling ponds or in some type of (onsite) surface storage that is intended to be interim.

FIG. 14 illustrates a flow chart of a method of data gathering, determining, ranking, and/or selecting existing (or future) nuclear surface (or near surface) sites for potential onsite disposal of HLW in deep geological zones directly vertically below the given selected site; and/or then implementing at least one such onsite deep HLW disposal repository at the selected existing (or future) nuclear surface (or near surface) site(s).

FIG. 15 shows Table 2 which shows and explains in tabular form how FDI (fuel decay index) may be calculated and/or determined for a given existing (or future) nuclear surface (or near surface) site.

FIG. 16 of Table 3 may illustrate a methodology showing in tabular form how elements of geological suitability analyses and resulting GSI (geological suitability index) and the location suitability model analyses and resulting LSI (location suitability index) may be implemented in this inventive application.

FIG. 17 is of Table 4, which shows that once GSI (geological suitability index), FDI (fuel decay index), and LSI (location suitability index) have been calculated for a given existing (or future) nuclear surface (or near surface) site; then, a final “site suitability index” (SSI) may be determined/calculated for that given site, all with a goal of evaluating that given site for implementing at least one onsite deeply located HLW disposal repository in an onsite but deep disposal zone/formation.

FIG. 18 is prior art and shows a 2010 version of 42 U.S.C. (United States Code) section 10132(a) that is annotated to show how 42 U.S.C. (United States Code) section 10132(a) treats (candidate) repository sites as different, separate, and unique sites/locations with respect to sites that generate HLW/SNF and/or that have HLW/SNF stored therein.

FIG. 19 is prior art and shows the areal boundary (perimeter) of Oyster Creek (nuclear) Power plant in New Jersey (NJ).

### REFERENCE NUMERAL SCHEDULE

10 drilling rig 10
12 earth's surface 12
14 vertical wellbore 14
16 surface layers 16
18 underground rock formation 18
primary horizontal lateral 20
22 angle between primary laterals 22
24 secondary horizontal lateral 24
26 tertiary horizontal lateral 26
28 horizontal plane 28
100 map 100
101 shutdown nuclear (power plant) site 101
102 operating commercial nuclear (power plant) site 102
103 interim storage site (in NM) 103
104 interim storage site (in TX) 104
105 non-operating Yucca Mt site (in NV) 105
106 Waste Isolation Pilot Plant (WIPP) (in NM) 106
200 nuclear power plant (operating or closed) 200
201 cooling tower 201
202 building(s) 202
203 electrical power transmission lines 203
204 infrastructure road(s) 204
205 terrestrial surface 205
206 (modified) drilling rig 206
207 (main and long) vertical wellbore 207
208 (long) lateral wellbore 208
209 disposal zone/formation 209
210 deep vertical depth 210
211 non-disposal zone(s)/formation(s) 211
212 previously contemplated disposal formation 212
213 shallow vertical depth 213
214 deep vertical depth 214
301 subterranean protected room 301
302 (shallow) salt formation 302
303 sedimentary rock layer(s) 303
304 sedimentary rock layer(s) 304
305 surface associated system 305
306 kick-off point 306
307 lateral extend of site 307
308 (first) vertical depth 308
309 (second) vertical depth 309
310 surface control operations center 310
400 Hanford, Washington, surface waste disposal site 400
401 subsurface cross-section of geological zones 401
402 HLW surface tank 402
403 high-level nuclear waste (HLW) 403
404 exploratory wellbore 404
405 human-made storage cavern 405
411 surface facility/building 411
412 surface drilling fluids facilities 412
500 (prior art) consolidated interim storage projects (CISP) 500
501 HLW (surface) storage cask 501
502 concrete and/or gravel pad 502
503 grade level 503
504 fence 504
505 lighting 505
506 road(s) 506
700 (prior art) cooling pond/pool system 700
701 water 701
702 SNF handler 702
703 spent nuclear fuel rod assembly (SNF) 703
704 cooling pool/pond 704
705 containment wall(s) 705
800 HLW disposal/storage system 800
801 (main and long) vertical wellbore 801
802 human-made disposal/storage cavern 802
803 HLW 803
804 deep geologic formation (disposal zone) 804
805 drilling rig 805
806 subterranean geological zone above disposal zone 806
851 marker 851
852 grounds 852
853 surrounding-area 853
900 geophysical analysis method(s) 900
901 geological analysis method(s) 901
1010 analyzed well logging traces 1010
1011 rock fluid saturations, rock thicknesses, and other recorded parameters 1011
1012 calculated volumes of interstitial fluids in the rock 1012
1110 high-quality video borehole images 1110
1111 fractures 1111
1200 3D digital/rendered model for deep HLW disposal system 1200
1201 modeled disposal repository zone/formation 1201
1202 modeled (modified) drilling rig 1202
1203 modeled terrestrial surface 1203
1204 modeled (main and long) vertical wellbore 1204
1205 modeled non-disposal rock formation(s) 1205
1206 modeled (long) lateral wellbore 1206
1207 modeled subterranean geologic zone(s) 1207
1208 coordinate/axis system 1208
1300 decay curve 1300
1301 vertical boundary line 1301
1302 predetermined critical level 1302
1303 horizontal axis 1303
1304 vertical axis 1304
1305 area 1305
1400 method of evaluating existing site for deep HLW disposal repository 1400
1401 step of collecting data 1401
1403 step of analyzing drilling and related characteristics 1403
1405 step of determining geological suitability index (GSI) 1405
1407 step of analyzing location suitability issues 1407
1409 step of determining location suitability index (LSI) 1409
1411 step of analyzing combined indexes 1411
1413 step of selecting a different potential site for evaluation 1413
1415 step of selecting a different potential site for evaluation 1415
1417 step of determining site suitability index (SSI) 1417
1419 step of ranking evaluated potential sites 1419
1421 step of selecting site to implement deep disposal repository 1421
1423 step of implementing onsite deep disposal repository 1423
1425 step of closing and marking onsite deep disposal site 1425
1500 method of calculating fuel decay index (FDI) 1500
1501 categorizing/grouping HLW surface site amount by residence time per site 1501
1502 age/residence time of group of HLW 1502
1503 HLW amount for particular age category 1503
1504 relative activity level (loss level) 1504
1505 total HLW amount at a particular site 1505
1506 product of amount and age (first-product-value) 1506
1507 calculated fuel decay index (FDI) (second-product-value) 1507
1508 total/summed of FDI scores for a particular site 1508
1509 sorting totaled FDIs for each evaluated site 1509
1510 ranks/ranking 1510
1511 particular site with surface (or near surface) HLW 1511
1512 normalized FDI value for a particular site 1512
1601 geological suitability model 1601
1602 specific geological parameters/categories 1602
1603 rating values for geological parameters 1603
1604 weight factors (weighted-value) 1604
1605 calculated product (factor-rating-product) 1605
1606 calculated geological suitability index (GSI) 1606
1607 location suitability model 1607
1608 specific location parameters 1608
1609 rating values for location parameters 1609
1610 weighted factors (weighted-value) 1610
1611 calculated product (factor-rating-product) 1611
1612 calculated location suitability index (LSI) 1612
1701 index values (first-rating, second-rating, and/or third-rating) 1701
1702 weight factors (weighted-value) 1702
1703 calculated product (factor-rating-product) 1703
1704 calculated site selection index (SSI) 1704
1900 Oyster Creek (Nuclear) Power Plan site New Jersey (NJ) 1900
1901 areal boundary (perimeter) 1901
1903 State Route 9 1903
1905 South Branch Forked River 1905

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

Unless otherwise stated herein, “HLW” may refer to “high-level nuclear waste;” and “SNF” may refer to “spent nuclear fuel.” SNF may include at least a portion of a fuel rod and/or fuel rod assembly. Unless otherwise stated herein, HLW and/or high-level nuclear waste may include SNF.

“Site” and/or “site 1511” are defined towards the end of this Specification, before the Claims.

Unless otherwise stated herein, “located directly vertically below” a given terrestrial surface 205 means between that point of the terrestrial surface 205 and a nearest exterior portion of the Earth's core; and in a direction that is at least substantially parallel to completely parallel with the Earth's gravitational vector at that point the terrestrial surface 205. For example, deep geological formation(s), zone(s), and/or repositories 209 may be located directly vertically below a given existing (or future) nuclear surface (or near surface) site 1511 and directly vertically below any water tables are that located directly vertically below that given existing (or future) nuclear surface (or near surface) site 1511, wherein such water tables are located between that point of the terrestrial surface 205 and a nearest exterior portion of the Earth's core.

Unless otherwise stated herein, “vertical” may be in a direction that is at least substantially parallel to completely parallel with the Earth's gravitational vector at that point the terrestrial surface 205.

Unless otherwise stated herein, “lateral” and/or “horizontal” may be in a direction that is at least substantially orthogonal with the Earth's gravitational vector at that point the terrestrial surface 205. “Lateral” and “horizontal” may be used herein interchangeably.

Unless otherwise states herein, “disposal zone,” “disposal formation,” “disposal repository,” “waste repository,” “deep disposal zone/formation,” “deep disposal repository,” “deep geological disposal zone/formation,” and “deep geological disposal repository,” and/or the like may be used herein interchangeably and/or may be associated with (assigned) reference numeral 209. However, technically, the “repository” may be an excavated portion of that given “zone/formation”; and it is the repository that receives and houses the radioactive materials, such as, but not limited to, HLW, SNF, waste, and/or the like.

Unless otherwise stated herein, “GSI” may refer to “geological suitability index”; “FDI” may refer to “fuel decay index”; “LSI” may refer to “location suitability index”; and “SSI” may refer to “site suitability index.” In some embodiments, a combination of GSI, FDI, and LSI may be used to determine/calculate SSI for a given suite 1511.

Unless otherwise stated herein, “interim” with respect to HLW (SNF) storage may refer to storage of HLW (SNF) that was not intended to be permanent and/or long-term. In general, interim HLW storage may be associated with surface sites 1511 and/or with near surface sites 1511. Whereas, proper long-term storage and/or disposal of HLW (SNF) is storage of that HWL (SNF) within a deeply located geological repository that is itself located within a deeply located geological zone/formation 209.

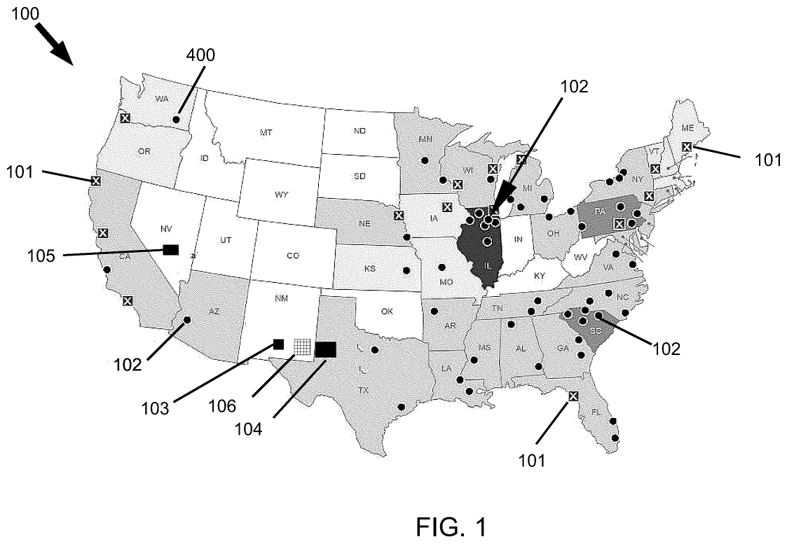

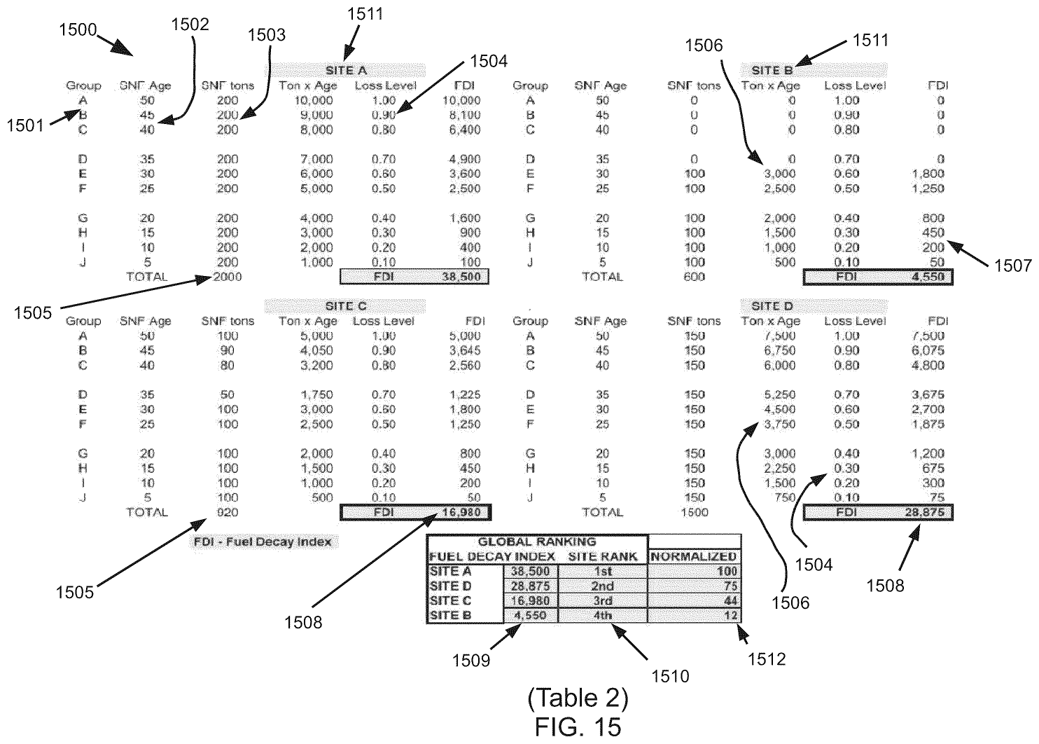

FIG. 1 illustrates a map 100, showing locations of stored commercial spent nuclear fuel (SNF) assemblies (i.e., examples of HLW) across the various U.S. states. These U.S. storage locations may be the following: shut down nuclear (power plant) sites 101 (indicated in map 100 by black boxed x's); at operating nuclear commercial (power plant) sites 102 (indicated in map 100 with black dots/circles); at interim storage site 103 in New Mexico (NM); at interim storage sites 104 in Texas (TX); at currently non-operating Yucca Mountain (Mt) site for HLW disposal of SNF is shown by 105 in Nevada (NV); and finally at location 106 that is for a Waste Isolation Pilot Plant (WIPP) site in NM for storage/disposal of nuclear waste in shallow salt formations. This WIPP location 106 has been plagued by ongoing accidents, operational mishaps, and accusations of mismanagement. Most of the HLW at these sites in map 100 is at the surface (e.g., at or very near Earth's terrestrial surface at those locations/sites). Some of the HLW at these sites in map 100 is near the surface, e.g., the WIPP location 106. This map 100 further shows the widespread dispersal of the SNF assembly wastes across the U.S. In addition, there is a high concentration of HLW in some specific states while in some other areas, this HLW can be non-clustered and widely dispersed sites across other states. There is a great variety of tonnage of waste being held on the surface in different states. For example, in Illinois there is more than 10,000 metric tons (mt) of stored commercial HLW waste; California has about 5,000 mt; while Vermont, New Hampshire and Florida each have about 1,000 mt of HLW. Total U.S. national overall HLW is about 83,000 mt currently in surface storage and this quantity continues to rise by about 2,500 mt annually. None, of this HLW is currently being stored in deep geologic rock formations. In some embodiments, any of the sites (e.g., 101, 102, 103, 104, 105, 106, and/or 400) shown in FIG. 1 may be a site 1511 (particulars of four example sites 1511 are shown in FIG. 15).

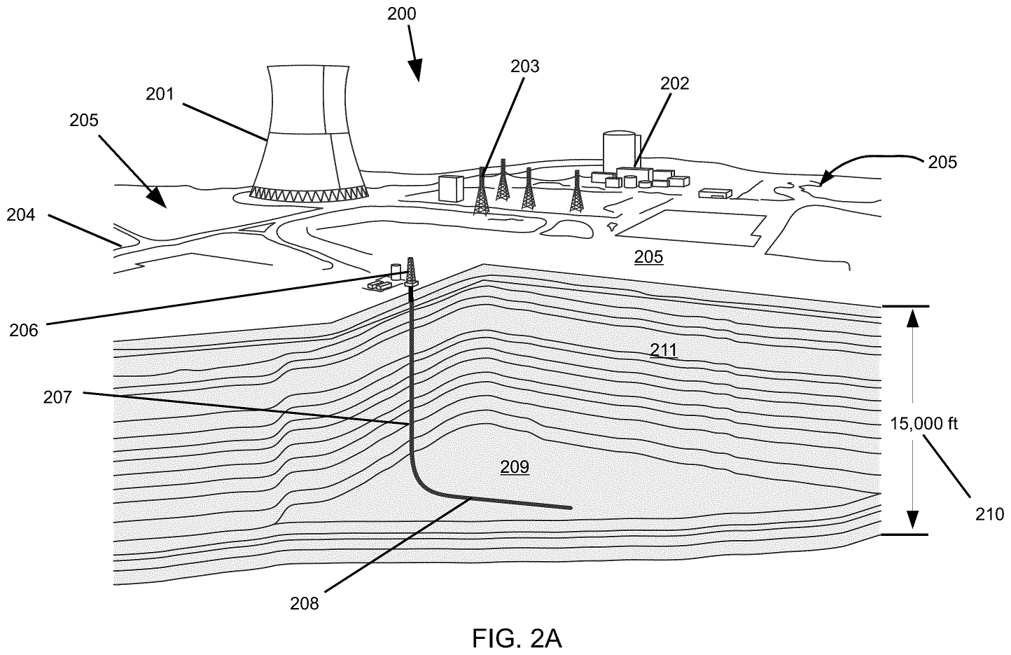

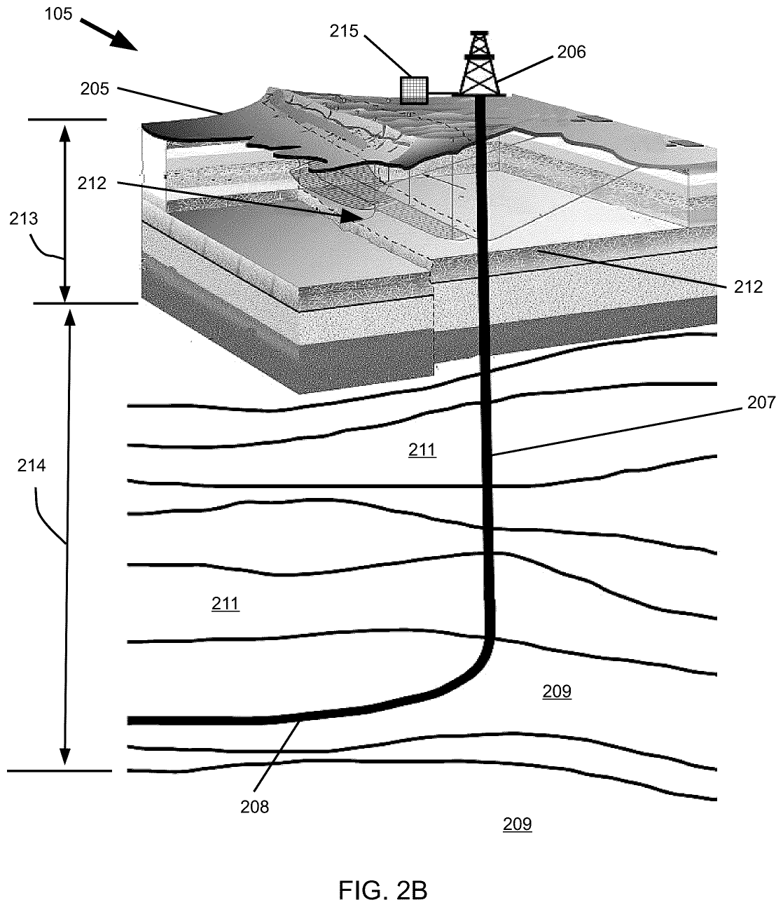

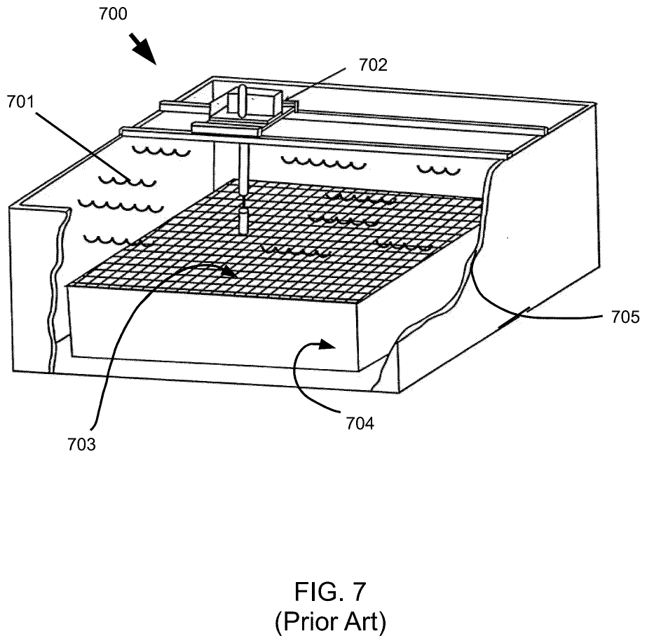

FIG. 2A may illustrate a generic surface schematic overview and a generalized vertical cross-section “cut-out” of a location wherein a HLW repository may be implemented at an operating or closed nuclear power plant 200 site; i.e., at a site corresponding to sites 101 or sites 102 in map 100. The nuclear power plant 200 has its associated onsite cooling tower(s) 201, various onsite building(s) 202, and high electrical power transmission lines 203. The nuclear power plant 200 is typically sited in an areally large, secure guarded compound, with infrastructure roads 204, generally in a readily accessible ground site, without hilly or mountainous terrain at the terrestrial surface 205 onsite. The nuclear power plant 200 may have one or more onsite cooling pond system(s) 700 (see e.g., FIG. 7). The typical operating power plant 200 may represent a fully licensed, fully regulated, multi-billion-dollar investment constructed over many years, and as such, has been fully seismically, geologically, and environmentally investigated beforehand; and it is thus, safe to consider that the site of nuclear power plant 200 is seismically safe from earthquake activity, erosional problems, flooding, and/or other localized weather events. Furthermore, the nuclear power plant 200 site may be implemented with protective fencing and/or walled enclosures. The nuclear power plant 200 site may have available ongoing technical and capable mechanical operator personnel who may be needed for the management of the processes needed for HLW disposal as contemplated and taught herein.

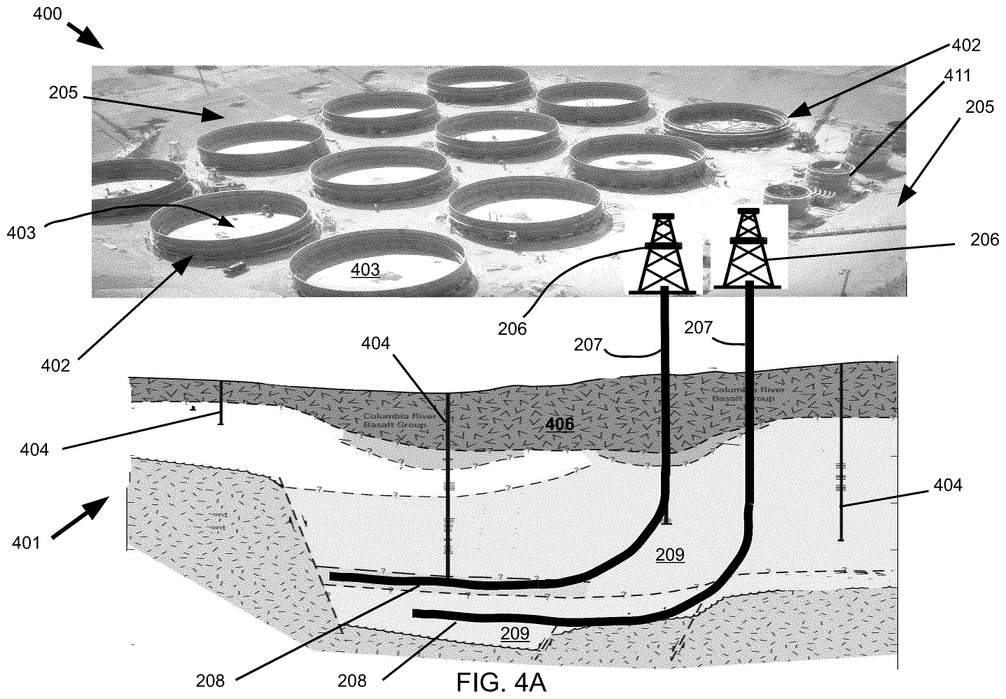

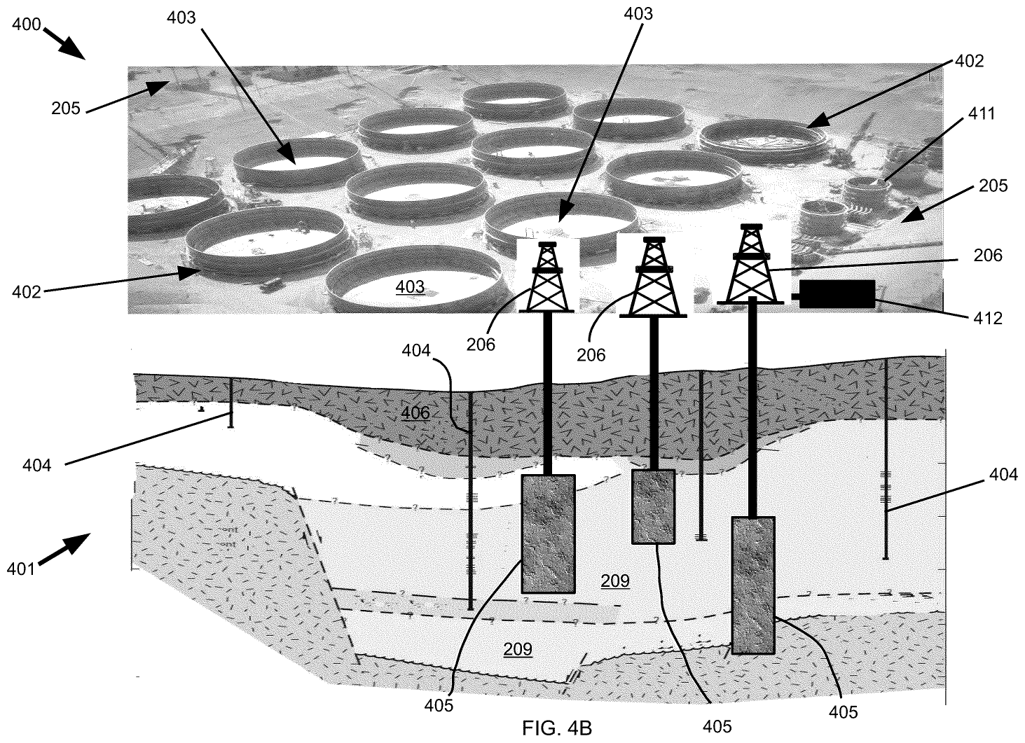

Continuing discussing FIG. 2A, in some embodiments, at least one (modified) drilling rig 206 may be stationed, positioned, and/or located on terrestrial surface 205, “behind the power plantfence,” operating within the confines of the nuclear power plant 200 compound. In some embodiments, drilling rig 206 may be used to drill out pilot hole(s), (main) vertical wellbore(s) 207, lateral (horizontal) wellbore(s), human-made cavern(s) 405, portions thereof, combinations thereof, and/or the like onsite but below nuclear power plant 200 site/compound. In some embodiments, drilling rig 206 may first drill at a predetermined and selected location of terrestrial surface 205 within the overall confines of the nuclear power plant 200 site/compound, a vertical wellbore section 207 of the disposal system usually vertically downwards into the schematically shown disposal formation 209. At a preselected vertical point below the terrestrial surface 205, called the kick-off point, the drilled vertical wellbore 207 is controllably turned laterally or horizontally as shown forming lateral wellbore 208, into the disposal zone 209 forming the long lateral wellbore 208, in whose internal volume, when mechanically completed, forms a long hollow cylindrical volume suitable and capable for HLW capsule emplacement and disposal. In some embodiments, (long) lateral wellbore(s) 208 may be referred to as SuperLAT™. In some embodiments, any portions of a given lateral wellbore 208 (SuperLAT™) that may house/receive HLW/SNF and/or the like, may reside entirely within a given disposal zone 209. In some embodiments, the deep distal portion of vertical wellbore 207 may terminate into a human-made cavern 405 located within the disposal zone 209 (see e.g., FIG. 4B for human-made cavern 405). In some embodiments, vertical wellbore(s) 207, lateral wellbore(s) 208, and/or human-made cavern(s) 405 of a given nuclear power plant 200, may be all/each be located directly vertically below that nuclear power plant 200 site/compound, with respect to the areal boundary/confines of that nuclear power plant 200 site/compound.

Continuing discussing FIG. 2A, in some embodiments, disposal zone/formation 209 may be a geologic rock formation of predetermined qualities. Petrophysical formation and a geological formation properties' analysis may be utilized to obtain an optimal site location for the waste repository 209. With regard to the petrophysical formation properties, these may describe physical and chemical rock properties and their interactions with native fluids or drilling fluids. Some of the key properties studied in petrophysics may be lithology or differences of formation strata, porosity, water saturation, permeability, fractured systems, formation density, and/or the like. The interactions of formations with drilling fluids can create unintended and costly situations like washouts where enlargement of the hole size during drilling can occur if careful analysis and adherence to safe drilling policies are not followed prior and after drilling begins. The petrophysical formation properties may be calculated and analyzed using existing engineering and well-known geological methodologies to allow proper selection of the disposal zone. With regard to the formation geological properties, it may be necessary that a suitable deep geologic repository 209 has the prerequisite physical characteristics of: stratigraphic continuity; hydrodynamic closure; and the lateral size, range, and extension to allow long-term sequestration of HLW (and/or the like) in the large extended substantially lateral wellbores 208. The formation geological properties data may be collected by seismic or exploratory logging, and/or predetermined other means commonly used in oilfield exploratory operations and analyzed using existing engineering and well known petrophysical methodologies to allow proper selection of the disposal zone 209.

Continuing discussing FIG. 2A, in some embodiments, disposal zone 209 may be located at or below a depth/distance 210 below terrestrial surface 205. In some embodiments, depth/distance 210 may be below any water tables that are located directly vertically below nuclear power plant (operating or closed) 200 (or other such/similar site). In some embodiments, depth/distance 210 may be predetermined depth below terrestrial surface 205. In some embodiments, depth/distance 210 may be a minimum depth of 4,000 feet, plus or minus 2,000 feet, below terrestrial surface 205. For example, and without limiting the scope of the present invention, depth/distance 210 may be at a depth of at least 5,000 feet below terrestrial surface 205. For example, and without limiting the scope of the present invention, depth/distance 210 may be at a depth of at least 7,500 feet below terrestrial surface 205. For example, and without limiting the scope of the present invention, depth/distance 210 may be at a depth of at least 8,000 feet below terrestrial surface 205. For example, and without limiting the scope of the present invention, depth/distance 210 may be at a depth of at least 10,000 feet below terrestrial surface 205. For example, and without limiting the scope of the present invention, depth/distance 210 may be at a depth of at least 15,000 feet below terrestrial surface 205. In some embodiments, depth/distance 210 may be at a depth of over (more than) 15,000 feet below terrestrial surface 205. In some embodiments, depth/distance 210 may be at a depth of 20,000 feet, plus or minus up to 6,000 feet, below terrestrial surface 205. In some embodiments, depth/distance 210 may be at a depth of over (more than) 20,000 feet below terrestrial surface 205. In some embodiments, depth/distance 210 and disposal formation/zone 209 are implemented/designated as such, only if depth/distance 210 and/or disposal formation/zone 209 are located below known and local (relevant) water tables at and/or adjacent to the nuclear power plant 200 site. In some embodiments, depth/distance 210 may be below any known water tables and this deep location may provide for safety from radionuclide migration to terrestrial surface 205 even after the thousands of years of HLW residence/entrapment in the geological disposal formation/zone 209.

In contrast, near surface HLW repositories (e.g., WIPP site 106) have been shown to be affected by “modern water” i.e., rainwater which has been falling in the last several decades and has absorbed distinctive radioisotopes in quantities and ratios that are only recently attainable due to atmospheric nuclear bomb testing, and this rainwater has migrated downwards into the near surface storage formations, and which then may initiate degradation of HLW containers in near surface HLW repositories. Since the 1980s, this phenomenon has been scientifically proven by researchers examining the ratios of ³⁶Chlorine in the waters sampled over time in near surface caverns, tunnels, or mines. This observation makes it mandatory that any location to be developed for long-term HLW repository, be as deep below ground as possible, as illustrated in this invention, to prevent this radioisotope water migration problem. Deep implementation, below the water tables, as contemplated and taught herein mitigates the potential for migration of radioisotope rainwater into the disposal zone 209; and also, for the reverse movement of emplaced HLW material products away from the disposal zone 209 towards the surface 205.

Continuing discussing FIG. 2A, above disposal zone 209 and below terrestrial surface 205, may be one or more non-disposal geologic formation(s)/zone(s)/layer(s) 211. In some embodiments, non-disposal geologic formation(s)/zone(s)/layer(s) 211 may be located too shallow to terrestrial surface 205 to qualify as disposal zone 209. In some embodiments, non-disposal geologic formation(s)/zone(s)/layer(s) 211 may be located at least partially within known water table(s).

As contemplated in this patent application and in various embodiments of the present invention, the implementation of such deeply located lateral wellbore(s) 208 for HLW disposal repository onsite with respect to a given nuclear power plant 200 site/compound, provides multiple benefits.

FIG. 2B may illustrate the contemplated implementation of an onsite HLW deep geological disposal system at a current location such as Yucca Mt 105 in Nevada (NV). The FIG. 2B may illustrate the HLW deep geological disposal system elements to be added/implemented at the Yucca Mt site 105 that may be needed to make this type of currently non-operational site functional and operative for deep HLW disposal once implemented.

As developed in earlier years 1978-1990, the multi-billion-dollar site at Yucca Mt is a near surface mine tunnel repository in which the SNF capsules were to be disposed of in protected containers. The technical idea was that these SNF containing containers would be covered at some future date by extremely expensive titanium shields, to protect the SNF containing containers from the expected surface rainwater which has been demonstrated to be migrating downward through the near surface formations from the surface rainfall. As noted above, the presence of this type of migratory water which has been scientifically confirmed by ³⁶Chlorine isotope measurements scientifically may negate the beneficial use of Yucca Mt as a near surface shallow repository. That is, migrating rainwater will reach the proposed titanium shields and/or the SNF containers in too short of a time frame and will erode those protections also in too short a time frame.

In addition, retrofitting the SNF containers with titanium “umbrellas” may seem to be an impossible process given what has been learned or experienced recently at the Chernobyl Ukraine catastrophe, wherein mechanical/electrical devices were unable to function adequately in the extreme high radioactive environments near to and inside the spent Chernobyl nuclear fuel cores. Yucca Mt's only possible and feasible utilization may be as a deep geological repository 209 implemented at least 10,000 ft and as much as 15,000 feet below terrestrial surface 205 and in lateral wellbores 208 (and/or in deeply located human-made cavern(s) 405) as taught herein. It may be the only way to salvage parts of the billions of dollars already expended in trying to dispose HLW in a near surface environment at this Yucca Mt site 105.

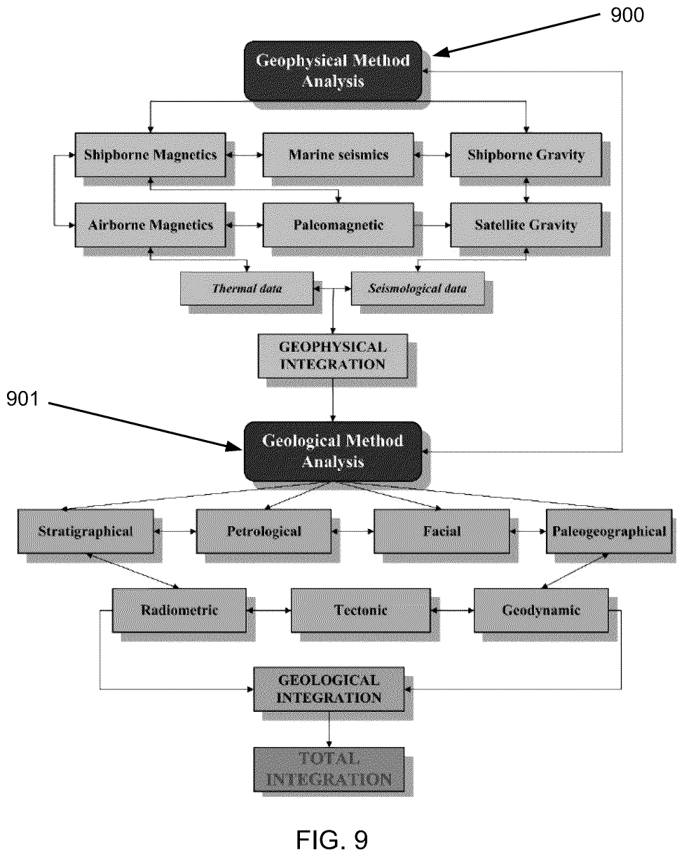

Continuing discussing FIG. 2B, the existing Yucca Mt site 105 comprises a dry arid desert areal region of the country (U.S). The terrestrial surface 205 at Yucca Mt site 105 may be considered a wasteland and the previously contemplated disposal formation 212 is only a few hundred feet underground, shown by shallow vertical depth distance 213 from the surface 205. In some embodiments, shallow vertical depth distance 213 may be a few hundred feet or less below terrestrial surface 205. Note, previously contemplated disposal formation 212 is considered and treated herein as a HLW non-disposal formation (at least because of previously contemplated disposal formation 212 close proximity to water table(s) and/or close proximity to migrating rainwater with radioisotopes). However, the Yucca Mt site 105 does have benefits. The area 105 is government owned, certified, and regulated under existing public law. There are no residents nearby, it is remote from the nearest metropolitan centers and has reasonable access to good highway systems. The deep geology is well described in both private, public, and government publications. The subterranean formations 209 and 211 may be drilled readily and safely using drill rig 206 and available operational service equipment in the oil and gas industry may be used and/or modified. It is contemplated that after a detailed geological and petrophysical analysis as discussed later under FIGS. 9, 10, and 11, at least one vertical wellbore 207 may be drilled at Yucca Mt from the surface 205 down to the repository zone 209; then lateral wellbore(s) 208 and/or human-made cavern(s) 405 may be implemented in deeply located geologic disposal zone/formation 209 below the Yucca Mt site 105; and then HLW may be emplaced into the void spaces formed within that disposal zone/formation 209. In some embodiments, deeply located geologic disposal zone/formation 209 may be located below deep vertical depth distance 214. In some embodiments, deep vertical depth distance 214 may be located below shallow vertical depth distance 213. In some embodiments, shallow vertical depth distance 213 plus deep vertical depth distance 214 may together total deep vertical depth distance 210. In some embodiments, vertical wellbore(s) 207, lateral wellbore(s) 208, and/or human-made cavern(s) 405 of the Yucca Mt 105 site, may be all/each be located directly vertically below the Yucca Mt 105 site, with respect to the areal boundary/confines of the Yucca Mt 105 site.

Today (circa 2022), with availability of trained drill rig crews and high horsepower drilling equipment (including drill rig 206), a 15,000-foot vertical wellbore 207 (as in FIG. 2A or in FIG. 2B) may be drilled and completed in less than five (5) weeks. Further the lateral wellbore 208 section(s) may be further drilled and completed within three (3) additional weeks of drilling time. Total cost of such drilling and completing this type SuperLAT™ disposal system infrastructure may be less than $25-30 million USD in 2022. This short time period and relatively inexpensive tens of millions dollars costs compared to the typical Yucca Mt costs of billions of dollars, may provide an example of the efficiency and cost-effectiveness of the herein contemplated processes wherein a SuperLAT™ disposal system as contemplated in this invention may be implemented in months, rather than decades as contemplated by other priorart systems such as the Yucca Mt site 105, near surface-tunnel mines, the Canadian DGR, and/or the Onkalo system in Europe, all of which are expected to require more than fifteen (15) years before initial disposal of HLW is possible with tens of billions of additional dollars expended.

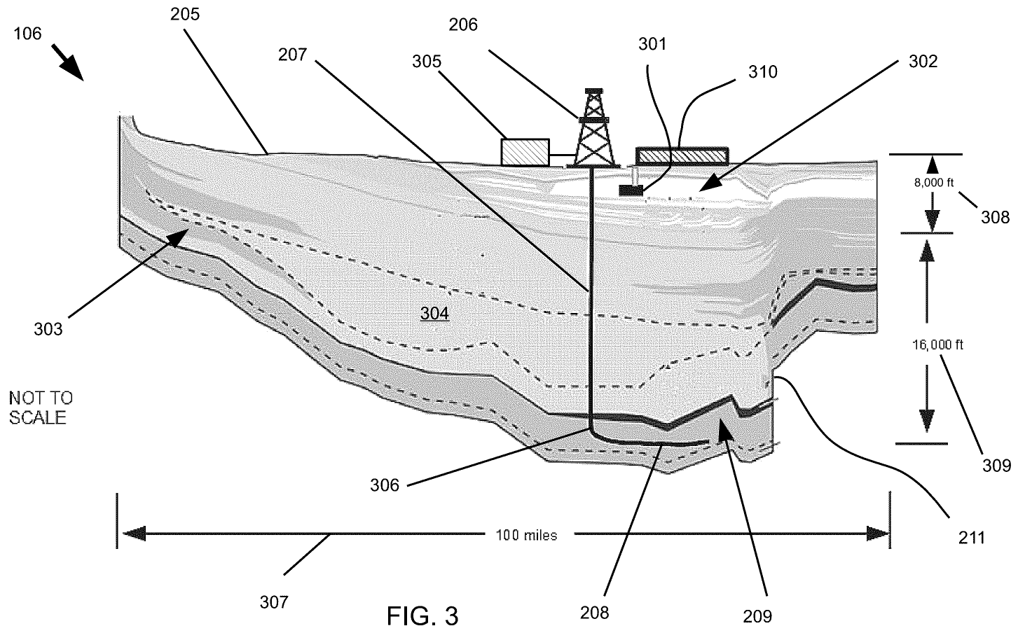

FIG. 3 may illustrate the contemplated implementation of an onsite HLW deep geological disposal system at a current location, such as Waste Isolation Pilot Plant (WIPP) 106 in New Mexico (NM) located about twenty-six (26) miles from Carlsbad, NM. This facility 106 is in a remote, sparsely populated area of the state with a relatively dry, desert-like climate. The site 106 has a capable road transportation system. The site 106 received its first shipment of HLW waste in March 1999. FIG. 3 may further illustrate the elements present at the WIPP site 106 and the added features that may be needed to make this type of site functional and operative today for deep geological HLW disposal as contemplated herein. This facility 106 is different to Yucca Mt. site 105. As developed, the $19 billion-dollar WIPP site 106 is a near surface mine typical mining-shaft from the surface 205, type operation forming a repository in which the SNF containing containers were to be disposed of by being stacked, “warehouselike,” in protected rooms 301 carved out of the salt deposits 302. The subsurface geology in the area of the WIPP 106 site may consists of several sedimentary layers of rock 303 and 304 which may also provide a protective radioisotope barrier because of the fact that these formations 303/304 are usually impermeable and are at a relatively large distance of several thousand feet below surface 205 ground level; thus mitigating, convective migratory flow of radioisotopes away from the repository zone 209. Reference numeral “310” in FIG. 3 may represent one or more building(s) where surface control operations may be handled therefrom for that WIPP site 106.

The original intent of this WIPP facility 106 was to sequester the waste in these dispersed subterranean rooms 301 in the salt formations 302 of the Salado Zone at/about 860 feet to 2,836 feet (ft) below the surface 205 as defined by the ERDA-9 geological wellbore drilling and analysis (1983). Thus, a depth of salt formations 302 may be comparatively shallow as compared to depth(s) of deeply located geologic rock disposal zone(s)/formation(s) 209. At the current WIPP site 106, and under the prior art proposed disposal system at WIPP site 106, it was contemplated that after many millennia of time, the rock salt 302 will hopefully creep and flow, and fully cover, and securely protect the sequestered waste materials within the underground protected rooms 301. However, the current subject patent application still considers this 2,836 ft level to be “near-surface” and inadequate to meet the rigorous demands for very long-term protection of HLW from radionuclide migration for millions of years.

Continuing discussing FIG. 3, deep HLW disposal may implemented below and onsite to the existing WIPP site 106 terrestrial surface 205 within deeply located geologic rock disposal zone(s)/formation(s) 209. Implementing an onsite disposal of HLW in deep geological zone(s) 209 as taught by embodiments of the present invention, at least one drill rig 206, with its associated systems 302, may be utilized to drill the SuperLAT™ wellbore system of at least one vertical wellbore 207 and at least one connected lateral (horizontal) wellbore 208 for HLW disposal within the at least one connected lateral (horizontal) wellbore 208. FIG. 3 illustrates that the drill rig 206 may be used to drill first the vertical wellbore 207 section. In some embodiments, this vertical wellbore 207 section of the wellbore is drilled and completed to a prescribed depth in order to reach and enter the disposal zone 209. In some embodiments, after drilling vertically downward to that pre-determined depth, the kick-off point 306, from this kick-off point 306, the vertical wellbore 304 is controllably turned lateral (or horizontal) and continued to be drilled into the disposal zone 209, forming a lateral volume within lateral wellbore 208, within disposal zone 209, in which HLW and/or waste materials may be emplaced.

Continuing discussing FIG. 3, the regional geological system that encompasses the WIPP facility 106 site is exceptionally large and may extend 100 miles laterally as shown by lateral extend 307. Because of this extensive lateral extend 307, the lateral wellbore(s) 208 within disposal formation 209 and directly vertically below lateral extend 307 may also be developed into considerable and extensive lengths of lateral extent for considerable volumes for HLW disposal therein. In some embodiments, a relevant vertical extent may be more than 20,000 feet (ft) and encompasses multiple sedimentary and non-sedimentary zones in which the HLW may be effectively disposed at even greater vertical depths if needed. Vertical depths 308 and 309 may illustrate the vertical relief shown in the region in excess of 24,000 feet below terrestrial surface 205. In some embodiments, vertical wellbore(s) 207, lateral wellbore(s) 208, and/or human-made cavern(s) 405 of the WIPP 106 site, may be all/each be located directly vertically below the WIPP 106 site, with respect to the areal boundary/confines of the WIPP 106 site.

Continuing discussing FIG. 3, in some embodiments, the salt formations 302 may provide radio-isotope containment functionality. In some embodiments, the salt formation 302 may provide some protective gamma-ray-shielding properties since the salt formation 302 only undergoes minor (minimal) radiolytic (molecular disassociation) change when exposed to radioactivity (below a certain predetermined threshold).

FIG. 4A may illustrate a composite schematic of a surface location and a vertical cross-section of an existing Hanford, Washington (WA) waste disposal site 400. FIG. 4A illustrates a contemplated implementation of an onsite HLW deep geological disposal system at the current location at the Hanford site 400. The Hanford site 400 encompasses more than 500 square (sq) miles and is located about thirty-five (35) miles north of Richland, WA, adjacent to the Columbia River. The Hanford site 400 was established in 1943 for the war effort for weapons production. The Hanford site 400 has a capable road transportation system. Currently, there is in excess of fifty-three (53) million gallons of HLW 403 onsite at the Hanford site 400 stored in near surface tanks 402 that are now deteriorating and creating massive environmental problems. There are serious problems at the Hanford site 400 and on the nearby near surface environment such as the nearby Columbia river and its associated basin environment. Billions of dollars have been allocated to clean up the Hanford site 400. Reference numeral “411” in FIG. 4A (and in FIG. 4B) may represent various surface facilities and/or surface buildings of Hanford site 400.

FIG. 4A may illustrate a least some the elements present at the Hanford site 400. These elements may include surface tanks 402, containing the material waste/slurry 403. These tanks 402 are near surface 205 or slightly below grade. FIG. 4A may also show the added features and/or elements that may be needed to make Hanford site 400 (and/or similar type sites) functional and operative for deep geological HLW disposal as contemplated and taught herein. Currently (2022), the multi-billion-dollar Hanford site 400 is a surface operations site in which it was contemplated that the collected millions of gallons of toxic waste are treated currently utilizing a $9 billion dollar surface vitrification process, after which the vitrified glass/waste is then stored in stainless steel cylinders. Afterwards, the stainless-steel containers/systems would then be transported away from the Hanford site 400 and these vitrified-waste-carrying capsules may then be finally disposed of by being stacked, “warehouse-like” in protected rooms 301 carved out of the shallow salt deposits 302 of the WIPP facility 106 discussed in FIG. 3 earlier. It was contemplated that after 10,000 years of residence inside the underground WIPP facility 106, the salt 302 may creep and engulf the stainless-steel waste capsules located therein. There may be an inherent technical and engineering fallacy with the current WIPP process. The WIPP depth is about 2,150 feet, which is considerably less than the four thousand feet minimum depth 210 contemplated in various embodiments as taught herein for long-term deep HLW disposal. In addition, WIPP uses a removable load distributing fluidized medium of material, added to and completely covers up the waste steel capsules located within the storage rooms. However, there may be some difficulty in the expected creep process completely entombing the waste barrels which are surrounded by a fluidized bed of granular solids at this relatively shallow depth (e.g., both, granular fluidized material minimizes creep and shallow depth does not have the required deformational pressures needed to initiate creep). The fluidized granular material behaves as “a compressive load equalization system” which significantly reduces the ability of the salt to be compressed and crush the waste capsules. This WIPP process may not allow any salt creep as intended.

Continuing discussing FIG. 4A, in some embodiments, one or more drill rig(s) 206 may be located on surface 205, within the areal confines of the Hanford site 400. In some embodiments, from drill rig(s) 206 and via using 206, at least one vertical wellbore 207 may be formed and drilled down to deeply located geologic rock disposal zone(s)/formation(s) 209. In some embodiments, then from a distal portion of vertical wellbore 207 within disposal zone(s)/formation(s) 209, lateral (horizontal) wellbore(s) 208 may be formed within disposal zone(s)/formation(s) 209. In some embodiments, onsite surface HLW 403 may be emplaced within lateral wellbore(s) 208 within disposal zone(s)/formation(s) 209. Reference numeral “401” in FIG. 4A (and in FIG. 4B) may represent a subsurface cross-section aspect of geological zones in FIG. 4A (and in FIG. 4B) that may exist directly vertically below Hanford site 400 terrestrial surface 205. In some embodiments, subterranean geological disposal zone(s) 209 may provide repository formations in which the lateral disposal wellbores 208 of the SuperLAT™ system may be implemented. In some embodiments, drilling rigs 206 may be used to drill a plurality of disposal vertical wellbores 207 from the surface 205 for the implementation of the deep SuperLAT™ wellbores (lateral disposal wellbores 208). Initially the vertical wellbore sections 207 may be drilled down vertically to the kick-off points in disposal formation(s) 209. In some embodiments, then the lateral section(s) 208 may be controllably drilled from the distal portions of the vertical wellbores 207 into the repository zone(s) 209 to a preselected distance-depth below surface 205 and the wellbore disposal system completed. In some embodiments, existing exploratory/pilot wellbore(s) 404 may provide additional geological and/or stratigraphic analysis and rock data below the Hanford site 400; wherein such data and/or analysis may be desired or needed for empirical analyses as discussed later in FIGS. 9, 10, 11, and/or 14. Continuing discussing FIG. 4A, in some embodiments, the geology in the area of the Hanford site 400 may be reliably known and/or inferred from existing exploratory oil and gas well(s) 404; and/or by initiating new such exploratory/pilot drilling programs to analyze the geology as discussed later in FIGS. 9, 10, 11, and/or 14.

FIG. 4B is similar to FIG. 4A and FIG. 4B may illustrate a composite schematic of a surface location and a vertical cross-section of the Hanford site 400 as modified for deep HLW disposal; however, the Hanford site 400 shown in FIG. 4B may utilize human-made cavern(s) 405 instead of lateral wellbore(s) 208 or in addition to lateral wellbore(s) 208. Note, human-made caverns 405 may also be referred to and/or known as “SuperSILO™” systems. In some embodiments, drill rig(s) 206 may still be used to form at least one vertical wellbore 207 that reach to and/or extend into disposal formation(s) 209 located directly vertically below at least some portion of the areal boundary of Hanford site 400. In some embodiments, surface drilling fluids facilities 412 may be needed or desired to provide specialized fluids materials for the under-reaming (underreaming) operations. In some embodiments, at a distal portion of vertical wellbore 207 that is disposed away from surface 205, underreaming operations (via an underreaming tool that has been inserted into vertical wellbore 207 and controlled at least in part via and/or from drill rig 206 at surface 205) may be carried out vertically further downwards into disposal formation(s) 209, to form at least one human-made cavern 405 within disposal formation(s) 209. In some embodiments, underreaming operations within terminal/distal portions of a given vertical wellbore 207 essentially work by enlarging a diameter of such terminal/distal portions of the given vertical wellbore 207. In some embodiments, HLW 403 may be inserted into human-made cavern 405, via connected vertical wellbore 207. In some embodiments, a given human-made cavern 405 may be located entirely within a given disposal formation 209. In some embodiments, each human-made cavern 405, at its top, may be directly connected to at least one vertical wellbore 207 that leads to surface 205. In some embodiments, any portions of a given human-made cavern 405 (SuperSILO™) that may house/receive HLW/SNF and/or the like, may reside entirely within a given disposal zone 209.

Continuing discussing FIG. 4B in some embodiments, at the Hanford site 400, within the areal boundary of the Hanford site 400, a plurality of drill rigs 206 may be used. In some embodiments, at the Hanford site 400, within the areal boundary of the Hanford site 400, and below the Hanford site 400, a plurality of vertical wellbores 207 may be formed/implemented (by the plurality of drill rigs 206). In some embodiments, each such vertical wellbore 207, selected from the plurality of vertical wellbores 207, may reach to and/or extend into at least one disposal formation 209. In some embodiments, at the Hanford site 400, within the areal boundary of the Hanford site 400, and below the Hanford site 400, a plurality of vertically oriented human-made caverns 405 may be formed/implemented (by the plurality of drill rigs 206 and the plurality of vertical wellbores 207, using underreaming tools). In some embodiments, each such human-made cavern 405, selected from the plurality of human-made caverns 405, may be entirely located within at least one disposal formation 209. In some embodiments, as contemplated in this application, the onsite disposal of the high-level waste 403 that has accumulated on the surface 205 (e.g., within tanks 402) may be disposed of in deep human-made cavern(s) 405 or silo system(s). In some embodiments, these disposal SuperSILO™ systems 405 may be implemented in the selected disposal zone(s) 209 by drilling vertical wellbores 207 sections, then by controllably underreaming out the human-made storage caverns 405 below the smaller diameter vertical wellbores 207 sections. Given the vast areal expanse of the Hanford site 400, several to many deep human-made storage caverns 405 structures may be implemented within disposal zone(s) 209 to hold all of the millions of gallons of waste 403 at depths well below any surface waters, water tables, and in zones 209 that are structurally and hydraulically closed; and can thus, prevent vertical migration and environmental contamination by the disposed waste 403.

In some embodiments, the deep HLW disposal teachings of FIG. 4A and of FIG. 4B may be combined, mixed, and/or matched; i.e., both lateral wellbore(s) 208 and human-made cavern(s) 405 may be used beneath a given surface site (e.g., the Hanford site 400); or only lateral wellbore(s) 208 may be used/implemented; or only human-made cavern(s) 405 may be used/implemented.

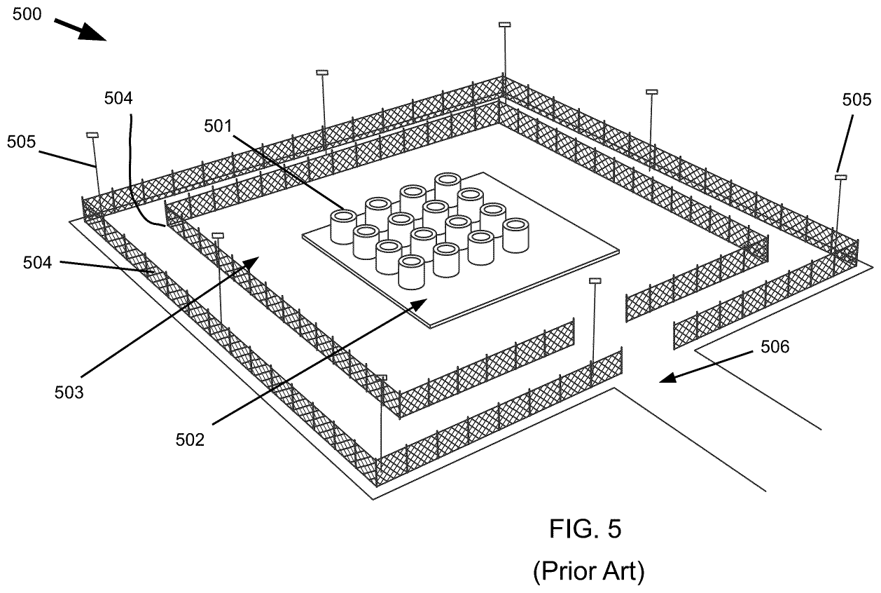

FIG. 5 may illustrate the implementation of a prior art proposed consolidated interim storage facility 500 for HLW material on the surface 205. The waste materials are usually stored in vertical cylindrical concrete casks 501 that weigh as much as 250,000 pounds (lbs) per cask 501. The storage may also be horizontal on the surface in robust structural racks. The storage facility usually consists of a concrete or gravel pad 502 which is setup on the ground or slightly below grade level 503 on which are stored the HLW material casks 501. The overall surface storage system is rather primitive, with lights 505, with double fences 504, and with egress and entry roads 506. To date (2022), these consolidated interim storage projects (CISP) 500 have not been approved anywhere in the U.S. and there is violent and considerable public opposition to CISP 500 use because CISP 500 are considered to be providing several hundreds of potential failure points, each failure emanating from each and every cask 501 stored on the concrete/gravel pad 502, and which individually are subject to mechanical, erosional, and other failure modes during surface storage.

In common practice today (2022), these CISP 500 operations business models have been accused of being the foundation of an industry that has developed a simple perpetual financial model; the forever surface warehousing of HLW. The relatively simply constructed casks 501 are extremely costly to make and maintain, and as such generate a profitable cash flow for the HLW surface storage companies. Some recent U.S. congressional hearings have alluded to these CISP 500 storage facilities as solely setup for a simple continuous money generating apparatus rather than solving the nuclear waste problem.

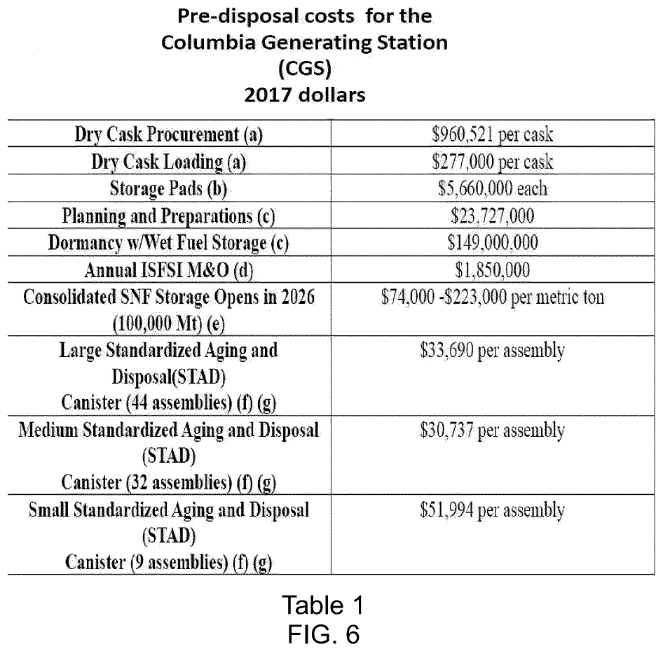

Published costs data (2017) shown in FIG. 6 (Table 1) indicate that just a single cask 501 has an associated actual cost of more than two million dollars ($2,000,000). And a given CISP 500 storage facility could have dozens, to hundreds, to thousands of such casks 501. These are massive costs that detract from utility of CISP 500 storage facilities. It should be noted that the systems shown in FIG. 5 do not even solve the HLW disposal problem. CISP 500 storage facilities only generate extravagant governmental waste and costs, that have to be repeated every time the surface storage has to be moved and finally disposed of in a deep geological repository.

FIG. 7 illustrates a typical (prior art) cooling pond system 700 containing water 701 for cooling SNF, implemented at an operating or non-operating nuclear power plant site 101/102, respectively. The system 700 consists of a fuel handling bridge 702 (SNF material handler 702) which is often just basically a gantry apparatus capable of two-dimensional excursions and having operative devices to enable the catch, transport, and release of the SNF rods 703 that are stored under cooling water 701 in the pool/pond 704. The cooling pool/pond 704 is protected usually by dual walled systems 705. The cooling pond system 700 may be seriously affected by breakdown in the cooling water 701 circulation system. The vertical placement of SNF rods 703 in the cooling ponds 704 may allow for easier future encapsulation of the waste assemblies by mechanical means before transport to the disposal sites. In some embodiments, a deep HLW disposal system may be implemented onsite with respect to a given cooling pond system 700 (see e.g., FIG. 2A).

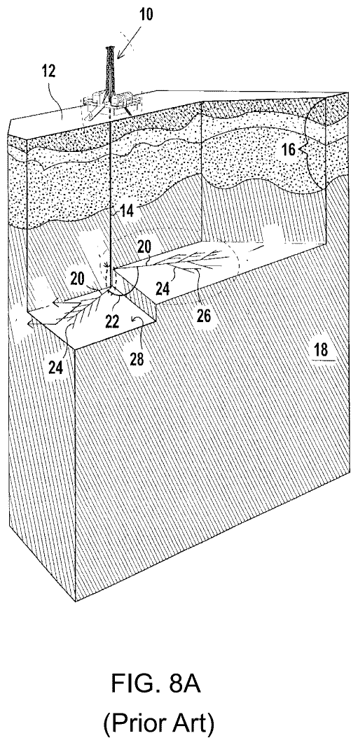

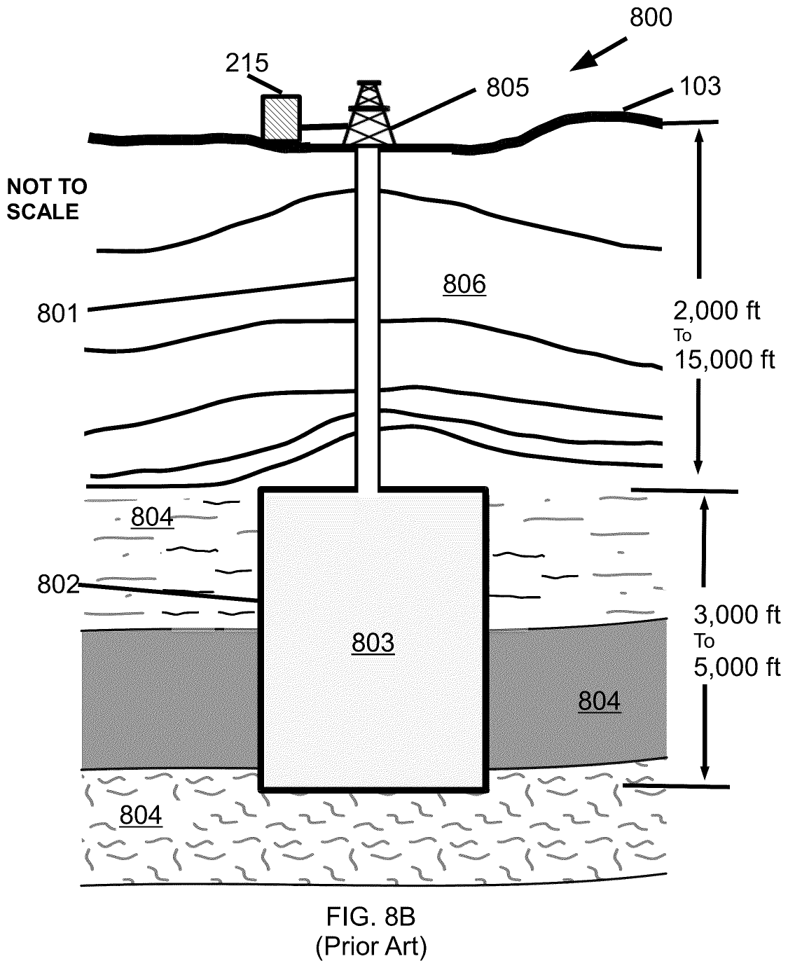

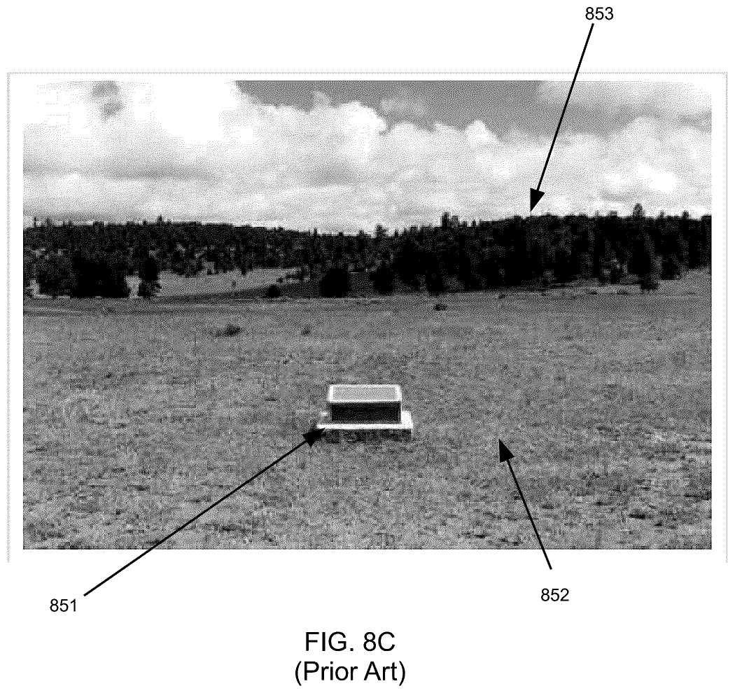

FIG. 8A is a reproduction of a FIG. 1 from a prior art patented system from U.S. utility Pat. No. 6,238,138, by the same inventor that describes the use of deep lateral wellbores implemented in geological formations. Note, the reference numerals in FIG. 8A are as disclosed in U.S. utility Pat. No. 6,238,138. This FIG. 8A shows the basic SuperLAT™ system for disposal/retrieval of HLW in capsular form in the wellbore laterals. This type of HLW disposal system may be implemented directly vertically below existing (or future) operating and nonoperating nuclear power plant sites 101/102 or surface storage locations today, if below such surface sites are appropriate deeply located geologic rock disposal zone(s)/formation(s) 209.

FIG. 8B illustrates a deep HLW disposal system based on a prior art invention taught in the patented inventions of U.S. utility Pat. No. 10,807,132 by the same inventor that describes the use of deep human-made cavern systems 800 implemented in deeply located disposal geological formation(s) 804 to be used for HLW disposal. Note, the reference numerals in FIG. 8A are as disclosed from the present/current patent application and not from U.S. utility patent 10,807,132. The FIG. 8B shows the basic SuperSILO™ system for disposal of HLW in liquid, solid, or slurry form 803 within a human-made cavern 802; wherein that human-made cavern 802, with its HLW 803, is entirely located within one or more deep geologic formation(s) (disposal zone(s)) 804. The deep geologic formation(s) (disposal zone(s)) 804 may be located below one or more subterranean geological zone(s) 808. In addition to at least one human-made cavern 802, the HLW disposal system 800 may also comprise at least one drill rig 805 and at least one vertical wellbore 801. This type HLW disposal system 800 may be implemented at the existing (or future) operating and non-operating nuclear power plant sites 101/102 or at surface storage locations (see e.g., FIG. 4B). These disposal systems may be implemented well below the levels of the water tables in the contemplated near surface systems such as, but not limited to, the Yucca Mt. site 104, the WIPP site 106, the Hanford site 400, and/or other near surface systems.

In some embodiments, (main and long) vertical wellbore 801 may be used interchangeably with (main and long) vertical wellbore 207. In some embodiments, human-made disposal/storage cavern 802 may be used interchangeably with human-made storage cavern 405. In some embodiments, HLW 803 may be used interchangeably with HLW 403. In some embodiments, deep geologic formation (disposal zone) 804 may be used interchangeably with deep geologic formation (disposal zone) 209. In some embodiments, drilling rig 805 may be used interchangeably with drilling rig 206. In some embodiments, subterranean geological zone(s) 808 may be used interchangeably with non-disposal zone(s)/formation(s) 211.

FIG. 8C illustrates the only actual approximately two (2) foot (ft) by two (2) ft surface marker 851 today, indicating the location in New Mexico (NM), where a massive 66-kiloton nuclear device was detonated on Dec. 10, 1967, in a deep wellbore at 5,838 feet (ft) to 6,689 ft below ground in project Gasbuggy, in an effort to stimulate natural gas production. Marker 851 is the rather nondescript cement marker covering the buried disposal wellhead. Grounds 852 is the undisturbed ground area surrounding the marker 851. Grounds 852 refers to the grounds immediately surrounding and/or adjacent to marker 851. Grounds 852 is generally flat. Surrounding-area 853 refers to the land surrounding and/or adjacent to grounds 852.

The SuperLAT™ HLW disposal system disclosed and taught herein may utilize a similar single surface maker to indicate the burial of millions of pounds HLW in deeply located geologic rock disposal formation(s)/zone(s) 209, such as, but not limited to, at 15,000 feet or more below ground in a plurality of sealed and protected lateral wellbores 208 and/or within sealed and protected human-made cavern(s) 405.

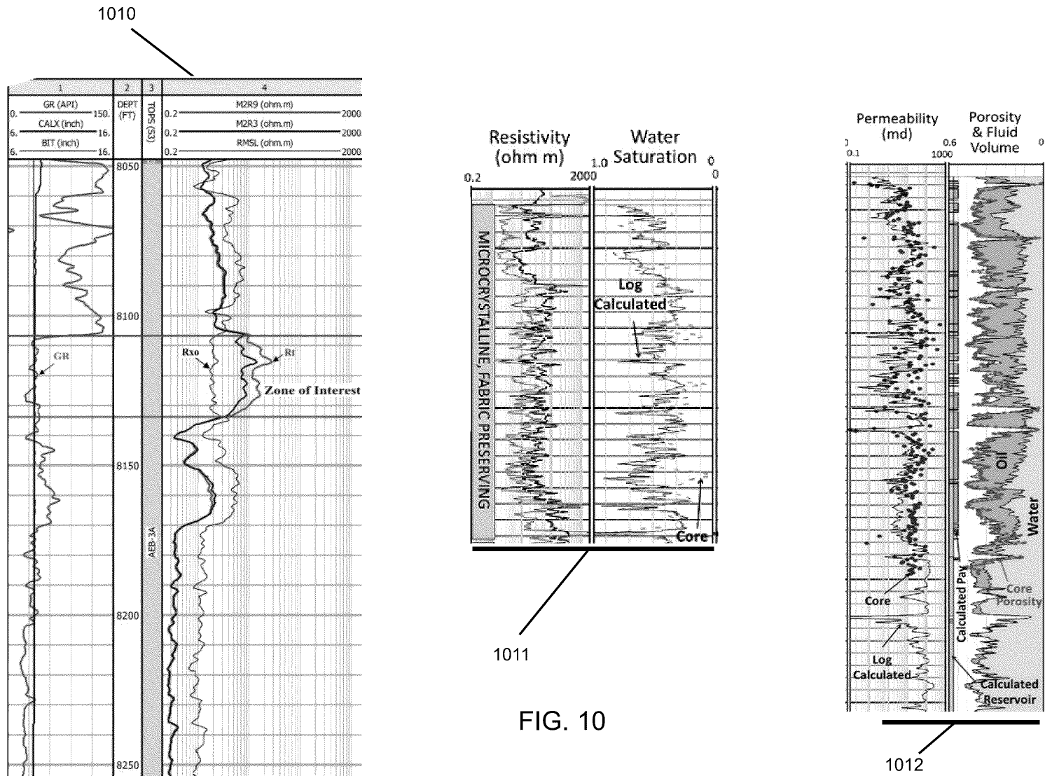

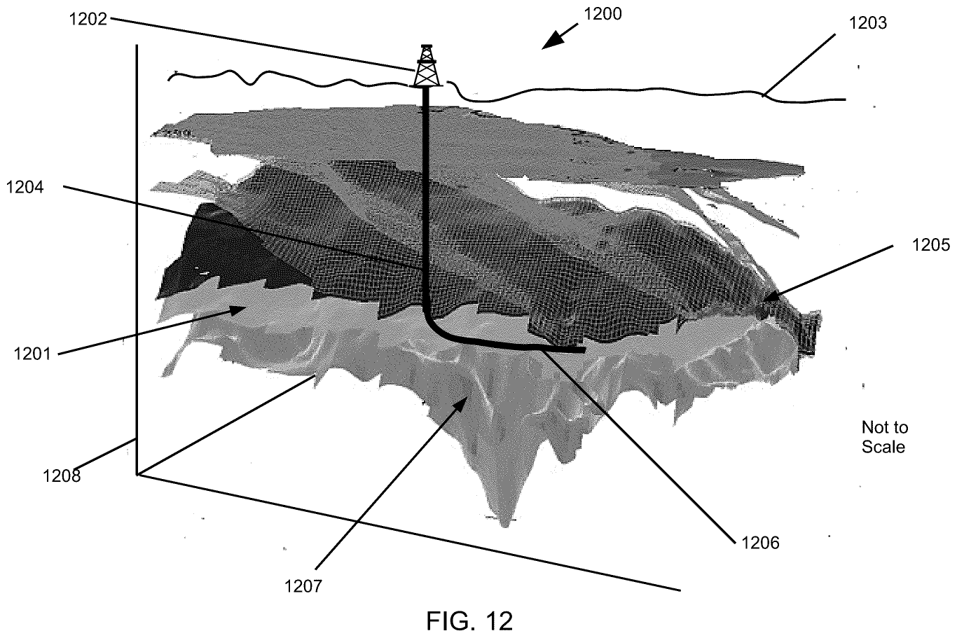

FIG. 9 may illustrate and summarize at least some of the exhaustive analyses that may provide sufficient data and/or information for determining whether implementing the SuperLAT™ and/or the SuperSILO™ HLW disposal systems at operating or non-operating nuclear storage sites 101/102 and/or nuclear surface sites across the U.S., Yucca Mt site 105, the WIPP site 106, Hanford site 400, and/or the like, may be physically feasible and/or desirable. Geophysical analysis method(s) 900 may produce geophysical data. Geological analysis method(s) 901 may produce geological data. This type of dual analysis is well developed today, and these techniques are available from multiple sources in the private sector. Geophysical analysis method(s) 900 may comprise at least one of the following types of analyses: shipborne magnetics; marine seismics; shipborne gravity; airborne magnetics; paleomagnetic; satellite gravity; thermal data; seismological data; geophysical integration (which may be a cumulation of conducted geophysical analyses); portions thereof; combinations thereof; and/or the like. Geological analysis method(s) 901 may comprise at least one of the following types of analyses: stratigraphical; petrological; facies; paleogeographical; radiometric; tectonic; geodynamic; geological integration (which may be a cumulation of conducted geological analyses); portions thereof; combinations thereof; and/or the like. Results from geophysical analysis method(s) 900 and geological analysis method(s) 901 may also be combined (i.e., “Total Integration” in FIG. 9). Note, some of example results of the analyses of FIG. 9 are shown later in FIG. 10 and FIG. 12.

FIG. 10 may illustrate in pictorial and (color-coded) graphic formats, the results of at least some of the studies/analyses implemented in FIG. 9. Note, while FIG. 10 is shown in black and white and/or grayscale, in actuality, FIG. 10 may be in color and various color coding may be used to help read and/or understand FIG. 10. These FIG. 10 results may be obtained by using downhole logging tools, including video-imager systems and then processing the massive quantities of measured data collected using sophisticated algorithms to evaluate, quantify, and define the rock and fluid properties at the “near wellbore” and at the “far wellbore zones.” In some embodiments, these algorithms and/or software may be preexisting and/or predetermined. By contrast, this type of critical technical analysis is usually not available or even attempted through the walls of near surface tunnels or mines used for near surface waste disposal. This processing and analytical ability indicates the additional superiority of the methods contemplated in the lateral wellbore 208 systems and/or in the human-made cavern(s) 405 versus those usually contemplated in mining/tunnel systems that are near to water tables. Section 1010 of FIG. 10 shows the analyzed well logging traces as recorded by the downhole logging instruments. Section 1011 may show rock fluid saturations and rock thicknesses among other recorded parameters (such as, but not limited to, resistivity). Section 1012 may show the calculated volumes of interstitial fluids in the rock. See e.g., FIG. 10.

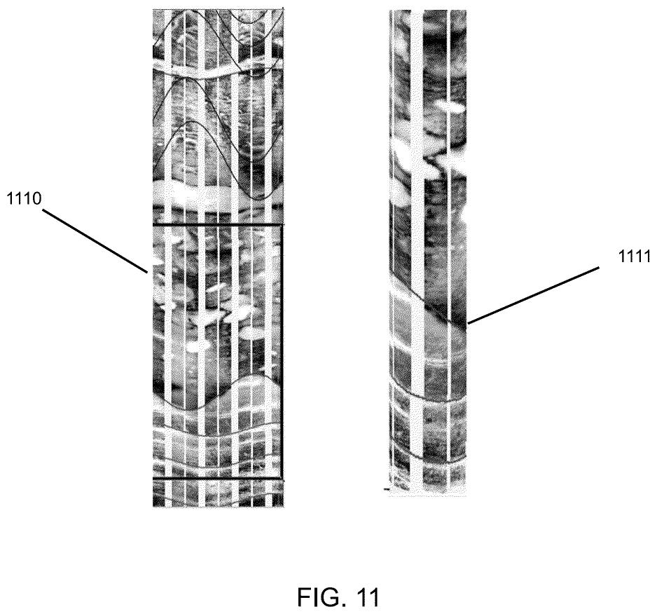

FIG. 11 may illustrate a graphic rendition of some results of the analyses/studies implemented using FIG. 9 as the analyses framework, and/or interpretations of FIG. 10 data/results and/or the like. FIG. 11 may show a graphic display output from high-quality (high-resolution) video borehole images 1110 and/or images/renderings of fractures 1111 in borehole adjacent formation(s). This type of sophisticated detailed analyses/results from FIG. 9, FIG. 10, and FIG. 11 allows for three-dimensional (3D) modelling of the deep geologic rock formations below sites shutdown nuclear (power plant) site 101, operating commercial nuclear (power plant) site 102, interim storage site 103, interim storage site 104, Yucca Mt site 105, WIPP site 106, Hanford site 400, and/or the like, that may qualify as deeply located geologic rock disposal zone(s)/formation(s) 209. FIG. 11 data may provide accurate geologic rock formations dip and fracture orientation both or either of which may support for successful implementation of the deep HLW disposal systems (e.g., using lateral wellbore(s) 208 and/or human-made cavern(s) 405) taught herein. These types of analyses may be important in providing the types of data that allow the geologic rock formations to be selected as deeply located geologic rock disposal zone(s)/formation(s) 209 and for such repositories 209 to be fully defined and allow for secure implementation of the deep HLW disposal systems as taught herein.

FIG. 12 may illustrate a graphic rendition of the compilation of all the data derived from the analyses of FIG. 9, and/or the data from FIGS. 10 and 11 into a coherent geologic 3D (digital) model 1200 of a potential modeled disposal repository zone 1201. FIG. 12 may show a 3D visual (digital) model 1200 showing a location of at least one modeled drill rig 1202 on a modeled terrestrial surface 1203, position of at least one modeled vertical wellbore 1204 passing through at least one modeled non-disposal rock formation(s) 1205 and extending into modeled disposal repository zone 1201, and at least one modeled lateral wellbore 1206 that is also located entirely within the modeled disposal repository zone 1201 and that extends from a distal/terminal end portion (that is disposed away from modeled terrestrial surface 1203) of modeled vertical wellbore 1204. In some embodiments, 3D digital/rendered model for deep HLW disposal system 1200 may also show one or more other modeled formation(s) 1207, which may be located below modeled disposal repository zone 1201. In some embodiments, 3D digital/rendered model for deep HLW disposal system 1200 may also comprise at least one predetermined coordinate/axis system 1208. In some embodiments, 3D digital/rendered model for deep HLW disposal system 1200 may be virtually rotated along multiple axes to show various operational aspects of the planned/modeled SuperLAT™ and/or SuperSILO™ systems. In some embodiments, various elements and/or aspects of 3D digital/rendered model for deep HLW disposal system 1200 may be selected, de-selected, hidden, and/or the like. In some embodiments, cross-sectional views, partial views, cutaway views, detailed views, and/or exploded views may be generated of 3D digital/rendered model for deep HLW disposal system 1200 and/or of its elements.

Furthermore, using the available computational processing power today (and into the near future), artificial intelligence, and/or virtual reality systems, an analyst may virtually “walk through” the proposed and modeled repository sites, looking at detailed sections, to determine the acceptability of the specific site. It should be noted that only the depiction of a SuperLAT™ disposal system is shown in FIG. 12, however a similar graphic for the SuperSILO™ system may also be developed and illustrated to show the use of the massive human-made caverns for HLW waste disposal. This “Big-Data,” virtual reality, synergistic approach may synthesize of at least some to all of the available information of the investigated geological system to allow rapid evaluation, critical analysis and to minimize omission or engineering errors that may occur when handling such a large database system of information.

In some embodiments, when the elements of 3D digital/rendered model for deep HLW disposal system 1200 get implemented in the real world, those modeled elements may then have real word analogs/equivalents. For example, and without limiting the scope of the present invention: modeled disposal repository zone/formation 1201 may be analogous/equivalent to real world disposal repository zone/formation 209; modeled (modified) drilling rig 1202 may be analogous/equivalent to real world drill rig 206; modeled terrestrial surface 1203 may be analogous/equivalent to real world terrestrial surface 205; modeled (main and long) vertical wellbore 1204 may be analogous/equivalent to real world (main and long) vertical wellbore 207; modeled non-disposal rock formation(s) 1205 may be analogous/equivalent to real world non-disposal rock formation(s) 211; and modeled (long) lateral wellbore 1206 may be analogous/equivalent to real world (long) lateral wellbore 208.

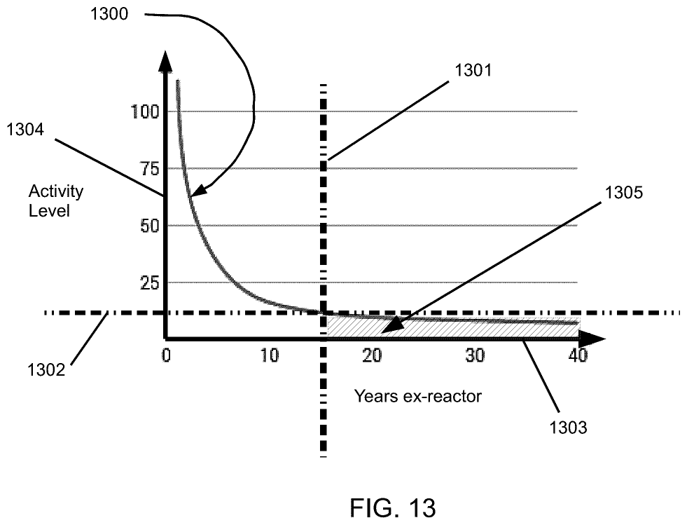

FIG. 13 may be graph/chart depicting the activity level of the SNF assembly radioactive material versus time as the SNF material resides in the cooling ponds 704 or in some type of onsite surface storage. Activity level is well known in the relevant arts and may be considered to establish the radioactivity toxicity of the SNF material. This FIG. 13 graph/chart may be considered to be a “cooling curve” of the SNF waste material since after the SNF is removed from use in power generation, the SNF materials continues to radiate sensible heat as the radioactive products activity decays over time. The decay curve 1300 shown in this FIG. 13 is shown utilizing two axes, with the vertical 1304 or Y-axis 1304 representing the level of activity in the SNF starting at 100% at the initial or zero point in time. The horizontal axis 1303 is the X-axis 1303, or the time axis depicted in years after the cooling begins at the power plant storage location. As shown in FIG. 13 the horizontal axis begins at zero and extends past forty (40) years.

Continuing discussing FIG. 13, the decay curve 1300, shows an exponential type of decay rate between time zero and the time at vertical line 1301, there is a critical time after which the activity level may be below a pre-determined critical level 1302. The area 1305 bounded by line 1301 horizontally and line 1302 vertically illustrates the times and activity levels during which the SNF may be removed and safely managed for disposal, such as deep HLW disposal at taught herein.

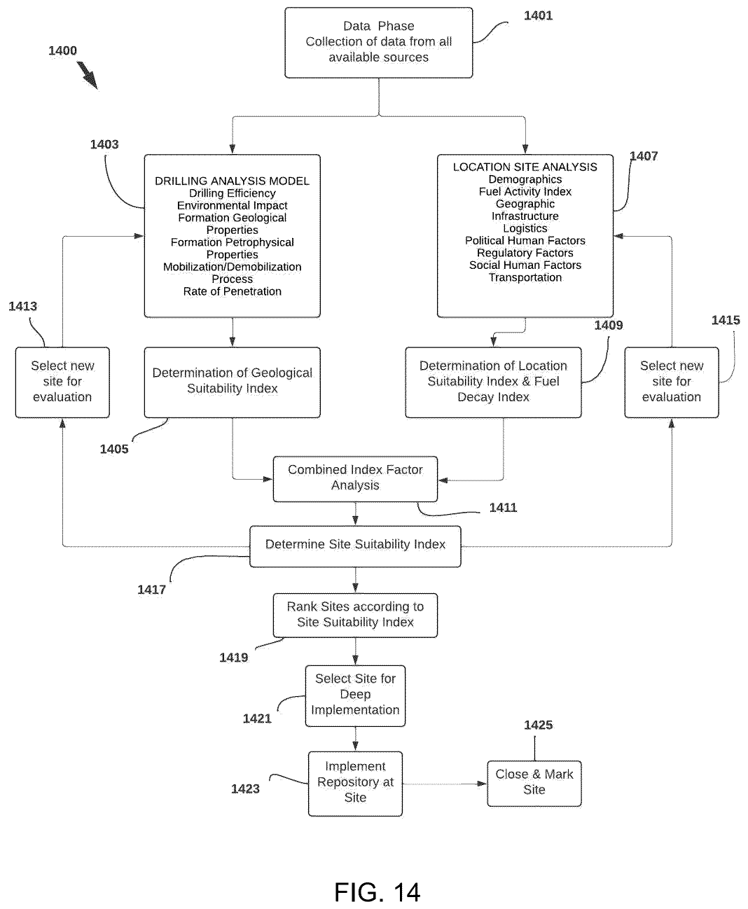

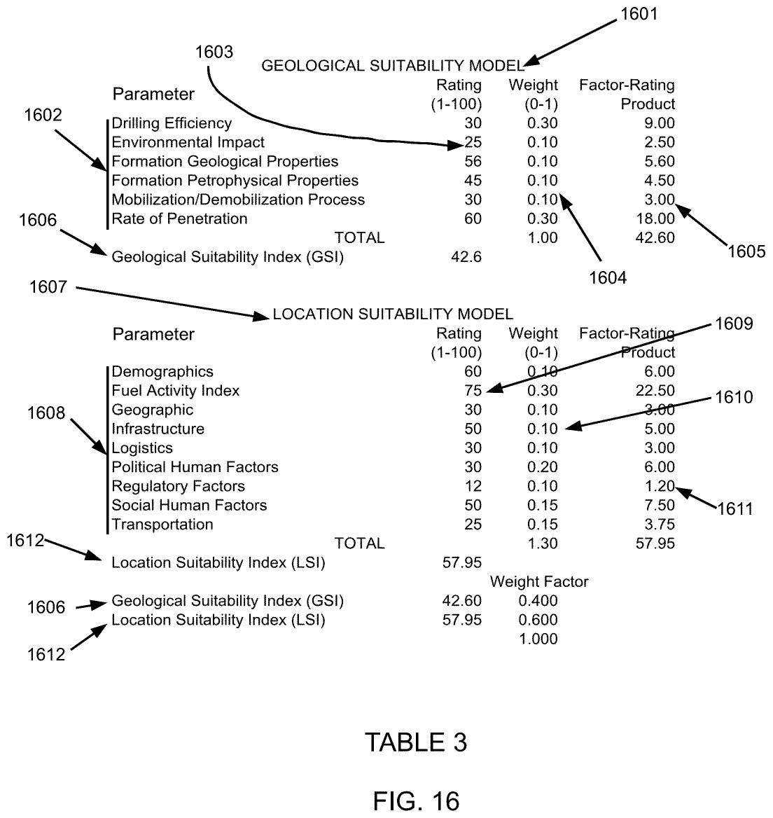

FIG. 14 (method 1400), FIG. 15 (Table 2), and FIG. 16 (Table 3) may work together and/or complement each other with respect to implementing deep (below water tables) HLW disposal repositories below existing (or future) nuclear surface (or near surface) sites such as, but not limited to, shutdown nuclear (power plant) site(s) 101, operating commercial nuclear (power plant) site(s) 102, interim storage site 103, interim storage site 104, Yucca Mt site 105, WIPP site 106, Hanford site 400, cooling pool(s)/pond(s) 704, portions thereof, combinations thereof, and/or the like.

The inventive method(s) fundamentally may consider at least one or more of: each existing (or future) physical nuclear surface (or near surface) site and that site's particular conditions; including SNF decay rates; state/status of onsite SNF decay/age; environmental, social, regulatory, and/or political conditions/issues for each site; geophysical analyses at each site; geological analyses at each site; geographic considerations of each site; miscellaneous related infrastructure assets at each site (such as, but not limited to, roads, buildings, vehicles, machinery, equipment, power, personnel, and/or the like); portions thereof; combinations thereof; and/or the like. With such data and/or information, such existing (or future) nuclear surface (or near surface) sites may be ranked in an objective manner with respect to a goal of implementing at least one onsite deep (below water tables) HLW disposal repository; and better ranking sites may then receive implementation of at least one onsite deep (below water tables) HLW disposal repository as taught herein.

In some embodiments, there may be three (3) separate factors or indices which are computed in this inventive method as follows: (i) the geological suitability index, (ii) the location suitability index, and (iii) the fuel decay index. In some embodiments, then all three (3) of these assigned indices for each particular existing (or future) nuclear surface (or near surface) site may be combined to form a calculated index, referred to herein as the “site selection index” (“SSI”) for each such site. And then different may be compared by comparing their respective site selection index scores, with a higher score indicating a better candidate site for implementing at least one onsite deep (below water tables) HLW disposal repository as taught herein.

HLW storage and/or disposal is a complex issue that has confounded the U.S. government and other agencies worldwide for decades and there exists a need to make decisions which allow these dangerous materials to be removed from the surface and near surface areas and thus protect the environment. The inventive method(s) taught herein do just that.

FIG. 14 as a flow chart that illustrates at least some of steps of a method 1400. FIG. 15 (Table 2) illustrates at least some of the parameters and elements at a qualitative and descriptive level that may be analyzed to provide additional input into method 1400 of FIG. 14. FIG. 14 may provide a granular level illustration of the data and computations that are combined and utilized in reaching a decisive list of ranked existing (or future) nuclear surface (or near surface) sites 1511, from which at least some (or one) such sites 1511 may be selected for implementation of at least one onsite deep HLW disposal repository, and that at least one onsite deep HLW disposal repository implemented at each such selected site 1511.

FIG. 14 illustrates a flow chart of an overall process of data gathering, determining, ranking, and/or selecting existing (or future) nuclear surface (or near surface) sites 1511 for potential onsite disposal of HLW in deep geological zones directly vertically below the given selected site 1511; and/or then implementing at least one such onsite deep HLW disposal repository at the selected existing (or future) nuclear surface (or near surface) site(s) 1511. In some embodiments, method 1400 may be a method of data gathering, determining, ranking, and/or selecting existing (or future) nuclear surface (or near surface) sites 1511 for potential onsite disposal of HLW in deep geological zones directly vertically below the given selected site 1511; and/or then implementing at least one such onsite deep HLW disposal repository at the selected existing (or future) nuclear surface (or near surface) site(s) 1511. In some embodiments, there may be fundamentally at least two main, but separate, operational processes to method 1400; a first process (e.g., of steps 1403, 1405, and/or 1413) that may be a drilling analysis model system methodology which analyzes the rock(s)/formation(s), that may exist directly vertically below a given site 1511, with respect to suitability, based on a set of (predetermined) parameters 1602; and a second process (e.g., of steps 1407, 1409, and/or 1415) that may be a location site analysis model which may integrate multiple other (predetermined) parameters 1608 that investigate the suitability of the plant location/storage site for onsite but deep HLW repository disposal. These two processes may operate independently, dependently, simultaneously (concurrently), sequentially, overlapping, portions thereof, combinations thereof, and/or the like.

Continuing discussing FIG. 14, in some embodiments, method 1400 may comprise at least one step selected from: step 1401, step 1403, step 1405, step 1407, step 1409, step 1411, step 1413, step 1415, step 1417, step 1419, step 1421, step 1423, step 1425, portions thereof, combinations thereof, and/or the like. In some embodiments, method 1400 may comprise one or more steps selected from: step 1401, step 1403, step 1405, step 1407, step 1409, step 1411, step 1413, step 1415, step 1417, step 1419, step 1421, step 1423, step 1425, portions thereof, combinations thereof, and/or the like. In some embodiments, such at least some such steps may be executed in numeral order. In some embodiments, such at least some such steps may be executed out of numeral order. In some embodiments, such at least some such steps may be optional, omitted, and/or skipped.

Continuing discussing FIG. 14, in some embodiments, step 1401 may be a step of gathering and/or collecting (relevant/pertinent) data and/or information on a given existing (or future) nuclear surface (or near surface) site 1511 that is intended to be evaluated and ranked for possibility of implementing at least one onsite but deeply located HLW disposal repository directly vertically below that given existing (or future) nuclear surface (or near surface) site 1511. Such relevant/pertinent data and/or information may be at least some data/information generated from execution of step 1403 and/or of step 1407; i.e., step 1403 and/or step 1407 may be thought of as subset(s) (sub-step(s)) of step 1401. In some embodiments, (successful) execution of step 1401 may lead method 1400 to step 1403 and/or to step 1407.

Continuing discussing FIG. 14, in some embodiments, step 1403 may be a step of collecting, determining, evaluating, and/or analyzing ease of deep wellbore “drill-ability” at a given existing (or future) nuclear surface (or near surface) site 1511. In some embodiments, execution of step 1403 may involve collecting and/or obtaining at least some data, information, and/or parameters, particular to the given existing (or future) nuclear surface (or near surface) site 1511, which may be analyzed in establishing the “drill-ability” or relative ease of making successful wellbore(s) (vertical and/or lateral) at a specific physical location(s) (e.g., potential wellhead(s)) within the areal confines (boundary/perimeter) of that given existing (or future) nuclear surface (or near surface) site 1511. In some embodiments, in executing step 1403, geophysical method analyses 900 and/or geological method analyses 901 may be carried out and resulting data/information collected, and/or analyzed. In some embodiments, in executing step 1403, at least one of the following may be obtained and/or evaluated: (1) drilling efficiency which describes the ease in which a rotary drill system (operating from a drill rig 206) may operate in the geologic rock environment directly vertically below that site being evaluated; (2) environmental impact, which may describe the effect of the drilling operations on the surrounding environment vis a vis land, water, and atmosphere effects; (3) formation geological and petrophysical properties, of the formation(s) directly vertically below that site being evaluated, which may describe the petrophysical, structural, and/or related physico-chemical properties of the rock zones being considered for waste disposal, wherein these properties may limit migration of radionuclides away from the site (and its deeply HLW repository); (4) mobilization/demobilization costs in bringing drill rig(s) 206 to the contemplated wellhead location(s) within that given site and removing those drill rig(s) 206 after the drilling (and/or underreaming) process(es) may be completed (depending on the specific local infrastructure this may be a significant expense or not); (5) rate(s) of penetration of the drilling (and/or underreaming) operations may provide a relatively short drill time which minimizes total cost of operations; portions thereof; combinations thereof; and/or the like. In some embodiments, (successful) execution of step 1403 may lead method 1400 to step 1405.

In some embodiments, the ease of drilling (as determined by step 1403) may be defined by the relative rates of penetration (ROP) of the drill bit(s) operated by drilling rig 206 in the geological formations (such as, formation 209) which lie (directly vertically) below at least some portion of the terrestrial surface at the given site 1511. In some embodiments, a unit of measurement for ROP is based on distance over time, or usually, feet per hour. Often, the ROP is affected by three primary variables: drill bit type, drilling mud type, and the formation rock type. Each variable directly affects the ROP and optimal ROP may be calculated in advance by analytical modelling of known historical data and rig performance data, and prior empirical performance. In practice, the ROP is measured in real time by a tachometer-like device at the drilling rig 206 wellhead and drilling operations are modified or controlled to maintain optimality during the drilling operations. Note, earlier U.S. utility Pat. No. 10,518,302 discusses in detail ease of drilling in the context of a drilling exploration model (DEM) and drilling suitability index. The teachings U.S. utility Pat. No. 10,518,302 are incorporated herein as if fully set-forth here. Note, U.S. utility Pat. No. 10,518,302 is by the same inventor as the present patent application. In some embodiments, a site 1511 with a sufficient ease of drilling may be one with a ROP that a consensus of persons of ordinary skill in the relevant art would find acceptable for drilling operations into formation 209.

Continuing discussing FIG. 14, in some embodiments, step 1405 may be a step of determining (calculating) a “geological suitability index” (GSI) 1606 value/number for each existing (or future) nuclear surface (or near surface) site 1511 that was evaluated per step 1403. The data, information, and/or parameters obtained in executing step 1403 for a given existing (or future) nuclear surface (or near surface) site 1511, in step 1405 may be given (assigned) a weighted value based on (drilling) operator (and/or expert) experience, empirical modeling, and/or analytical modeling, and then these assigned values may be combined (summed) into the determined (calculated) GSI 1606. In further discussing step 1403/1405 of FIG. 14, in some cases the weighted values 1603/1604 for parameters 1602 may be determined, deduced, or estimated by experts or consultants based on historical references to the observed or resulting level of importance of a given drilling parameter 1602 in the past processes where operational data and rock and fluid data have been collected, measured, classified and analyzed. This type of weight/value determination is usually done in the performance of a “post-mortem” or “after action” analysis of a given drilling or exploration project wherein the analytical focus has been on attribution; i.e., why an event or action occurred, and which specific parameters contributed and their relative or weighted effects. The same type of weight/value determination protocol may be used in step 1407/1409 where the parameters 1608 relate to the location site analysis procedure of various embodiments of the present invention.

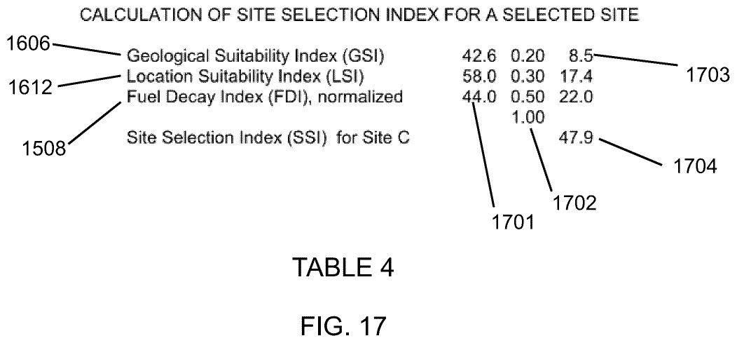

In some embodiments, the expert may be selected from one or more of a drilling operator, a geologist, a physicist, a chemical engineer, and/or the like. Note, while two different experts might disagree as to particular numerical value 1603 assignments for the various drill-ability factors/parameters 1602, each such expert can arrive at a definite particular numerical value 1603 assignment for each drill-ability factors/parameters 1602 that was examined in step 1403. Different experts arriving at different numerical value 1603 assignments for the various drill-ability factors/parameters 1602, does not negatively impact execution of method 1400, step 1403, and/or of step 1405. In some embodiments, in step 1405 may be a step of determining (calculating) the geological suitability index GSI 1606 of the given site 1511. In some embodiments, the GSI 1606 value may be calculated as a composite number which combines all the geological data, information, and/or parameters obtained from step 1403 for that given site 1511; and may be reflective of the drill-ability at and below that given site 1511. In some embodiments, favorable and/or desired data, information, parameters, and/or outcomes of step 1403 may be assigned higher values/scores. In some embodiments, a higher GSI 1606 value per a given site 1511 may be desired. An example of GSI 1606 determination and/or calculation for a given site 1511 may be shown in FIG. 16 of Table 3; and use of GSI 1606 in determining/calculating Site Selection Index (SSI) may be shown in FIG. 17 of Table 4. In some embodiments, (successful) execution of step 1405 may lead method 1400 to step 1411.

Continuing discussing FIG. 14, in some embodiments, step 1407 may be a step of collecting, evaluating, determining, and/or analyzing parameters that may be particular (specific) to a given existing (or future) nuclear surface (or near surface) site 1511. In some embodiments, step 1407 may be a step of collecting, evaluating, determining, and/or analyzing location parameters that may be particular (specific) to a given existing (or future) nuclear surface (or near surface) site 1511. In some embodiments, the location parameters may be characteristics, factors, data, information, and/or quantifiable measurements including and/or pertaining to human activity that relates directly or indirectly to the specific (particular) site 1511. In some embodiments, the location parameters consider measurable, surveyable or quantifiable data or information related to or describing the above ground site 1511 characteristics. In some embodiments, location parameters may include (comprise): demographics, geographic, infrastructure, logistics, political human factors, social huma factors, transportation issues, fuel activity decay (FDI) of waste currently stored at the site 1511, portions thereof, combinations thereof, and/or the like. Many methods exist for routinely computing and determining such location parameters quantities, and these are able to be performed by technical professionals who provide quantified results to allow determination and evaluation of the location parameters. Note, at least some elements of these location parameters analyses may be shown in the flow charts of FIG. 14, FIG. 15, and in FIG. 16 in particular illustrates an example of how collected location parameters are analyzed using a weighted average metric to arrive at a “location suitability index” (LSI) 1612 value/number for that given site 1511 that was evaluated (collected) in step 1407. In comparison, step 1403 may pertain to below ground factors at the given site being evaluated; whereas, with respect to step 1407, it may be largely above ground factors 1608 of that given site 1511 that are being considered. In some embodiments, in executing step 1407, at least one of the following may be considered: (1) demographics, which may describe population types in the local region, be they urban, rural suburban or other; (2) fuel decay (activity) index (FDI) 1508/1512 of the onsite SNF/HLW may be performed; (3) geographic factors, such as, but not limited to, weather, climate, earthquake potential, and/or the like; (4) onsite, local, and/or regional infrastructure/assets (this may include transportation considerations of roads, rail, airports, airstrips, waterways, and/or the like); (5) logistics may play an important part in the site selection process; (6) political and/or human factors considerations (e.g., dealing with/addressing “not in my back yard” (NIMBY) sentiment); (7) regulatory factors related to existing laws at the federal, state, regional, and/or local levels may be analyzed to remain within the limits proposed by such laws and/or regulations; (8) social human factors which may relate to the over-concentration or under concentration of certain operations in a given demographic region may need to be assessed to obtain consent-based solutions; portions thereof; combinations thereof; and/or the like. With respect to consideration (2) the fuel decay (activity) index or FDI 1508/1512, see also FIG. 15 of Table 2, which shows how FDI 1508/1512 may be determined/calculated at four (4) different sites 1511. In some embodiments, FDI 1508/1512 may be a critical, important, and/or significant site parameter since FDI relates to the radioactive toxicity and heat generation capacity of the HLW (SNF) that is stored onsite at the site (such as, but not limited to HLW in onsite cooling pond(s)/pool(s) 704). HLW (radio)activity decays over time and thus becomes more manageable as time passes, it is therefore beneficial to wait as long as possible not to endanger workers, but yet to be able to move sufficiently seasoned (cooled) HLW from the surface storage (or near surface storage) after an optimal period of time. This activity (decay) index (FDI) 1508/1512 may be calculated as an integral part of various embodiments of the present invention may be further illustrated in detail in FIG. 15 (Table 2). With respect to consideration (4), transportation needs and transportation availability may also be considered. In some embodiments, transportation may be an important feature since adequate means of ingress/egress to/from the site 1511 may be needed. In some embodiments, in evaluating adequacy of a given site 1511, considering the difficulty or ease of moving various types of personnel, equipment, machinery, vehicles, material, drill rig(s) 206, drilling equipment, underreaming equipment, casing(s)/piping, SNF, HLW, and/or complex systems to and from the site 1511 may be considered. The selection process may require good road, rail, and/or relatively available airport connections. Mobilization and demobilization costs in bringing the drill rig(s) 206 to the given site 1511 may be considered. Depending on the infrastructure associated with a given site 1511, this may be a significant expense since massive trucking costs are associated with major drill rig 206 and/or the like transportation. The ability to rapidly transfer goods and services via common carriers may contribute to the successful implementation of a complex deep HLW disposal program at and below a given site 1511. In some embodiments, drill rig 206 and/or like mobilization and demobilization may be considered as part of step 1403 or as part of step 1407. With respect to consideration (8), the analytical process of this step 1407 may include a weighting factor to better account for and consider minority and/or marginalized groups in a fair and responsible manner. In some embodiments, (successful) execution of step 1407 may lead method 1400 to step 1409.

Continuing discussing FIG. 14, in some embodiments, step 1409 may be a step of determining (calculating) a “location suitability index” (LSI) 1612 value/number for each existing (or future) nuclear surface (or near surface) site 1511 that was evaluated per step 1407. In some embodiments, step 1409 may be a step of determining (calculating) a LSI 1612 value/number for each existing (or future) nuclear surface (or near surface) site 1511 with respect to location parameters data collected in step 1407 for that given site 1511. In some embodiments, in step 1409 specific suitability of each site 1511 (evaluated by step 1407), with respect to LSI 1612, may be empirically, observationally, and/or expert determined (calculated). In some embodiments, step 1409 may be a step of (or may include a step of) determining (calculating) a “fuel decay index” (FDI) 1508 value/number for each existing (or future) nuclear surface (or near surface) site 1511 that was evaluated per step 1407. In some embodiments, in step 1409 specific suitability of each site 1511 (evaluated by step 1407), with respect to FDI 1508, may be empirically, observationally, and/or expert determined (calculated). The data, information, and/or parameters obtained in executing step 1407 for a given existing (or future) nuclear surface (or near surface) site 1511, in step 1409 may be given (assigned) a weighted value based on expert experience, empirical modeling, and/or analytical modeling, and then these assigned values may be combined (summed) into the determined (calculated) LSI 1612. In some embodiments, this expert may be one or more of: a statistician, a data scientist, a geologist, an engineer, a physicist, a sociologist, a political analysist, and/or the like. Note, while two different experts might disagree as to particular numerical value 1609 assignments for the various location factors/parameters 1608, each such expert can arrive at a definite particular numerical value 1609 assignment for each location factors/parameters 1608 that was examined in step 1407. Different experts arriving at different numerical value 1609 assignments for the various location factors/parameters 1608, does not negatively impact execution of method 1400, step 1407, and/or of step 1409. In some embodiments, in step 1409 may be a step of determining (calculating) the location suitability index (LSI) 1612 of the given site 1511. In some embodiments, the LSI 1612 may be calculated as a composite number which combines all the data, information, and/or parameters obtained from step 1407 for that given site 1511; and may be reflective of the ease of implementing at least one onsite deep HLW disposal repository at and below that given site 1511, with respect to above-ground issues, such as human considerations, infrastructure, transportation, and/or overall costs. In some embodiments, favorable and/or desired data, information, parameters, and/or outcomes of step 1407 may be assigned higher values/scores. In some embodiments, a higher LSI 1612 value per a given site 1511 may be desired. In some embodiments, determination/calculation of FDI 1508 score(s)/value(s) may be done separately from determination/calculation of LSI 1612 score(s)/value(s). An example of FDI 1508/1512 determination and/or calculation for a given site 1511 may be shown in FIG. 15 of Table 2. An example of LSI 1612 determination and/or calculation for a given site 1511 may be shown in FIG. 16 of Table 3; and use of LSI 1612 in determining/calculating Site Selection Index (SSI) (also known as Site Suitability Index) may be shown in FIG. 17 of Table 4. In some embodiments, (successful) execution of step 1409 may lead method 1400 to step 1411.

Continuing discussing FIG. 14, in some embodiments, step 1411 may be a step of collecting, collating, and/or combining GSI 1606 scores, FDI 1508/1512 values, and LSI 1612 scores for the same given existing (or future) nuclear surface (or near surface) site 1511. In some embodiments, GSI 1606 scores, FDI 1508/1512 values, and LSI 1612 scores for the same given existing (or future) nuclear surface (or near surface) site 1511 may be combined in step 1411. In some embodiments, step 1411 may do this for each such site 1511 that has been evaluated according to steps 1403, 1405, 1407, and 1409. In some embodiments, (successful) execution of step 1411 may lead method 1400 to step 1417. See also FIG. 17.

Continuing discussing FIG. 14, in some embodiments, step 1417 may be a step of collecting, collating, and/or combining GSI 1606 scores, FDI 1508/1512 values, and LSI 1612 scores for the same given existing (or future) nuclear surface (or near surface) site 1511 to determine (calculate) an overall Site Selection Index (Site Suitability Index) (SSI) 1704 score for that same given existing (or future) nuclear surface (or near surface) site 1511. In some embodiments, step 1417 may do this for each such site that has been evaluated according to steps 1403, 1405, 1407, and 1409. In some embodiments, an output of step 1417 may be a determined/calculated SSI 1704 score for each such site 1511 that has been evaluated according to steps 1403, 1405, 1407, and 1409. In some embodiments, if a given SSI 1704 falls outside of a predetermined range, then method 1400 may progress back to steps 1403 (via step 1413) and 1407 (via step 1415) for selecting a different existing (or future) nuclear surface (or near surface) site 1511 to be evaluated. In some embodiments, step 1417 may progress to steps 1413 and 1415 until all potential (or some subset thereof) existing (or future) nuclear surface (or near surface) sites 1511 have been evaluated according to steps 1403 and 1407. In some embodiments, if a given SSI 1704 falls within a predetermined range (including endpoints of that range), then method 1400 may progress to step 1419. Note, an example of determining/calculating Site Selection Index (SSI) 1704 may be shown in FIG. 17 of Table 4.

Continuing discussing FIG. 14, in some embodiments, step 1413 may be a step of selecting a different existing (or future) nuclear surface (or near surface) site 1511 to be evaluated according to step 1403. In some embodiments, in step 1413 method 1400 may be incremented to select another potential site 1511 for further drilling analysis modelling per step 1403. In some embodiments, this process may be iteratively continued until all possible/potential (or some subset thereof) sites 1511 are investigated for drilling suitability according to step 1403. In some embodiments, (successful) execution of step 1413 may lead method 1400 to step 1403.

Continuing discussing FIG. 14, in some embodiments, step 1415 may be a step of selecting a different existing (or future) nuclear surface (or near surface) site 1511 to be evaluated according to step 1407. In some embodiments, in step 1415 method 1400 may be incremented to select another potential site 1511 for further location site analysis modelling per step 1407. In some embodiments, this process may be iteratively continued until all possible/potential sites (or some subset thereof) 1511 are investigated for location site analysis modeling according to step 1407. In some embodiments, the new/different/other existing (or future) nuclear surface (or near surface) site 1511 to be evaluated in steps 1413, 1403, 1415, and 1407 may be the same site 1511; i.e., the exact same site 1511 may be evaluated according to both steps 1403 and 1407. In some embodiments, (successful) execution of step 1415 may lead method 1400 to step 1407.

Continuing discussing FIG. 14, in some embodiments, step 1419 may be a step of ranking at least two (2) different existing (or future) nuclear surface (or near surface) sites 1511 that have SSI 1704 associated scores. In some embodiments, a comparatively higher SSI score of a given site 1511 may be deemed better and/or desirable as compared to a lower SSI 1704 score of a different site 1511, with respect to implementing an onsite deep HLW disposal repository 209. In some embodiments, (successful) execution of step 1419 may lead method 1400 to step 1421.

Continuing discussing FIG. 14, in some embodiments, step 1421 may be a step of selecting one or more existing (or future) nuclear surface (or near surface) sites 1511 according to comparatively higher SSI 1704 scores, for implementing at least one onsite deep HLW disposal repository 209 per each such selected site 1511. In some embodiments, step 1421 may be a step of selecting the at least one existing (and/or future) site 1511 that has a desirable site suitability index (SSI). In some embodiments, the desirable site suitability index (SSI) is a site suitability index (SSI) of one of the plurality of existing (and/or future) sites 1511 (that was evaluated per method 1400) that is better than a site suitability index (SSI) of another of the plurality of existing (and/or future) sites 1511 (that were evaluated per method 1400). In some embodiments, the desirable site suitability index (SSI), of one existing (and/or future) site 1511 evaluated per method 1400, is larger (i.e., numerically bigger) than the site suitability index (SSI) of another existing (and/or future) site 1511 selected from the plurality of existing (and/or future) sites 1511 (that were evaluated per method 1400). In some embodiments, the desirable site suitability index (SSI) may be a composite index determined for ranking purposes (see e.g., FIG. 17). In some embodiments, this ranking may consider the collective empirical data based on two empirical determinants (GSI 1606 [geological suitability index] and LSI 1612 [location suitability index]) and on the FDI 1508 (fuel decay index) for sites 1511 evaluated per method 1400. The first determinant is the GSI 1606 (geological suitability index 1606) as determined in step 1405 for each site 1511 being evaluated per method 1400. The second determinant is the LSI 1612 (location suitability index 1612) as determined in step 1409 for each site 1511 being evaluated per method 1400. Many methods exist for computing and these determinants, and these are able to be performed by technical professionals who provide quantified results to allow a numerical ranking of the indices. See e.g., FIG. 16 and its discussion that are relevant to determining (calculating) GSI 1606 and LSI 1612 for a particular site 1511. See e.g., FIG. 15 and its discussion that are relevant to determining (calculating) FDI 1508 for sites 1511. And see FIG. 17, relevant to steps 1419 and 1421, for determining (calculating), ranking, and/or selecting desirable SSI 1704 score(s) from GSI 1606, LSI 1612, and FDI 1508 of evaluated sites 1511. In some embodiments, (successful) execution of step 1421 may lead method 1400 to step 1423.

Continuing discussing FIG. 14, in some embodiments, step 1423 may be a step of implementing (constructing) at least one onsite deeply located HLW disposal repository within the disposal zone(s)/formation(s) 209 that is directly vertically located below at least some portion of the areal confines of site(s) 1511 selected in step 1421. In some embodiments, this may entail implementing (constructing) an embodiment as at least substantially as shown and discussed from FIG. 2A to FIG. 4B. In some embodiments, the implementing (constructing) step 1423 may comprise (in sequence): the actual selection of at least one wellsite on the terrestrial surface of the selected site 1511 (within the areal confines of that selected site 1511); the drilling of a vertical wellbore 207 into disposal formation 209 from that selected at least one wellsite via drill rig 206 operating at that wellsite, and using associated drilling equipment; followed by and the completion of at least one deep lateral wellbore 208 and/or of at least one human-made cavern 405 within the selected disposal rock formation 209. See e.g., FIG. 2A to FIG. 4B. In some embodiments, once the HLW/SNL waste disposal repository has been implemented (constructed) per step 1423 (within the selected disposal rock formation 209 that is directly vertically located below at least some portion within the areal boundary of the selected site 1511); then, in some embodiments, step 1423 may further comprise using that implemented (constructed) deeply located waste disposal repository by loading and sequestering of the selected (HLW, SNF, portions thereof, and/or combinations thereof) waste material in their various respective forms, into: (i) first the vertical wellbore 207 and then into the connected at least one lateral wellbore 208 or (ii) first into the vertical wellbore 207 and then into the connected at least one human-made cavern 405. In some embodiments, execution of step 1423 this may entail (comprise) using at least one drill rig 206 on terrestrial surface 205 (within the areal confines of selected site 1511); drilling out at least one vertical wellbore 207 from that terrestrial surface 205 and into disposal zone(s)/formation(s) 209; drilling at least one lateral (horizontal) wellbore 208 entirely within that disposal zone(s)/formation(s) 209 and/or forming at least one human-made cavern 405 entirely within that disposal zone(s)/formation(s) 209; and doing so, at each such selected site 1511, within the areal confines of the given selected site, such that the newly formed disposal repository is located directly vertically below at least some portion of the areal confines of the given selected site 1511. In some embodiments, step 1423 may then also entail (comprise) loading, inserting, filling, placing, injecting, and/or the like HLW (SNF) into the formed/implemented deep HLW disposal repository that is located within the given deep disposal zone/formation 209.

Note, the rock cutting/boring bits/tools operatively connected to and/or operated from drill rig 206 may operate by mechanical means, hydraulic means, electrical means, combinations thereof, and/or the like.

Note, the rock cutting/boring bits/tools operatively connected to and/or operated from drill rig 206 may remove, cut, bore, and/or excavate rock/formation material by mechanical means, abrasive means, frictional means, rotary means, cutting means, heating means, melting means, plasma means, acoustic means, vibratory means, combinations thereof, and/or the like.

Further note, the equipment and/or tools used to implement (construct) the given deeply located waste repository within the at least formation 209, such as, but not limited to, drill rig 206, drill bits, rock boring tools, rock cutting tools, rock melting tools, underreaming bits/tools, string assemblies, casings, drilling fluids/mud, portions thereof, combinations thereof, and/or the like are all well understood by persons of ordinary skill in the relevant technical fields, such as, but not limited to, oilfield wellbore drilling and development; and such teachings of such equipment and/or tools are incorporated by reference. For example, the teachings of U.S. utility Pat. Nos. 5,439,067, 5,482,119, 5,547,033, 5,904,211, 6,070,672, and 6,131,676 include teachings of such equipment and/or tools and these U.S. utility patents are incorporated by reference herein.

Continuing discussing step 1423, in some embodiments, the step 1423 of implementing (constructing) the deeply located geological repository within at least one formation 209 may be carried out, at least in part, by at least one drill rig 206, wherein the at least one drill rig 206 (and associated drilling equipment and/or tools, such as, but not limited to, drill bits, string assemblies, drilling muds, and/or the like) drills at least one vertical wellbore 207, from the terrestrial surface 205, within the areal confines of the selected site 1511, down through any existing and intervening water table(s) (if any), to a specified depth of at least 4,000 to 15,000 feet below that terrestrial surface 205 and into that at least one formation 209. See e.g., FIG. 2A through FIG. 4B.

Continuing discussing step 1423, in some embodiments, this step 1423 implementing (constructing) the deeply located geological repository within at least one formation 209 may be further carried out, at least in part, by the at least one drill rig 206, wherein the at least one drill rig 206 (and associated drilling equipment and/or tools, such as, but not limited to, drill bits, string assemblies, drilling muds, and/or the like) continues to drill from a terminal/distal portion of the at least one vertical wellbore 207 (wherein “terminal/distal portion” is disposed away from terrestrial surface 205 by the at least 4,000 to 15,000 feet of vertical downwards distance from terrestrial surface 205) by turning the drilling equipment into a lateral (horizontal) direction with respect to the at least one vertical wellbore 207, to form at least one connected lateral (horizontal) wellbore 208, wherein that at least one connected lateral (horizontal) wellbore 208 may be intended as the deeply located waste repository, to receive HLW, SNF, portions thereof, combinations thereof, and/or the like, wherein that at least one connected lateral (horizontal) wellbore 208 is located within the disposal formation 209. Further, such a formed at least one connected lateral (horizontal) wellbore 208 may be entirely located vertically below the areal confines of that selected site 1511. As some sites 1511 may have an areal terrestrial surface 205 size on the order of one square mile or more, in some embodiments, the formed at least one connected lateral (horizontal) wellbore 208 may have a lateral (horizontal) run length of 7,000 feet, plus or minus 100 feet that is capable of receiving HLW, SNF, portions thereof, combinations thereof, and/or the like. See e.g., FIG. 2A through FIG. 4A.

Continuing discussing step 1423, in some embodiments, instead of forming at least one connected lateral (horizontal) wellbore 208 or in addition to forming at least one connected lateral (horizontal) wellbore 208, this step 1423 implementing (constructing) the deeply located geological repository within at least one formation 209 may be further carried out, at least in part, by the at least one drill rig 206, wherein the at least one drill rig 206 (and associated drilling equipment and/or tools, such as, but not limited to, drill bits, underreaming tools, string assemblies, and/or the like) continues to drill from a terminal/distal portion of the at least one vertical wellbore 207 (wherein “terminal/distal portion” is disposed away from terrestrial surface 205 by the at least 4,000 to 15,000 feet of vertical downwards distance from terrestrial surface 205) by continuing to drill vertically downwards from that terminal/distal portion of the at least one vertical wellbore 207, an additional (further) vertical distance of 3,000 feet to 5,000 feet below the terminal/distal portion of the at least one vertical wellbore 207 and still within the given disposal formation 209; and then executes underreaming operations within the vertical wellbore section that is below the terminal/distal portion of the at least one vertical wellbore 207 to form a human-made cavern (silo) 405. The formed human-made cavern (silo) 405 may then have a height from 3,000 feet to 5,000 feet, all of which may be located directly vertically below the terminal/distal portion of the at least one vertical wellbore 207. Further, such a formed human-made cavern (silo) 405 may be entirely located vertically below the areal confines of that selected site 1511. The diameter of the formed human-made cavern (silo) 405 may be larger than the diameter of the connecting at least one vertical wellbore 207. That formed human-made cavern (silo) 405 may be configured to receive human-made nuclear and/or radioactive waste, such as, but not limited to, HLW. See e.g., FIG. 4B.

In some embodiments, (successful) execution of step 1423 may lead method 1400 to step 1425.

Continuing discussing FIG. 14, in some embodiments, step 1425 may be a step of closing, sealing, marking, and/or shutting down a given deep HLW disposal repository (from step 1423) that has received at least some HLW therein. In some embodiments, step 1425 may entail placing a surface marker at the now closed/sealed wellhead to vertical wellbore 207. In some embodiments, completion of step 1425 for a given site concludes method 1400 with respect to that site 1511.

FIG. 15 shows Table 2 which shows and explains in tabular form how FDI (fuel decay index) may be calculated and/or determined for a given existing (or future) nuclear surface (or near surface) site 1511. Note, FIG. 15 (and Table 2) may be a collection of five (5) separate tables, of four (4) separate tables each for one given existing (or future) nuclear surface (or near surface) site 1511 (designated as sites A, B, C, and D) in FIG. 15, and one (1) final table that summarizes the calculated FDI scores/values for each of those four (4) sites 1511. These tables of FIG. 15 may together, by example, demonstrate method 1500. In some embodiments, method 1500 may be a method for calculating/determining FDI at a given existing (or future) nuclear surface (or near surface) site 1511 and/or ranking at least two such sites 1511 according to the site's 1511 calculated FDI score/value. In some embodiments, at least some of the tabulated example data shown in FIG. 15 may detail a series of computational steps that are comprehensively designed to lead to a decision making and ranking that may allow a systematic validation of preferred and/or desired site(s) 1511 for implementation of at least one onsite but deeply location geological HLW disposal repository based on FDI information. This particular FIG. 15 example shows four (4) existing (or future) nuclear surface (or near surface) sites 1511, site A, site B, site C, and site D, as being evaluated and ranked according to calculated/determined FDI scores/values.

Continuing discussing FIG. 15, in some embodiments, reference numeral 1501 may represent a grouping or a categorization designation that may be performed at each such existing (or future) nuclear surface (or near surface) site 1511 being evaluated. In some embodiments, this grouping/categorization 1501 is done by different residence times 1502 (ages 1502) that the HLW (SNF) at the given existing (or future) nuclear surface (or near surface) site 1511 has been in at an interim surface (e.g., cooling pond(s)/pool(s) 704 or casks) (or near surface) storage environment. In some embodiments, grouping/categorization 1501 may involve grouping of the SNF tonnage at the given existing (or future) nuclear surface (or near surface) site 1511, into alphabetical order by age 1502. Merely as an example, the grouping/categorization 1501 in FIG. 15 is by alphabetically (e.g., A, B, C, etc.); however, in other embodiments, a different method grouping/categorization 1501 may be employed. There is no specific reason for the alphabetic grouping/categorization designations shown in FIG. 15, these designations 1501 could just as easily be in numerical order, or some combination thereof, or some predetermined code, for analyzing the characteristics of each specific existing (or future) nuclear surface (or near surface) site 1511, taking into the account the tonnage of SNF at each site 1511 and the number of years 1502 tonnage amount has been onsite at the given site 1511. Each given group/category 1501 corresponds to a different age 1502 (residence time 1502) that a certain amount of HLW has been at the given existing (or future) nuclear surface (or near surface) site 1511 in the interim surface (or near surface) storage environment. For example, and without limiting the scope of the present invention, with group/category 1501 of “A” has an associated age 1502 of fifty (50) years in residence at that given existing (or future) nuclear surface (or near surface) site 1511; whereas, group/category 1501 of “J” has an associated age 1502 of only five (5) years in residence at that given existing (or future) nuclear surface (or near surface) site 1511.

In FIG. 15, reference numeral 1502 may indicate the age or residence time in years of the specific tonnage amount of HLW (SNF) in onsite cooling ponds 704, other onsite surface storage locations and/or in onsite near surface storage locations. For calculating purposes, in this analysis, the age 1502 levels may be divided into half-decades (five-year increments) arbitrarily. It may be possible to use decade units of time or even annual units, however, the calculating table size would increase since there may be more calculating rows, but the complexity level does not increase, just the quantity/amount of computation which is needed to obtain the results.

Continuing discussing FIG. 15, reference numeral 1203 may illustrate a quantitative amount (e.g., in tonnage) of SNF (HLW) material at a given site 1511 at a given period of time 1502 and for a given category/group 1501. Those knowledgeable in the nuclear power industry know that on regular time interval basis that SNF assembly 607 rods are removed from the hot cores of the nuclear power plant 200 and then stored in cooling ponds 704 for years.

Continuing discussing FIG. 15, reference numeral 1504 may be a computed parameter and/or decimal number that is derived from empirical fuel (SNF) decay analysis. For computational ease, the relative activity level 1504 shown may be computed in this patent application, as a “loss level” rather than the true activity level. In the context of this invention, for example, a loss level 1504 of 1.00 may indicate that most of the radioactivity of the SNF assembly 607 rods has been dissipated whereas a loss level 1504 of 0.10 may indicate only a small fraction of the SNF radioactivity has been dissipated and that at the point in time the SNF assembly 607 rods is still extremely dangerous to be handled. Those knowledgeable in the art understand that longer cooled SNF has a smaller activity level 1504. The longer cooled SNF, the less dangerous for handling. Note, higher loss levels 1504 in FIG. 14 are associated with older aged 1502 SNF. In some embodiments, an intent of this FIG. 15 analysis is to remove the oldest residing 1502 SNF 607 first at a given site 1511 for onsite deep HLW disposal, while still allowing the younger residing 1502 SNF 607 to remain in surface or near surface cooling conditions until safer (less activity) for the eventual onsite deep HLW disposal. The total amount 1505 (e.g., total tonnage 1505) of SNF 607 at a given location 1511 is calculated by summing the SNF 607 amount/tonnage elements 1503 to provide the summed number of total amount/tonnage 1505.

Continuing discussing FIG. 15, reference numeral 1506 may represent the mathematical product (multiplication) of the specific tonnage 1503 times the specific age 1502 with respect to a given group/category 1501 of SNF 607. For example, consider site “A” and group 1501 “A,” which has an age 1502 of fifty (50) years and a tonnage 1503 of 200 tons, the product 1506 is then fifty times 200 which calculates out to 10,000 for this particular product 1506.

Continuing discussing FIG. 15, in some embodiments, product 1506 is an intermediary number utilized in combination with the SNF loss level 1504 to provide a parameter which is a product of items 1504 and 1506. This mathematical product 1507 may be the fuel decay index 1507 score/value (FDI 1507 score/value). For example, consider site “A” and group 1501 “A,” which has an age 1502 of 50 years and a tonnage 1503 of 200 tons, a product 1506 of 10,000, and a loss level 1504 of “1.00,” then the calculated FDI 1507 score for this row is 10,000 times 1.00 for a calculated FDI 1507 score of 10,000 for this row. These FDI 1507 indices of each row of aged 1502 SNF 607 are summed at a given site 1511 to provide a FDI sum 1508, which quantity may be used later as a discrete variable to quantify and relatively rank the totality of SNF 607 assembly material at a given site 1511 in surface (or near surface) storage, that is being analyzed in regards its level of suitability in the deep disposal selection process.

Finally, in FIG. 15, is the final table (bottom middle table) that summarizes the calculated total FDI 1508 scores/values for each of the four (4) separate sites 1511. In this final table, the four different total FDI 1508 scores appear in separate rows of one column that are sorted/ranked 1509 by numerical order of the total FDI 1508 scores. A site 1511 with the highest total FDI 1508 score may get assigned the best or most desirable rank (e.g., “first” or “1^{st}”) of that particular group of sites 1511 that has been evaluated for total FDI 1508 scores. In general, sites 1511 with higher total FDI 1508 scores compared to other sites 1511 with lower total FDI 1508 scores may have more older/safer HLW (SNF) that may be safe enough for respective onsite deep HLW disposal as taught herein. A site 1511 with the lowest total FDI 1508 score (of that particular group of sites 1511 that has been evaluated for total FDI 1508 scores) may get assigned the worst rank. Reference numeral 1510 may refer to these rankings of sites 1511 according to the total FDI 1508 score of the sites 1511 being compared to each other. In some embodiments, the summed/total FDI 1508 values for each site 1511 may be ranked from highest total FDI 1508 to lowest FDI 1508. This sorting/ranking of total FDI 1508 by site 1511 is shown in the column item 1509. Based on this selected ranking between multiple sites 1511 analyzed, the desired onsite but deep HLW disposal process may be implemented such that the combined oldest and/or largest SNF 607 volumes may be disposed of first, since those SNF 607 quantities may be considered to be safest based on their high total fuel decay indices (FDIs) 1508.

Continuing discussing FIG. 15 and the final table (bottom middle table), in some embodiments, reference numeral 1512 may refer to normalized FDI values for each of the total FDI 1508 values for each considered site 1511. That is, in some embodiments, normalized FDI 1512 value may simply a normalized version of its associated total FDI 1508 value. In this particular FIG. 15 example, a value of “100” is used as the baseline normalization FDI 1512 value that corresponds with the highest ranked site 1511 of highest total FDI 1508 value. In the normalization process, the highest ranked site 1511 may be arbitrarily assigned a value of “100” (or “1.00” or some other predetermined normalizing/scaling system) based on this highest ranked site 1511 having the highest total FDI 1508 value, which in this particular FIG. 15 example is “38,500.” Each other site 1511 may have a calculated normalized value that is a ratio of each site's 1511 total FDI 1508 value as compared to the highest ranked site 1511 total FDI 1508 value. For example, the second ranked site 1511 may have a normalized FDI 1512 value calculated by total FDI 1508 value “28,875” divided by total FDI 1508 value “38,500” which may equal a normalized FDI 1512 value of “75” (or 0.75). However, in other embodiments, other normalizing protocols may be employed as a statistician in the relevant field(s) might employ.

Similar real-world (actual) data as the example data in FIG. 15, may be used as illustrated by method 1500 and/or by FIG. 15 to run these FDI determination calculations for each site 1511 being evaluated for onsite deep HLW disposal. This method 1500 illustrated by FIG. 15 to calculate site specific total FDIs 1508 and rank 1509/1510 those evaluated sites 1511 by those FDIs 1508/1512, may be used in method 1400, such as, in step 1407 and/or in step 1409. In some embodiments, the FDIs 1508/1512 may be component of the LSI (location suitability index).

FIG. 16 of Table 3 may illustrate the methodology showing in tabular form how the elements of the geological suitability analyses and GSI (geological suitability index) (e.g., steps 1403 and 1405) and the location suitability model analyses and LSI (location suitability index) (e.g., steps 1407 and 1409) are implemented in this inventive application. FIG. 16 of Table 3 shows how the GSI (step 1405) may be calculated from the data the geological suitability analyses (step 1403) for a given site 1511. FIG. 16 of Table 3 shows how the LSI (step 1409) may be calculated from the data the location suitability model analyses (step 1407) for a given site 1511. Thus, FIG. 16 (Table 3) may be an example of steps 1411 and/or 1417.

Continuing discussing FIG. 16, in some embodiments, reference numeral 1601 may refer collectively to the geological suitability model analyses of step 1403. In some embodiments, reference numeral 1602 may represent the various/specific tests and/or analyses performed and/or executed during step 1403, which may be geared at evaluating the drill-ability feasibility of implementing at least one onsite deep HLW disposal repository. In some embodiments, these parameters 1602 may comprise at least one of: drilling efficiency, environmental impact, formation properties (formation geological properties and/or formation petrophysical properties), mobilization (and demobilization) costs, rate of penetration, portions thereof, combinations thereof, and/or the like. In some embodiments, these parameters 1602 may correspond with the tests and/or analyses of step 1403. In some embodiments, these parameters 1602 may correspond with the tests and/or analyses of geophysical method analyses 900 and/or geological method analyses 901. In some embodiments, at least some of these parameters 1602 may be determined from (drill rig) operator experience, analysis, and/or modelling studies. In some embodiments, reference numeral 1603 may refer to numerical values for each given parameter 1602 that was analyzed in step 1403. In some embodiments, the values 1603 may be normalized onto a relative scale of 1 to 100, with a higher value 1603 being associated with a more desired outcome. In some embodiments, at least some of these parameters 1602 values 1603 may be determined from (drill rig) operator experience, analysis, and/or modelling studies. In some embodiments, this value 1603 assignment/determination/calculation process may be based on experience and/or other empirical factors such as, but not limited to, modelling. The weight factors 1604 may be assigned to each specific parameter 1602 based on observation, experience, politics, economics, modelling, portions thereof, combinations thereof, and/or the like. Combining the values 1603 with the weight factors 1604 as a mathematical product (multiplication), on a per row basis, may produce an intermediate product result 1605 for each parameter 1602 in the geological suitability model 1601. In some embodiments, a summation of all the product results 1605 for each examined parameter 1602, for a given 1511, may provide a calculated/determined GSI 1606 for that given site 1511. For example, in FIG. 16 (Table 3), the calculated GSI 1606 is 42.6.

Continuing discussing FIG. 16 (Table 3) in some embodiments, reference numeral 1607 may refer collectively to the location suitability model analyses of step 1407. In some embodiments, reference numeral 1608 may represent the various/specific tests and/or analyses performed and/or executed during step 1407, which may be geared at evaluating above-ground and/or human related issues with respect to implementing at least one onsite deep HLW disposal repository at a given site 1511. In some embodiments, these parameters 1608 may comprise at least one of: demographic issues, fuel decay indices (FDIs) determination, geographic issues, infrastructure issues, logistics issues, political human factors issues, regulatory factors issues, social human factors issues, transportation systems issues, portions thereof, combinations thereof, and/or the like. These parameters 1608 may be determined from experience (experts), analysis, and/or modelling studies. In some embodiments, reference numeral 1609 may refer to numerical values for each given parameter 1608 that was analyzed in step 1407. In some embodiments, the values 1609 may be normalized onto a relative scale of 1 to 100, with a higher value 1609 being associated with a more desired outcome. In some embodiments, at least some of these parameters 1608 values 1609 may be determined from (drill rig) operator experience, analysis, and/or modelling studies. In some embodiments, this value 1609 assignment/determination/calculation process may be based on experience and/or other empirical factors such as, but not limited to, modelling. The weight factors 1610 may be assigned to each specific parameter 1608 based on observation, experience, politics, economics, modelling, portions thereof, combinations thereof, and/or the like. Combining the values 1609 with the weight factors 1610 as a mathematical product (multiplication), on a per row basis, may produce an intermediate product result 1611 for each parameter 1608 in the location suitability model 1607. In some embodiments, a summation of all the product results 1611 for each examined parameter 1608, for a given 1511, may provide a calculated/determined LSI 1612 for that given site 1511. For example, in FIG. 16 (Table 3), the calculated LSI 1612 is 57.95.

FIG. 17 is of Table 4, which shows that once GSI 1606 (geological suitability index), FDI 1508 (fuel decay index), and LSI 1612 (location suitability index) have been calculated for a given site 1511, then a final “site suitability index” (SSI) may be determined/calculated for that given site 1511, all with a goal of evaluating that site 1511 for implementing at least one onsite deeply located HLW disposal repository in an onsite but deep disposal zone/formation 209. And then various SSI values of different potential sites 1511 may be compared against each other, to determine which given site(s) 1511 may be selected for implementation of onsite but deep HLW disposal repositories. In some embodiments, reference numeral 1701 refers to the individual indexes scores for that given site 1511, such as, but not limited to, GSI 1606, FDI 1508, and LSI 1612. In some embodiments, reference numeral 1702 may refer to weighted factors 1702, for each such index. In some embodiments, weighted factors 1702 may represent a scientifically determined weight factors showing the relative importance of each index value. In some embodiments, weighted factors 1702 may sum to unity. In some embodiments, weighted factors 1702 may be determined by experience (e.g., by an appropriate expert in the relevant field), analysis, and/or computational modeling. For example, and without limiting the scope of the present invention, in some embodiments, FDI 1508 may be weighted as more important than LSI 1612, and LSI 1612 may be weighted as more important than GSI 1606. In some embodiments, reference numeral 1703 may be a mathematical product (multiplication) between a given index score 1701 and its associated weighted factor 1702, for a given row. For example, in FIG. 17, the product outcome 1703 for the GSI 1606 may be 42.6 times 0.20 for a product outcome 1703 of 8.5. In some embodiments, reference numeral 1704 may be a total (summation) of the three product outcomes 1703 for a particular site 1511 and may indicate that site's 1511 SSI value 1704. In some embodiments, SSI (e.g., SSI value 1704) may be a culmination of having considered a plurality of issues (e.g., as considered by steps 1403 and 1407) pertaining to implementing at least one onsite deep HLW disposal repository at a given site 1511. In some embodiments, these SSI values 1704 may be used to rank a potential selective order of available sites 1511 for the onsite deep HLW disposal repository. In some embodiments, when comparing two different SSI values 1704 of two different sites 1511, the higher valued SSI value 1704 may be more desirable with respect to implementing at least one onsite deeply located HLW disposal repository in an onsite but deep disposal zone/formation 209. In some embodiments, site(s) 1511 may be selected for onsite deeply located HLW disposal repository implementation based on SSI value 1704 for the given site 1511. Thus, FIG. 17 (Table 4) may show, at least in part, how steps 1411, 1417, 1419, and/or 1421 may be executed/performed.

Continuing discussing FIG. 17 (Table 4), since a raw FDI 1508 value may be relatively large (e.g., on the order of several thousands), compared to GSI 1606 and/or LSI 1612 values (which may be about one hundred), the FDI 1508 values may be normalized between 1 and 100 to allow integration of FDI 1508 into the SSI value 1704, without biasing the data because of the imbalance in number sizes. This normalization process is typical in analyses of this type.

At least some embodiments of the present invention may be a method. In some embodiments, this may be method 1400, method 1500, portions thereof, combinations thereof, and/or the like. In some embodiments, this method (e.g., method 1400) may be for selecting at least one existing (or future) site 1511 with nuclear waste from a plurality of existing (or future) sites 1511 with nuclear waste for implementation of a deep geological repository 209 that is located directly vertically below an areal boundary of the at least one existing site 1511. In some embodiments, this method may comprise at least the following steps: step (a) (step 1403), step (b) (step 1405), step (c) (step 1407), step (d) (step 1409), step (e) (step 1417), step (f) (step 1419), and step (g) (step 1421). In some embodiments, the deep geological repository 209 may be configured for long-term disposal of radioactive material (such as, but not limited to, HLW and/or SNF or portions thereof) therein. In some embodiments, the radioactive material that may be configured for the long-term disposal in the deep geological repository 209, may be selected from the nuclear waste of the at least one existing (or future) site 1511. See e.g., FIG. 14 to FIG. 17.

In some embodiments, the plurality of existing (or future) sites 1511 with nuclear waste may be at least two separate and distinct existing (or future) sites 1511 with nuclear waste. In some embodiments, the plurality of existing (or future) sites 1511 with nuclear waste may all be located within territory of the United States of America (U.S.). See e.g., FIG. 1. Note territory of the U.S. may include not only the continental U.S., but also Alaska, Hawaii, Puerto Rico, Guam, U.S. Samoa, U.S. Virgin Islands, U.S. military bases, U.S. embassies, and/or any other territory that is owned and/or controlled by the U.S.

In some embodiments, step (a) (step 1403) may be a step of evaluating each existing (or future) site 1511 selected from the plurality of existing (or future) sites 1511 with nuclear waste for ease of drilling (drill-ability or the like) in at least a portion of a deep geological zone 209 that is located directly vertically below the areal boundary of each existing (or future) site 1511. Only sites 1511 with a located directly vertically below deep geological zone 209 would be considered for evaluation per step (a) (step 1403). In some embodiments, step (b) (step 1405) may be a step of determining a geological suitability index (GSI) 1606 from results of the step (a) (step 1403) for each existing (or future) site 1511 selected from the plurality of existing (or future) sites 1511 with nuclear waste. In some embodiments, step (c) (step 1407) may be a step of evaluating each existing (or future) site 1511 selected from the plurality of existing sites 1511 with nuclear waste for location parameters (for location site analysis modeling). In some embodiments, step (d) (step 1409) may be a step of determining a location suitability index (LSI) 1612 from results of the step (c) (step 1407) for each existing (or future) site 1511 selected from the plurality of existing (or future) sites 1511 with nuclear waste. In some embodiments, step (e) (step 1417) may be a step of determining a site suitability index (SSI) 1704 for each existing (or future) site 1511 selected from the plurality of existing (or future) sites 1511 with nuclear waste from both the geological suitability indexes (GSIs) 1606 and from the location suitability indexes (LSIs) 1612. In some embodiments, step (f) (step 1419) may be a step of ranking (sorting and/or ordering) the plurality of existing (or future) sites 1511 with nuclear waste by determined site suitability indexes (SSIs) 1704. In some embodiments, step (g) (step 1421) may be a step of selecting the at least one existing (or future) site 1511 with nuclear waste that has a desirable site suitability index (SSI) 1704. In some embodiments, the desirable site suitability index (SSI) 1704 may be larger than the site suitability index (SSI) 1704 of another site 1511 selected from the plurality of existing sites 1511 with nuclear waste. See e.g., FIG. 14 to FIG. 17.

In some embodiments, in executing the step (a) (step 1403), the method may analyze data from at least one of: drilling efficiency at each site 1511; environmental impact study at each site 1511; geological properties at and below each site 1511; petrophysical properties at and below each site 1511; rates of penetration in formations below each site 1511; or mobilization costs for each site 1511, with respect to bringing in and setting up at least one drill rig 206 and related equipment to each site 1511; portions thereof; combinations thereof; and/or the like; wherein each such site 1511 is selected from the plurality of existing sites 1511 with nuclear waste. In some embodiments, in executing the step (b) (step 1405), the method may assign a rating 1603 for each category 1602 of data that is evaluated in the step (a) (step 1403). In some embodiments, the assigned/determined ratings 1603 may be per a predetermine scale (rating system) (e.g., 1 to 100). In some embodiments, in executing the step (b) (step 1405), the method may assign a weighted-value 1604 for each of the ratings 1603 for each category 1602 of data that is evaluated in the step (a) (step 1403). In some embodiments, in executing the step (b) (step 1405), the method multiplies each rating 1603 value to its weighted-value 1604 to output a factor-rating-product 1605 for each category 1602 of data that is evaluated in the step (a) (step 1403). In some embodiments, in executing the step (b) (step 1405), the method sums (totals) all of the factor-rating-products 1605 to arrive at the geological suitability index (GSI) 1606 for each site 1511. See e.g., FIG. 14 and FIG. 16.

In some embodiments, in executing the step (c) (step 1407) of evaluating the location parameters of each site 1511, the method may analyze data from at least one of: demographics at each site 1511; a fuel decay index (FDI) 1508/1512 at each site 1511; existing infrastructure at each site 1511; ease of transportation at each site 1511; regulatory factors at each site 1511; political considerations at each site 1511; social considerations at each site 1511; geographic considerations at each site 1511; logistics considerations at each site 1511; portions thereof; combinations thereof; and/or the like; wherein each such site 1511 is selected from the plurality of existing sites 1511 with nuclear waste. In some embodiments, in executing the step (d) (step 1409), the method may assign a rating 1609 for each category 1608 of data that is evaluated in the step (c) (step 1407). In some embodiments, the rating is per a predetermine scale. In some embodiments, in executing the step (d) (step 1409), the method may assign a weighted-value 1610 for each of the ratings 1609 for each category 1608 of data that is evaluated in the step (c) (step 1407). In some embodiments, in executing the step (d) (step 1409), the method multiplies each rating to its weighted-value to output a factor-rating-product 1611 for each category of data that is evaluated in the step (c) (step 1407). In some embodiments, in executing the step (d (step 1409) the method may sum (total) all of the factor-rating-products 1611 to arrive at the location suitability index (LSI) 1612 for each site 1511. See e.g., FIG. 14 and FIG. 16.

In some embodiments, determining the fuel decay index (FDI) 1508 for each site 1511 may be done by: (i) categorizing nuclear waste present at each site into categories 1501 by age 1502 of how long the nuclear waste has been present at each site 1511; (ii) for each category 1501, determining an amount 1503 of the nuclear waste that is present at each site 1511; (iii) for each category 1501, multiplying the category's age 1502 times the amount 1503 of the nuclear waste to arrive at a first-product-value 1506; (iv) for each category 1501, multiplying the first-product-value 1506 by a loss-level 1504 for that given category 1501 to arrive at a second-product-value 1507; and (v) then summing (totaling) all the category's second-product-values 1507 together to arrive at the determined/calculated fuel decay index (FDI) 1508 for each site 1511. See e.g., FIG. 15 for FDI 1508 determination for each site 1511; and see also FIG. 14, steps 1407 and/or 1409 for when FDI 1508 may be evaluated, analyzed, and/or determined.

In some embodiments, in executing the step (e) (step 1417), the method: (i) may assign a first-rating 1701 for each geological suitability index (GSI) 1606 determined from the step (b) (step 1405), may assign a second-rating 1701 for each location suitability index (LSI) 1612 determined from the step (d) (step 1409), and may assign a third-rating 1701 for each fuel decay index (FDI) 1508 determined for each site 1511, wherein the first-rating 1701, the second-rating 1701, and the third-rating 1701 may all be per a same predetermine scale/scoring protocol (such as, but not limited to, 1 to 100), wherein each site 1511 then has three separate ratings 1701 (one for each of the three indexes of GSI, LSI, and FDI); (ii) may assign a weighted-value 1702 for each of the three separate index ratings 1701; (iii) may multiply each of three separate index ratings 1701 by its associated weighted-value 1702 to output a factor-rating-product 1703 for each of the three separate ratings; and (iv) lastly then sums (totals) all of the factor-rating-products 1703 together to arrive at the site suitability index (SSI) 1704 for each site 1511. In some embodiment, for each site 1511 that GSI 1606, LSI 1612, and FDI 1508 have been determined, then SSI 1704 for that given site 1511 may be determined. In some embodiment, for each site 1511 that has GSI 1606 determined, that raw GSI 1606 may be converted to first-rating 1701; that is, first-rating 1701 may also be a GSI 1606 value for a given site 1511. In some embodiment, for each site 1511 that has LSI 1612 determined, that raw LSI 1612 may be converted to second-rating 1701; that is, second-rating 1701 may also be a LSI 1612 value for a given site 1511. In some embodiment, for each site 1511 that has FDI 1508/1512 determined, that raw FDI 1508 may be converted to third-rating 1701; that is, third-rating 1701 may also be a FDI 1508 value for a given site 1511. In some embodiments, third-rating 1701 may be used interchangeably with normalized FDI 1512. For example, site 1511 “C” in FIG. 15 has a normalized FDI 1512 value of “44” and site 1511 “C” of FIG. 17 has a third-rating 1701 value of “44.” In some embodiments, these raw index conversions to first-rating 1701, second-rating 1702, and third-rating 1703 may be done so the three indexes (GSI, LSI, and FDI) all use a same scale and/or scoring protocol; and/or may all be of the same order of magnitude with respect to each other. See e.g., FIG. 14 and FIG. 17.

In some embodiments, the method, after the step (g) (step 1421), may further comprise a step 1423 of implementing the deep geological repository 209. In some embodiments, the step 1423 of implementing the deep geological repository 209 may be carried out at least in part by at least one drill rig 206. In some embodiments, the at least one drill rig 206 may be used to drill out and form at least one vertical wellbore 207 from terrestrial surface 205 of the at least one (selected) existing (or future) site 1511 and to the at least the portion of the deep geological zone 209 of that at least one (selected) existing (or future) site 1511. See e.g., FIG. 14 to FIG. 17; see also, FIG. 2A to FIG. 4B.

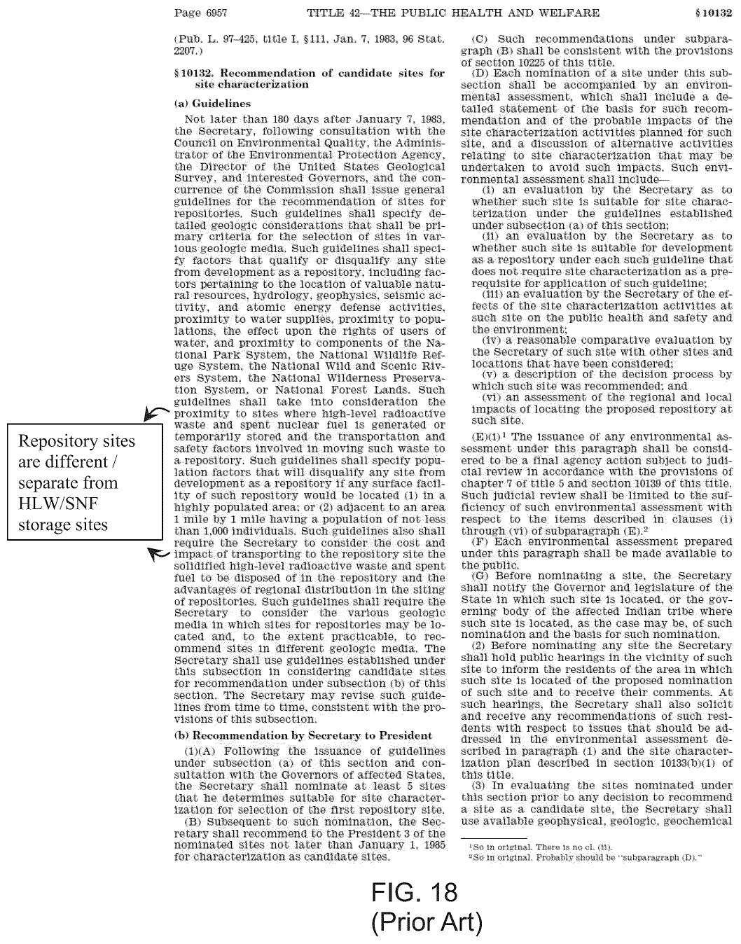

FIG. 18 is prior art and shows a 2010 version of 42 U.S.C. (United States Code) section 10132(a) that is annotated to show how 42 U.S.C. (United States Code) section 10132(a) treats candidate repository site” as different, separate, and unique sites/locations with respect to preexisting sites that generate HLW/SNF and/or that already have HLW/SNF stored therein. Title 42 U.S.C. section 10132(a) specifically instructs that proximity between candidate repository sites and the preexisting sites where HLW radioactive waste and/or SNF is generated or temporarily stored be considered as with respect to transportation, safety, and cost in moving that radioactive waste to the repository site (from the preexisting storage or generation site). That is, 42 U.S.C. section 10132(a) treats “repository sites” as physically different, separate, and unique sites/locations from the preexisting sites where HLW radioactive waste and/or SNF is generated or temporarily stored.

Title 42 U.S.C. section 10132(a) does not disclose, teach, and/or suggest implementing (constructing) a given deep geological repository 209 onsite and directly vertically below an areal extent of an existing site 1511 that already has HLW/SNF present at that existing site 1511 (e.g., at the terrestrial surface or near it). Rather, 42 U.S.C. section 10132(a) teaches that the “repository sites” as physically different, separate, and unique sites/locations from the “preexisting sites” where HLW radioactive waste and/or SNF is generated or temporarily stored, such that the HLW/SNF will have be moved and transported from the “preexisting sites” where HLW radioactive waste and/or SNF is currently being generated or temporarily stored to the “repository site.”

If a proposed modification would render the prior art invention being modified unsatisfactory for its intended purpose, then there is no suggestion or motivation to make the proposed modification. In re Gordon, 733 F.2d 900, 221 USPQ 1125 (Fed. Cir. 1984). And if the proposed modification or combination of the prior art would change the principle of operation of the prior art invention being modified, then the teachings of the references are not sufficient to render the claims prima facie obvious. In re Ratti, 270 F.2d 810, 813, 123 USPQ 349, 352 (CCPA 1959).

Thus, it would be improper to modify 42 U.S.C. section 10132(a) such that “repository site” and the “preexisting sites” where HLW radioactive waste and/or SNF is currently being generated or temporarily being stored are now in fact the exact same sites, as unmodified 42 U.S.C. section 10132(a) explicitly requires that the safety and costs be considered with respect to moving and transporting the HLW/SNF from temporary storage/generation “preexisting sites” to the physically different, separate, and unique “repository site.” That is, modifying 42 U.S.C. section 10132(a) such that “repository site” and the “preexisting sites” where the HLW radioactive waste and/or SNF is currently being generated or temporarily being stored as being the exact same sites would render the modified 42 U.S.C. section 10132(a) unsatisfactory for its intended purpose and would also constitute a change in the principle of operation of 42 U.S.C. section 10132(a)—because then there would be no point in considering the safety and costs of HLW/SNF between sites. Thus, such a modification of 42 U.S.C. section 10132(a) would be improper in the context of articulating a 35 U.S.C. section 103 obviousness claim rejection of any claim of this patent application.

Further, prior art must be considered in its entirety, including disclosures that teach away from the claims. See e.g., MPEP section 2141.02. Pursuant to Intelligent Bio-Sys. v. Illumbia Cambridge Ltd., 821 F.3d 1359 (Fed. Cir. 2016), teaching away can be anything that causes the person of ordinary skill in the art not to combine references.

Here, 42 U.S.C. section 10132(a) teaches away from having “repository site” and the preexisting site where the HLW radioactive waste and/or the SNF is currently being generated or currently being temporarily stored as being the exact same site. Thus, reliance upon teachings of 42 U.S.C. section 10132(a) would be improper in the context of articulating a 35 U.S.C. section 103 obviousness claim rejection of any claim of this patent application.

Note, that 42 U.S.C. sections 10132 to 10133 provide vague instructions on site recommendations for selecting or recommending a future nuclear waste disposal site, i.e., a future waste disposal repository site.

Whereas, in contrast the teachings of this present patent application may be directed to evaluating sites 1511 that already have HLW/SNF stored thereon, for selection of implementing (constructing) a deeply located disposal repository that is located directly vertically below the selected site 1511, such that the onsite HLW/SNF never has to leave that selected site 1511, rather instead that already present HLW/SNF simply gets moved vertically downwards into the deeply located waste repository.

Furthermore, 42 U.S.C. sections 10132 to 10133 recommends a format for candidate future nuclear waste repository site characterization prior to any such operations. 42 U.S.C. sections 10132 to 10133 also includes some parameters and/or features to look at and what to include in the site assessment; however, 42 U.S.C. sections 10132 to 10133 does not discuss how to combine, quantify, select, and rank the specific candidate future repository sites in a manner that ranks and selects the most desirable of those specific candidate future repository sites for selection and implementation of a particular waste repository site. Whereas, the present patent application does teach addressing those issues.

With respect to non-patent literature (NPL) prior art published article “Rank Ordering Criteria Weighting Methods—A Comparative Overview” by Ewa Roszkowska (hereinafter, “Roszkowska”) discusses a panoramic and academic review of theoretical approaches to decision making under alternatives.

Roszkowska differs from the teachings in the present patent application in many ways. For example, Roszkowska states that the true weight of a criteria is unknown in practice (see e.g., Roszkowska page 15, line 18). Whereas, in the present patent application we know the true weight assigned to a feature (criterion) from empirical and/or operational data; and further, assign a numerical rating (1-100) and a weight factor (0-1) to each parameter in our analysis. See e.g., FIG. 16, Table 3.

For example, Roszkowska attaches rank to alternatives and then numeric weights, then to determine ranking of alternatives in a one-dimensional three-step algorithmic manner. Whereas, in the present patent application we handle ranking differently, we expand the analytical process as shown in FIG. 14, FIG. 15, FIG. 16, and FIG. 17 to a multi-dimensional analysis. In the present patent application, we apply a multi-dimensional analysis methodology in the method 1400 in which we have several computed variables (indices) GSI (geological suitability index), LSI (location suitability index), FDI (fuel decay index), and SSI (site selection index or site suitability index), which have been determined separately and then new combine them as shown in FIG. 14, FIG. 15, FIG. 16, and FIG. 17 for purposes of selecting a desirable site 1511 from a group of two or more such candidate sites 1511. In one application we employ two (2) variables: rating, which varies from (1-100), and weight which varies from (0-1.00) and in which the weights are normalized to sum to 1.00 as shown in FIG. 16. In another application we use three (3) variables, age, tonnage, and fuel loss level, to compute site data, FDI (fuel decay index) for aiding in the methodology of selecting a site 1511 for implementation (construction) of deeply located waste repository that is directly vertically located below the given selected site 1511.

The methodology expressed in Roszkowska's work is complex and requires the use of matrix algebra analysis which may be beyond the typical person of ordinary skill in the nuclear industry.

Whereas, my methodology taught herein may be implemented simply by typical person of ordinary skill in the nuclear industry, such as by using a simple spreadsheet.

At least some embodiments of the present invention may be a system. In some embodiments, this system may be for long-term disposal of radioactive material within deep geological repository 209 that is located directly vertically below an areal boundary of an existing (or future) site 1511 that has nuclear waste. In some embodiments, the system may comprise at least a terrestrial surface 205 portion of the existing (or future) site 1511; at least one vertical wellbore 207 that may extend from terrestrial surface 205 of that existing (or future) site 1511 to deep geological repository 209; and the deep geological repository 209 that may be formed within at least a portion of a deep geological formation 209. In some embodiments, that deep geological repository 209 may be configured to receive and house a predetermined amount of the radioactive material within that deep geological repository 209. In some embodiments, the at least the portion of the deep geological formation 209 may be located below any water tables that exist below that existing (future) site 1511. In some embodiments, the at least the portion of the deep geological formation 209 may be located directly vertically below the areal boundary of that existing (or future) site. See e.g., FIG. 1 to FIG. 4B. In some embodiments, long-term may be a predetermined minimum age, such as, but not limited to, at least for at least 1,000 years; at least 500 years, at least 5,000 years; at least 10,000 years; or at least 15,000 years. In some embodiments, the existing (or future) site 1501 may be located within territory of the United States of America (U.S.). See e.g., FIG. 1.

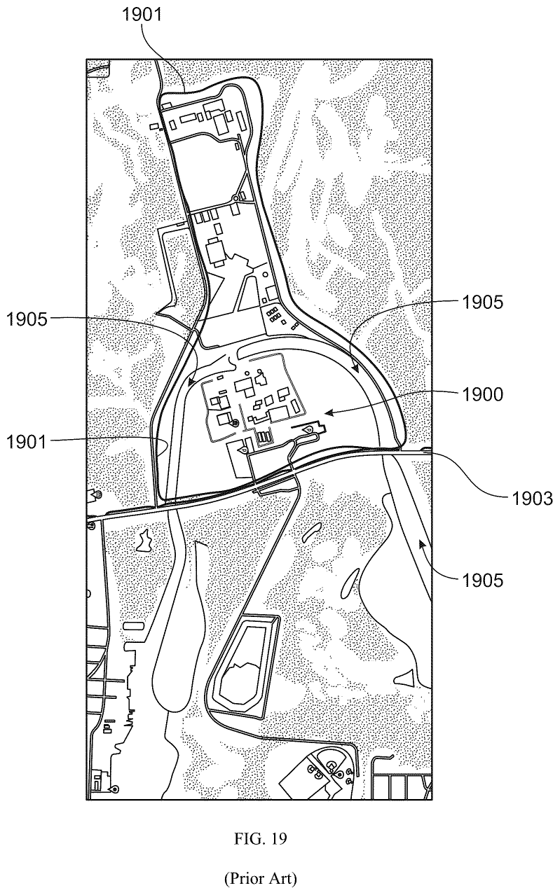

In some embodiments, the existing (or future) site 1511 may be selected from one or more of the following (or may be within one or more of the follow): an operational nuclear power plant site 102; a non-operational nuclear power plant site 101; a cooling pool 704/700 with at least some spent nuclear fuel rod assemblies or portions thereof; a site 500 that has at least one cask, wherein that at least one cask is configured for housing radioactive waste; a site 106 that is configured to store radioactive waste within a salt formation 302 that is located three thousand feet or less below the terrestrial surface 205; a site that been approved and/or licensed by the United States federal government (or portion thereof) for storing high-level nuclear waste (HLW); a site that been approved and/or licensed by the United States federal government (or portion thereof) for storing spent nuclear fuel rod assemblies or portions thereof (SNF); a site that been designated by the United States federal government (or portion thereof) for storing high-level nuclear waste (HLW); a site that been designated by the United States federal government (or portion thereof) for storing spent nuclear fuel rod assemblies or portions thereof (SNF); a site 400 in the municipality of Hanford, within the State of Washington (WA); a site 105 known in the nuclear waste disposal industry as the Yucca Mountain (Mt) site 105 that is located within the State of Nevada (NV); a site 106 known in the nuclear waste disposal industry as the Waste Isolation Pilot Plant (WIPP) site 106 that is located within the State of New Mexico (NM); a site known in the nuclear waste disposal industry as the “Nevada National Security Site” (or also known as the “Nevada Test Site”) located within the State of NV; a site known in the nuclear waste disposal industry as San Onofre nuclear power plant within the State of California (now decommissioned); or a site known in the nuclear waste disposal industry as Oyster Creek (nuclear) Power plant in New Jersey (NJ) site 1900; portions thereof; combinations thereof; and/or the like. See e.g., FIG. 1 to FIG. 5, FIG. 7, and FIG. 19. Note, the San Onofre site 1511 in California may have casks holding nuclear waste (e.g., HLW and/or SNF), wherein at least some of these casks may be partially buried below grade. Note, in some embodiments, a portion (and/or a part) of the U.S. federal government that may approve, license, and/or designate existing sites 1511 for nuclear power generation and/or temporary storage of nuclear waste may comprise an appropriate U.S. federal government agency, such as, but not limited to, the U.S. Nuclear Regulatory Commission (NRC).

In some embodiments, the system may further comprise at least one (modified) drilling rig 206 that may be configured to assist in forming the at least one vertical wellbore 207 and/or in forming the deep geological repository 209. See e.g., FIG. 2A to FIG. 4B. In some embodiments, the deep geological repository 209 may be at least one of a lateral wellbore 208 and/or a human-made cavern 405. In some embodiments, the human-made cavern 405 may be formed by underreaming operations within the at least the portion of the deep geological formation 209. In some embodiments, the at least the portion of the deep geological formation 209 may be located at least five thousand (5,000) feet below the terrestrial surface 205. See e.g., FIG. 2A to FIG. 4B.

Unless otherwise stated herein, “site” and/or “site 1511” may mean an existing (or future) nuclear surface (or near surface) location such as, but not limited to, shutdown nuclear (power plant) site(s) 101, operating commercial nuclear (power plant) site(s) 102, interim storage site 103, interim storage site 104, Yucca Mt site 105, WIPP site 106, Hanford site 400, cooling pool(s)/pond(s) 704, sites of FIG. 1, site of FIG. 2A, site of FIG. 2B, site of FIG. 3, site of FIG. 4A, site of FIG. 4B, site of FIG. 5, site FIG. 7, portions thereof, combinations thereof, and/or the like. Included within such a given site 1511 may be the areal confines/boundary of that given site 1511; and/or in some embodiments, such a site 1511 may include also directly vertically below ground elements such as at least one vertical wellbore 207, at least one lateral (horizontal) wellbore 208, and/or at least one human-made cavern 405, wherein at least part of the at least one vertical wellbore 207, all of the at least one lateral (horizontal) wellbore 208, and/or all of the at least one human-made cavern 405, reside within at least one deeply located (below water tables) HLW disposal zone(s)/formation(s) 209 that is at least in part also located directly vertically below that given site 1511. Also note, the “or future” descriptor used herein in reference to site(s) 1511 is because future sites like and/or at least substantially similar to those sites shown in FIG. 1 to FIG. 5 and in FIG. 7 may be likely to come online in the next twenty (20) years, and such future site(s) 1511 may also be evaluated for implementing at least one deeply located HLW disposal repository 209 directly vertically below such a future site 1511; and if selected, may then have that implementation executed (carried out). Methods 1400 and/or 1500 may be applied to future site(s) 1511 to do end up coming online in the next twenty (20) years or less.

In some embodiments, site 1511 may be approved to have (human-made and/or human generated) radioactive waste onsite (on premises) on and/or near a terrestrial surface of that site 1511. In some embodiments, site 1511 may be approved to generate and/or at least temporarily store (human-made and/or human-generated) radioactive waste onsite (on premises) on and/or near a terrestrial surface of that site 1511. In some embodiments, this approval may be from the U.S. federal government. In some embodiments, this (human-made and/or human generated) radioactive waste may be HLW, SNF, combinations thereof, portions thereof, and/or the like.

In some embodiments, site 1511 has (human-made and/or human generated) radioactive waste (e.g., HLW, SNF, combinations thereof, portions thereof, and/or the like) onsite (on premises) on and/or near a terrestrial surface of that site 1511.

In some embodiments, site 1511 has (human-made and/or human generated) radioactive waste (e.g., HLW and/or SNF) onsite (on premises) on and/or near a terrestrial surface of that site 1511, before deep geological repository 209 is implemented (constructed) directly vertically below at least some portion of the areal boundary of that site 1511. Thus, with respect to such a deep geological repository 209, that site 1511 is a preexisting site. For example, the U.S. federal government after this patent application is filed, published, and/or issues into a U.S. utility patent, could approve of a site for HLW and/or SNF generation and/or at least temporary storage of HLW and/or SNF; and subsequent to that U.S. federal government approval, that site could receive and/or generate the HLW and/or the SNF (or portions thereof), on and/or near the terrestrial surface of that site, making that site a site 1511; and then that site 1511 could be selected for implementation (construction) of at least one deep geological repository 209 that is located onsite directly vertically below at least some portion of the areal boundary of that site 1511 according to the teachings of one or more embodiment shown and discussed herein; and thus, site 1511 is preexisting with respect to that at least one deep geological repository 209 even if that site 1511 itself comes into existence in the future (e.g., after this patent application is filed). Other sites 1511 already exist, before the filing of this patent application, but do not yet have an associated onsite at least one deep geological repository 209 located there below.

In some embodiments, site 1511 is always at least a predetermined section of land and/or always at least a predetermined section of terrestrial real estate. In some embodiments, site 1511 is always at least a predetermined section of land and/or always at least a predetermined section of terrestrial real estate of the United States (U.S.) (i.e., that the U.S. considers as its terrestrial territory). In some embodiments, site 1511 is always at least a predetermined section of land and/or always at least a predetermined section of terrestrial real estate within terrestrial territory of the United States (U.S.).

In some embodiments, site 1511, as at least a predetermined section of land and/or at least a predetermined section of terrestrial real estate, that has a predetermined areal boundary (perimeter). In some embodiments, the predetermined areal boundary (perimeter) for a given site 1511 is as defined, determined, and/or indicated by the U.S. federal government, a U.S. court (federal, state, tribal, and/or administrative), and/or agent(s)/contractor(s) thereof (recall that the U.S. federal government would have approved that site 1511 for at least the temporary storage of (human-made and/or human generated) radioactive waste [e.g., HLW, SNF, combinations thereof, portions thereof, and/or the like]) and thus would have defined the areal boundary (perimeter) of that site 1511 in some manner.

So, whatever the U.S. federal government (or a portion thereof, such as, but not limited to the Nuclear Regulatory Commission [NRC]), a U.S. court (federal, state, tribal, and/or administrative), and/or agent(s)/contractor(s) thereof treats as the predetermined areal boundary (perimeter) for a given site that has been approved, licensed, and/or designed by the U.S. federal government to generate and/or at least temporarily store (human-made and/or human generated) radioactive waste (e.g., HLW, SNF, combinations thereof, portions thereof, and/or the like) onsite (on premises) on and/or near a terrestrial surface of that site; and that has at least a metric ton of (human-made and/or human generated) radioactive waste (e.g., HLW, SNF, combinations thereof, portions thereof, and/or the like) at least temporarily stored onsite (on premises) on and/or near a terrestrial surface of that site, may be used as the predetermined areal boundary for that given site 1511.

In some embodiments, the predetermined areal boundary (perimeter) of a given site 1511 may be marked, determined, and/or indicated by one or more onsite physical indicators, such as, but not limited to, fencing, walls, berms, and/or the like that (at least partially) surround that predetermined areal boundary (perimeter).

In some embodiments, the predetermined areal boundary of a given site 1511 may be at least marked, determined, and/or indicated by periodic (intermittent) warning signage that may be at or near such portions of that predetermined areal boundary (perimeter).

In some embodiments, the predetermined areal boundary (perimeter) for a given site 1511 is as marked, defined, determined, and/or indicated by typical (generally accepted) land survey means, such as, but not limited to, coordinates.

In some embodiments, the predetermined areal boundary (perimeter) for a given site 1511 is as marked, defined, determined, and/or indicated by typical (generally accepted) land survey means/methods, wherein such typical (generally accepted) land survey means/methods are incorporated by reference herein.

In some embodiments, the terrestrial surface area of a given site 1511, within its predetermined areal boundary (perimeter), may be one or more: real estate lots, real estate parcels, acres, hectares, square miles, combinations thereof, portions thereof, and/or the like, but always much less than the total current terrestrial territory of the U.S. In some embodiments, “much less” in this context may be less than ninety percent (90%) of the total current terrestrial territory of the U.S. “Current” in this context may be the year 2023, i.e., the year this patent application was filed.

In some embodiments, a given site 1511 may also include (comprise) one or more human structures onsite (on premises), such as, but not limited to, roads, pathways, buildings, tanks, sheds, towers, antennas, ponds, fences, walls, berms, storage containers, aqueducts, power transmission equipment, power generation equipment, power storage equipment, communications equipment, combinations thereof, portions thereof, and/or the like.

For example, consider FIG. 19. FIG. 19 is prior art and shows the areal boundary (perimeter) 1901 of Oyster Creek (nuclear) Power plant in New Jersey (NJ) site 1900. In some embodiments, the Oyster Creek (nuclear) Power plant site 1900 may be a potential site 1511. This Oyster Creek (nuclear) Power site 1900 is described legally by the areal physical surface (land/water) boundaries 1901 described in the licensing process for that site 1900 and in the operating license of the subject nuclear power plant site 1900. In its application the operating company has to specify parcel(s) of land (or portions thereof) which encompasses the entire area in which it shall operate. For example, at the Oyster Creek Power plant 1900 in NJ, that site encompasses about 800 acres. FIG. 19 also shows a portion of State Route 9 1903 that runs North-South, at the eastern edge of the areal boundary (perimeter) 1901 of site 1900. FIG. 19 also shows a portion of the South Branch Forked River 1905 that through a portion of the areal boundary (perimeter) 1901 of site 1900. See e.g., FIG. 19. In some embodiments, the Oyster Creek (nuclear) Power plant may be a potential site 1511. As such, the Oyster Creek (nuclear) Power plant site 1900 may be evaluated per the teachings herein for implementation (construction) of at least one deep geological repository 209 located directly vertically below as least some portion of the legally defined areal boundary (perimeter) 1901 of this Oyster Creek (nuclear) Power site 1900. In any event, the process of determining, identifying, and/or marking the legal areal boundaries (perimeter) 1901 of the Oyster Creek (nuclear) Power site 1900 may be applied to any other site 1511.

In some embodiments, a vertical and/or bottom boundary of a given site 1511 may also include (comprise) geologic formation(s) (or portions thereof) located directly vertically below the predetermined areal boundary (perimeter) and the terrestrial surface of that given site 1511, including a portion of at least one deep geological zone, where at least one deep geological repository 209 may be implemented (constructed) within.

In some embodiments, a top (an upper) boundary of a given site 1511 may also include (comprise) its terrestrial surface within its predetermined areal boundary (perimeter). In some embodiments, a top (an upper) boundary of a given site 1511 may also include (comprise) its terrestrial surface within its predetermined areal boundary (perimeter), and human-made structures and/or equipment on (affixed to) that terrestrial surface.

In some embodiments, surrounding the predetermined areal boundary (perimeter) of a given site 1511 may be one or more of public land, government land, tribal land, private land, coastline, portions thereof, combinations thereof, and/or the like that is generally not intended to have (human-made and/or human generated) radioactive waste (e.g., HLW, SNF, combinations thereof, portions thereof, and/or the like) at least temporarily stored thereon; although, such (human-made and/or human generated) radioactive waste may occasionally (intermittently) move through such surrounding lands in route to a given site 1511.

Note, once at least one deep geological repository 209, of a given site 1511, has been implemented (constructed) and then subsequently filled to desired (intended) capacity with the onsite (human-made and/or human generated) radioactive waste (e.g., HLW, SNF, combinations thereof, portions thereof, and/or the like), then that former (human-made and/or human generated) radioactive waste (e.g., HLW, SNF, combinations thereof, portions thereof, and/or the like) that had initially been at or near the terrestrial surface of that given site 1511 may be transferred to that at least one deep geological repository 209.

In some embodiments, site 1511 does not include oceans, seas, lakes, rivers, natural navigable bodies of water, portions thereof, combinations thereof, and/or the like.

In some embodiments, site 1511 does not include geologic formation(s)s that are located below terrestrial (surface): oceans, seas, lakes, rivers, navigable bodies of water, portions thereof, combinations thereof, and/or the like.

Devices, apparatus, machines, systems, methods, and/or the like for data collecting, gathering, determining, ranking, and/or selecting existing (or future) nuclear surface (or near surface) sites for potential onsite disposal of HLW in deep geological zones directly vertically below the given selected site; and/or then implementing at least one such onsite deep HLW disposal repository at the selected existing (or future) nuclear surface (or near surface) site(s) have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for long-term disposal of radioactive material within a deep geological repository that is located directly vertically below at least some portion of an areal boundary of an existing site that has nuclear waste stored at the existing site or had nuclear waste stored at the existing site, wherein the existing site has a terrestrial surface within the areal boundary, wherein the system comprises:
at least a portion of the existing site that has the nuclear waste stored or that had the nuclear waste stored;
at least one vertical wellbore that extends from the terrestrial surface of the existing site to the deep geological repository; and
the deep geological repository that is formed within at least a portion of a deep geological formation; wherein the deep geological repository is configured to receive and house a predetermined amount of the radioactive material; wherein the at least the portion of the deep geological formation is located below any water tables that exist directly vertically below the existing site; wherein the at least the portion of the deep geological formation is located directly vertically below the at least some portion of the areal boundary of the existing site;
wherein the existing site is at least a predetermined section of terrestrial real estate;
wherein the existing site has been approved by the U.S. federal government for the storage of nuclear waste, which includes a determination of the areal boundary of the existing site.

2. The system according to claim 1, wherein long-term is at least for at least 1,000 years.

3. The system according to claim 1, wherein the existing site is located within terrestrial territory of the United States of America.

4. The system according to claim 1, wherein the existing site is selected from one or more of the following: an operational nuclear power plant site; a non-operational nuclear power plant site; a cooling pool with at least some spent nuclear fuel rod assemblies or portions thereof; a site that has at least one cask, wherein that at least one cask is configured for housing radioactive waste; a site that is configured to store radioactive waste within a salt formation that is located three thousand feet or less below a terrestrial ground surface; a site that been approved by the United States federal government for storing high-level nuclear waste; a site that been approved by the United States federal government for storing spent nuclear fuel rod assemblies or portions thereof; a site that has been designated by the United States federal government for storing high-level nuclear waste; a site that has been designated by the United States federal government for storing spent nuclear fuel rod assemblies or portions thereof; a site in the municipality of Hanford, within the United States State of Washington; a site known in the nuclear waste disposal industry as the Yucca Mountain site that is located within the United States State of Nevada; a site known in the nuclear waste disposal industry as the Waste Isolation Pilot Plant site that is located within the United States State of New Mexico; a site known in the nuclear waste disposal industry as Nevada National Security Site; or a site known in the nuclear waste disposal industry as San Onofre nuclear power plant located within the State of California.

5. The system according to claim 1, wherein the system further comprises at least one drilling rig that is configured to assist in forming the at least one vertical wellbore and/or in forming the deep geological repository.

6. The system according to claim 1, wherein the deep geological repository is at least one of a lateral wellbore or a human-made cavern.

7. The system according to claim 6, wherein the human-made cavern is formed by underreaming operations within the at least the portion of the deep geological formation with at least one underreaming tool that is operatively connected to at least one drilling rig that is located on the terrestrial surface.

8. The system according to claim 1, wherein the at least the portion of the deep geological formation is located at least four thousand feet below the terrestrial surface.

9. A method for selecting at least one existing site for implementation of a deep geological repository that is located, onsite with the at least one existing site, such that the deep geological repository is located at least partially directly vertically below an areal boundary of the at least one existing site, wherein the at least one existing site is selected from a plurality of existing sites, wherein the method comprises steps of:
(a) collecting drilling analysis data for each existing site selected from the plurality of existing sites with respect to geologic parameters located directly vertically below a terrestrial surface of each existing site selected from the plurality of existing sites and to at least a portion of a deep geological zone that is located directly vertically below the areal boundary of each existing site selected from the plurality of existing sites;
(b) determining a geological suitability index from results of the step (a) for each existing site selected from the plurality of existing sites;
(c) collecting location parameters data for each existing site selected from the plurality of existing sites;
(d) determining a location suitability index from results of the step (c) for each existing site selected from the plurality of existing sites;
(e) determining a site suitability index for each existing site selected from the plurality of existing sites from at least the geological suitability indexes determined in the step (b) and from the location suitability indexes determined in the step (d);
(f) ranking the plurality of existing sites by the determined site suitability indexes from the step (e); and
(g) selecting the at least one existing site that has a desirable site suitability index, wherein the desirable site suitability index is a site suitability index of one of the plurality of existing sites that is better than a site suitability index of another of the plurality of existing sites;
wherein each existing site selected from the plurality of existing sites has been approved and/or licensed by the U.S. federal government or portion thereof for at least storage of high-level nuclear waste at that existing site;
wherein each existing site selected from the plurality of existing sites is at least a predetermined section of terrestrial real estate;
wherein the deep geological repository is configured for long-term disposal of radioactive material therein.

10. The method according to claim 9, wherein the method after the step (g) further comprises a step of implementing the deep geological repository at least partially directly vertically below the areal boundary of the at least one existing site that was selected from the execution of the step (g), wherein this implementing at least comprises constructing the deep geological repository.

11. The method according to claim 10, wherein the step of implementing the deep geological repository is carried out at least in part by at least one drill rig, wherein the at least one drill rig drills out and forms at least one vertical wellbore from the terrestrial surface of the at least one existing site and to the at least the portion of the deep geological zone that is located directly vertically below the terrestrial surface of the at least one existing site.

12. The method according to claim 9, wherein in executing the step (a), the drilling analysis data is selected from at least one of: drilling efficiency at each existing site selected from the plurality of existing sites; environmental impact study at each existing site selected from the plurality of existing sites; geological properties at and below each existing site selected from the plurality of existing sites; petrophysical properties at and below each existing site selected from the plurality of existing sites; rates of penetration in formations below each existing site selected from the plurality of existing sites; or mobilization costs for each existing site selected from the plurality of existing sites, with respect to bringing in and setting up at least one drill rig to each existing site selected from the plurality of existing sites.

13. The method according to claim 12, wherein in executing the step (b), the method assigns a rating for each category of drilling analysis data that is collected in the step (a); wherein the rating is per a predetermined scale; wherein in executing the step (b), the method assigns a weighted-value for each of the ratings for each category of the drilling analysis data that is collected in the step (a); wherein in executing the step (b), the method multiplies each rating to its weighted-value to output a factor-rating-product for each category of the drilling analysis data that is collected in the step (a); wherein in executing the step (b), the method sums all of the factor-rating-products to arrive at the geological suitability index for each existing site selected from the plurality of existing sites.

14. The method according to claim 9, wherein in executing the step (c) of collecting the location parameters for each existing site selected from the plurality of existing sites, the method analyses data from at least one of: demographics at each existing site selected from the plurality of existing sites; a fuel decay index at each existing site selected from the plurality of existing sites; existing infrastructure at each existing site selected from the plurality of existing sites; ease of transportation at each existing site selected from the plurality of existing sites; regulatory factors at each existing site selected from the plurality of existing sites; political considerations at each existing site selected from the plurality of existing sites; or social considerations at each existing site selected from the plurality of existing sites.

15. The method according to claim 14, wherein in executing the step (d), the method assigns a rating for each category of data that is evaluated in the step (c); wherein the rating is per a predetermined scale; wherein in executing the step (d), the method assigns a weighted-value for each of the ratings for each category of data that is evaluated in the step (c); wherein in executing the step (d), the method multiplies each rating to its weighted-value to output a factor-rating-product for each category of data that is evaluated in the step (c); wherein in executing the step (d), the method sums all of the factor-rating-products to arrive at the location suitability index for each existing site selected from the plurality of existing sites.

16. The method according to claim 9, wherein prior to executing the step (e), the method further comprises a step of determining a fuel decay index for each existing site selected from the plurality of existing sites that has nuclear waste stored at the existing site, wherein determining the fuel decay index for each existing site is done by: (i) categorizing nuclear waste present at each existing site selected from the plurality of existing sites into categories by age of how long the nuclear waste has been present at each existing site selected from the plurality of existing sites; (ii) for each category, determining an amount of the nuclear waste that is present at each existing site selected from the plurality of existing sites; (iii) for each category, multiplying the category's age times the amount of the nuclear waste to arrive at a first-product-value; (iv) for each category, multiplying the product-value by a loss-level for that category to arrive at a second-product-value; and (v) summing all the category's second-product-values together to arrive at the fuel decay index for each existing site selected from the plurality of existing sites.

17. The method according to claim 16, wherein in executing the step (e), the method: (i) assigns a first-rating for each geological suitability index determined from the step (b), assigns a second-rating for each location suitability index determined from the step (d), and assigns a third-rating for each fuel decay index determined for each existing site selected from the plurality of existing sites, wherein the first-rating, the second-rating, and the third-rating are per a predetermined scale, wherein each existing site selected from the plurality of existing sites then has three separate ratings; (ii) assigns a weighted-value for each of the three separate ratings; (iii) multiplies each of three separate ratings by its associated weighted-value to output a factor-rating-product for each of the three separate ratings; and (iv) sums all of the factor-rating-products together to arrive at the site suitability index for each existing site selected from the plurality of existing sites.

18. The method according to claim 9, wherein the plurality of existing sites is at least two separate and distinct existing sites with nuclear waste stored thereon.

19. The method according to claim 9, wherein each existing site selected from the plurality of existing sites is located within terrestrial territory of the United States of America.

20. The method according to claim 9, wherein the desirable site suitability index is larger than the site suitability index of another existing site selected from the plurality of existing sites.

21. The method according to claim 9, wherein the radioactive material is selected from at least some of the nuclear waste that is stored at the at least one existing site that is selected in execution of the step (g).
